(19) United States
(12) Patent Application Publication
(10) Pub. No.: US 2021/0242449 A1
(43) Pub. Date: Aug. 5, 2021

(54) IMPROVED FLOODED LEAD ACID BATTERIES UTILIZING AN IMPROVED SEPARATOR WITH A FIBROUS MAT, AND METHODS AND SYSTEMS USING THE SAME

(71) Applicant: DARAMIC, LLC, Charlotte, NC (US)

(72) Inventors: Jorg Deiters, Ettenheim (DE); Matthew Stainer, Owensboro, KY (US); Anna L. Verderame, Charlotte, NC (US); J. Kevin Whear, Utica, KY (US)

(21) Appl. No.: 17/049,163

(22) PCT Filed: Apr. 18, 2019
(86) PCT No.: PCT/US2019/028024

§ 371 Date: Oct. 20, 2020

(51) Int. Cl. H01M 4/14; H01M 50/46; H01M 10/12

(52) U.S. Cl. CPC H01M 4/14; H01M 2220/20; H01M 10/12; H01M 50/46

(57) ABSTRACT

A flooded lead acid battery and a vehicle comprising the same are described herein. The flooded lead acid battery comprises an electrode array, comprising one or more negative plates and one or more positive plates alternately arranged and interleafed with one another. In some embodiments, a negative plate is wrapped or enveloped with a fibrous mat, and a porous membrane is wrapped or enveloped about an adjacent positive electrode. In some embodiments, a fibrous mat is at least partially integrated into a negative plate, and a porous membrane is enveloped about either the negative plate with the fibrous mat partially integrated therein or around an adjacent positive plate. In other embodiments, a negative plate is enveloped with a porous membrane having ribs, and a fibrous mat is present between the wrapped negative plate and the porous membrane enveloping the negative plate. Methods, systems, and vehicles utilizing the disclosed batteries are also provided.

### CROSS-REFERENCE TO RELATED PATENT APPLICATIONS

This application is a 371 Application to PCT Application No. PCT/US2019/028024, filed Apr. 18, 2019, which claims priority to and the benefit of co-pending French patent application 1853502 filed Apr. 20, 2018, which is fully incorporated by reference herein.

### FIELD

In accordance with at least selected embodiments, the present disclosure or invention is directed to novel or improved separators, battery separators, flooded battery separators, enhanced flooded battery separators, fibrous mats, batteries, cells, and/or methods of manufacture and/or use of such separators, battery separators, fibrous mats, flooded battery separators, enhanced flooded battery separators, cells, and/or batteries. In accordance with at least certain embodiments, the present disclosure or invention is directed to novel or improved enhanced flooded battery separators for starting lighting ignition (“SLI”) batteries, fibrous mats, flooded batteries for deep cycle applications, flooded batteries for motive power applications, flooded batteries for partial state of charge (PSoC) applications, and/or enhanced flooded batteries, and/or systems, vehicles, and/or the like including such separators, fibrous mats, batteries, and/or improved methods of making and/or using such improved separators, fibrous mats, cells, batteries, systems, vehicles, and/or the like. In accordance with at least certain embodiments, the present disclosure or invention is directed to an improved separator for enhanced flooded batteries and/or improved methods of making and/or using such batteries having such improved separators. In accordance with at least selected embodiments, the present disclosure or invention is directed to separators, particularly separators for enhanced flooded batteries having reduced electrical resistance and/or increased cold cranking amps. In addition, disclosed herein are methods, systems, and battery separators for enhancing active material retention, enhancing battery life, reducing water loss, reducing internal resistance, increasing wettability, reducing acid stratification, improving acid diffusion, improving cold cranking amps, improving uniformity in at least enhanced flooded batteries, and/or the like. In accordance with at least particular embodiments, the present disclosure or invention is directed to an improved separator for enhanced flooded batteries wherein the separator includes one or more performance enhancing additives or coatings, optimized porosity, optimized void volume, amorphous silica, higher oil absorption silica, higher silanol group silica, retention, and/or improved retention of active material on electrodes, and/or any combination thereof.

In accordance with at least selected embodiments, the present disclosure or invention is directed to separators for lead acid batteries, in particular flooded lead acid batteries, and various lead acid batteries, such as flooded lead acid batteries or enhanced flooded lead acid batteries, having the same. In accordance with at least selected embodiments, the present disclosure or invention is directed to novel or improved separators, cells, batteries, and/or methods of manufacture and/or use of such separators, cells, and/or batteries. In accordance with at least certain embodiments, the present disclosure or invention is directed to an improved separator for lead acid batteries and/or improved methods of using such batteries having such improved separators. In addition, disclosed herein are methods, systems, and battery separators for enhancing active material retention, battery life, reducing battery failure, reducing water loss, improving oxidation stability, improving, maintaining, and/or lowering float current, improving end of charge (EOC) current, decreasing the current and/or voltage needed to charge and/or fully charge a deep cycle battery, minimizing internal electrical resistance increases, lowering electrical resistance, increasing wettability, lowering wet out time with electrolyte, reducing time of battery formation, reducing antimony poisoning, reducing acid stratification, improving acid diffusion, and/or improving uniformity in lead acid batteries. In accordance with at least particular embodiments, the present disclosure or invention is directed to an improved separator for lead acid batteries wherein the separator includes one or more improved performance enhancing additives and/or coatings. In accordance with at least certain embodiments, the disclosed separators are useful for deep-cycling applications, for instance in motive machines or vehicles, and/or stationary machines or vehicles, such as golf carts (also known as “golf cars”), fork trucks, inverters, renewable energy systems and/or alternative energy systems such as, by way of example only, solar power systems and wind power systems; in particular, the disclosed separators are useful in battery systems wherein deep cycling and/or partial state of charge operations are part of the battery life, even more particularly, in battery systems where additives and/or alloys (e.g., antimony (Sb)) are added to the battery to enhance the life and/or performance of the battery and/or to enhance the deep cycling and/or partial state of charge operating capability of the battery.

In accordance with at least selected embodiments, the present disclosure is directed to improved lead acid batteries, such as flooded lead acid batteries, improved systems that include a lead acid battery, and/or a battery separator, improved battery separators, improved vehicles including such systems, methods of manufacture or use, or combinations thereof. In accordance with at least certain embodiments, the present disclosure or invention is directed to novel or improved flooded lead acid batteries, improved battery separators for such batteries, and/or methods of manufacturing, testing, using such improved flooded lead acid batteries, and/or combinations thereof. In addition, disclosed herein is a method, system, battery, and/or battery separator for reducing acid stratification, enhancing battery life and performance in a flooded lead acid battery, and in such batteries that operate in a partial state of charge.

### BACKGROUND

A battery separator electrically separates the battery's positive and negative electrodes or plates in order to prevent an electrical short. Such a battery separator is typically microporous and ionically conductive such that ions may pass therethrough between the positive and negative electrodes or plates. Separators may be fashioned from polyolefins, such as polyethylene. In lead acid storage batteries, such as automotive batteries and/or industrial batteries and/or deep cycle batteries, the battery separator is typically a microporous polyethylene separator; in some cases, such a separator may include a backweb and a plurality of ribs standing on one or both sides of the backweb. See, Besenhard, J. O., Editor, Handbook of Battery Materials, Wiley-VCH Verlag GmbH, Weinheim, Germany (1999), ch. 9, pp. 245-292.

Enhanced flooded batteries (“EFBs”) and absorbent glassmat (“AGM”) batteries have been developed to meet the expanding need for electric power sources in idle-start-stop (“ISS”) applications. EFB systems have similar architecture to traditional flooded lead acid batteries, in which positive and/or negative electrodes are surrounded by a microporous separator, and submerged in a liquid electrolyte. AGM systems, on the other hand, do not contain free liquid electrolyte. Instead, the electrolyte is absorbed into a glass fiber mat that is layered on the electrodes. Historically, AGM systems have been associated with higher discharge power, better cycle life, and greater cold cranking amps than flooded battery systems. However, AGM batteries are significantly more expensive to manufacture and are more sensitive to overcharging. As such, EFB systems remain an attractive option for mobile power sources as well as stationary power sources for various markets and applications.

EFB systems can include one or more battery separators that divide, or separate, the positive electrodes from the negative electrodes within a lead acid battery cell. A battery separator may have two primary functions. A battery separator should keep the positive electrode physically apart from the negative electrode in order to prevent any electrical current passing between the two electrodes, which would cause an electrical short. In addition, a battery separator should permit an ionic current between the positive and negative electrodes with the least possible resistance. A battery separator can be made out of many different materials, but these two opposing functions have been met well by a battery separator being made of a porous nonconductor. With this structure, pores contribute to ionic diffusion between electrodes, and a non-conducting polymeric network prevents electronic shorting.

An EFB with increased discharge rate and cold cranking amperes or amps (“CCA”) would be able to displace AGM batteries. Cold cranking amps are correlated with the internal resistance of the battery. It is expected that lowering internal resistance of an enhanced flooded battery will increase the CCA rating. As such, there is a need for new battery separator and/or battery technology to meet and overcome the challenges arising from current lead acid battery systems, especially to lower internal resistance and increase cold cranking amps in enhanced flooded batteries.

In order to reduce fuel consumption and generation of tail pipe emissions, auto manufacturers have implemented varying degrees of electrical hybridization. One form of Hybrid Electric Vehicle (“HEV”) is sometimes referred as the “Micro HEV” or “micro-hybrid.” In such Micro HEVs or similar vehicles, an automobile may have an idle-start-stop (“ISS”) function in which the engine may shut off at various points during idle-start-stop and/or regenerative braking. Although this increases the fuel economy of the vehicle, it also increases strain on the battery, which must power auxiliary devices (such as air conditioning, media players and the like) while the vehicle is not in motion.

Conventional vehicles (such as automobiles without start-stop capability) may use conventional flooded lead acid batteries such as starting lighting ignition (“SLI”) lead acid batteries. Because the engine never shuts off during use, power is only drawn from the battery when the engine is cranked, or started. As such, the battery typically exists in a state of overcharge, not in a partial state of charge. For example, such a conventional flooded lead acid battery may exist in a state of charge that is greater than 95% charged, greater than 96%, greater than 97%, greater than 98%, greater than 99%, or even greater than 100% charged, as it is often in a state of overcharge. At overcharge, gas bubbles (for example hydrogen gas bubbles) are generated within the conventional lead acid battery, and these circulating gas bubbles serve to mix the liquid electrolyte (e.g., sulfuric acid) within the battery.

ISS vehicles, on the other hand, continuously draw power from the battery, which is therefore constantly in a state of partial charge. In a partial state of charge, gas bubbles are not generated and internal mixing of the electrolyte is substantially reduced, leading to acid stratification within the battery. Thus, acid stratification is a problem within various enhanced flooded batteries that operate in a partial state of charge, such as idle-start-stop flooded lead acid batteries. Whereas acid stratification is simply not a problem for more conventional or traditional flooded lead acid batteries, which operated in a state of overcharge or total, or close-to-total, charge.

Acid stratification is a term for the process in which the water and sulfuric acid in the electrolyte stratify with the denser sulfuric acid concentrating at the bottom of the battery, leading to a corresponding higher water concentration at the top of the battery. Acid stratification is undesirable within a flooded lead acid battery, such as an enhanced flooded lead acid battery or a start/stop flooded lead acid battery. The reduced levels of acid at the top of the electrode may inhibit uniformity and charge acceptance within the battery system and may increase the variation of internal resistance from top to bottom along the height of the battery. Increased acid levels at the bottom of the battery artificially raise the voltage of the battery, which can interfere with battery management systems, possibly sending unintended/erroneous state of health signals to a battery management system. Overall, acid stratification causes higher resistance along parts of the battery, which may lead to electrode issues and/or shorter battery life. Given that start/stop batteries and/or other enhanced flooded lead acid batteries are expected to become more and more prevalent with hybrid and fully electric vehicles to increase vehicle fuel efficiency and to reduce emissions, solutions for reducing acid stratification and/or for improving acid mixing are greatly needed.

In some instances, acid stratification can be somewhat reduced using valve regulated lead acid (“VRLA”) technology where the acid is immobilized by either a gelled electrolyte and/or by an absorbent glass mat (“AGM”) battery separator system. In contrast to the freely fluid electrolyte in flooded lead acid batteries, the electrolyte in VRLA AGM batteries is absorbed on a fiber or fibrous material, such as a glass fiber mat, a polymeric fiber mat, a gelled electrolyte, and so forth. However, VRLA AGM battery systems are substantially more expensive to manufacture than flooded battery systems. VRLA AGM technology in some instances, may be more sensitive to overcharging, may dry out in high heat, may experience a gradual decline in capacity, and may have a lower specific energy. Similarly, in some instances, gel VRLA technology may have higher internal resistance and may have reduced charge acceptance.

In EFB systems, the electrode, or plates, are comprised of a lead alloy grid and an active material. During the manufacturing process of such an EFB, an active material paste is applied and cured on a lead alloy grid to form the electrodes, or plates. The paste may comprise one or more of carbon black, barium sulfate, lignosulfonate, sulfuric acid, and water. The curing process changes the paste to a mixture of lead sulfates, which upon the initial charging of the battery becomes an electrochemically active material. The paste on positive electrodes is known as positive active material (“PAM”). Similarly, active material on the negative electrode is known as negative active material (“NAM”). During charging and discharging cycles of the batteries, the electrodes undergo expansion and contraction. Over time, this distortion of the electrodes causes the active material to shed and physically separate from the electrode. As more and more active material sheds from the electrode, that electrode becomes less effective and the battery's performance and life are reduced. As such, there is a need for new battery separator and/or battery technology to meet and overcome the challenges arising from current lead acid battery systems, especially to prevent or impede the shedding of active material from the electrodes in enhanced flooded lead acid batteries.

For at least certain applications or batteries, there remains a need for improved separators providing for improved cycle life, reduced antimony poisoning, reduced water consumption, reducing float charge current, and/or reduced voltage required to fully recharge the battery. More particularly, there remains a need for improved separators, and improved batteries (such as such as those operating at a partial state of charge and/or deep-cycling batteries) comprising an improved separator, which provides for enhancing battery life, reducing battery failure, reducing water loss, improving oxidation stability, improving, maintaining, and/or lowering float current, improving end of charge (“EOC”) current, decreasing the current and/or voltage needed to charge and/or fully charge the battery, such as a deep cycle battery, minimizing internal electrical resistance increases, lowering electrical resistance, increasing wettability, lowering wet out time with electrolyte, reducing time of battery formation, reducing acid stratification, improving acid diffusion, and/or improving uniformity in lead acid batteries.

### SUMMARY

In accordance with at least selected embodiments, the present disclosure or invention may address the above issues or problems, especially but not limited to EFB batteries and separators, and/or may provide or may be directed to novel or improved separators, battery separators, membranes, separator membranes, enhanced flooded battery separators, fibrous mats, batteries, cells, and/or methods of manufacture and/or use of such separators, battery separators, fibrous mats, enhanced flooded battery separators, cells, and/or batteries. In accordance with at least certain embodiments, the present disclosure or invention is directed to novel or improved enhanced flooded lead acid battery separators for starting lighting ignition (“SLI”) batteries, fibrous mats, flooded batteries for deep cycle applications, and/or enhanced flooded batteries, and/or systems, vehicles, and/or the like including such separators, mats, batteries, and/or improved methods of making and/or using such improved separators, mats, cells, batteries, systems, vehicles, and/or the like. In accordance with at least certain embodiments, the present disclosure or invention is directed to an improved separator for enhanced flooded batteries and/or improved methods of making and/or using such batteries having such improved separators. In accordance with at least selected embodiments, the present disclosure or invention is directed to separators, particularly separators for enhanced flooded batteries having reduced electrical resistance and/or increased cold cranking amps. In addition, disclosed herein are methods, systems and battery separators for enhancing active material retention, enhancing battery life, reducing water loss, reducing internal resistance, increasing wettability, reducing acid stratification, improving acid diffusion, improving cold cranking amps, improving uniformity in at least enhanced flooded batteries, and/or the like. In accordance with at least particular embodiments, the present disclosure or invention is directed to an improved separator for enhanced flooded batteries wherein the separator includes one or more performance enhancing additives or coatings, optimized porosity, optimized void volume, amorphous silica, higher oil absorption silica, higher silanol group silica, retention and/or improved retention of active material on electrodes, and/or any combination thereof.

In accordance with at least selected embodiments, the present disclosure or invention is directed to separators for lead acid batteries, in particular flooded lead acid batteries, and various lead acid batteries, such as flooded lead acid batteries or enhanced flooded lead acid batteries, having the same. In accordance with at least selected embodiments, the present disclosure or invention is directed to novel or improved separators, cells, batteries, and/or methods of manufacture and/or use of such separators, cells, and/or batteries. In accordance with at least certain embodiments, the present disclosure or invention is directed to an improved separator for lead acid batteries and/or improved methods of using such batteries having such improved separators. In addition, disclosed herein are methods, systems and battery separators for enhancing active material retention, battery life, reducing battery failure, reducing water loss, improving oxidation stability, improving, maintaining, and/or lowering float current, improving end of charge (EOC) current, decreasing the current and/or voltage needed to charge and/or fully charge a deep cycle battery, minimizing internal electrical resistance increases, lowering electrical resistance, increasing wettability, lowering wet out time with electrolyte, reducing time of battery formation, reducing antimony poisoning, reducing acid stratification, improving acid diffusion, and/or improving uniformity in lead acid batteries. In accordance with at least particular embodiments, the present disclosure or invention is directed to an improved separator for lead acid batteries wherein the separator includes one or more improved performance enhancing additives and/or coatings. In accordance with at least certain embodiments, the disclosed separators are useful for deep-cycling applications, for instance in motive machines or vehicles and/or stationary machines or vehicles, such as golf carts, fork trucks, inverters, renewable energy systems and/or alternative energy systems, by way of example only, solar power systems and wind power systems; in particular, the disclosed separators are useful in battery systems wherein deep cycling and/or partial state of charge operations are part of the battery life, even more particularly, in battery systems where additives and/or alloys (e.g., antimony (Sb)) are added to the battery to enhance the life and/or performance of the battery and/or to enhance the deep cycling and/or partial state of charge operating capability of the battery.

In accordance with at least selected embodiments, the present disclosure is directed to improved lead acid batteries, such as flooded lead acid batteries, improved systems that include a lead acid battery, and/or a battery separator, improved battery separators, improved vehicles including such systems, methods of manufacture or use, or combinations thereof. In accordance with at least certain embodiments, the present disclosure or invention is directed to novel or improved flooded lead acid batteries, improved battery separators for such batteries, and/or methods of manufacturing, testing, using such improved flooded lead acid batteries, and/or combinations thereof. In addition, disclosed herein is a method, system, battery, and/or battery separator for reducing acid stratification, enhancing battery life and performance in a flooded lead acid battery, and in such batteries that operate in a partial state of charge.

Separators made from polyolefins, such as polyethylene, typically contain silica to facilitate separator wetting with the hydrophilic electrolyte. In some instances, a hydrophilic material, such as a fibrous mat, is provided adjacent to the separator to assist with wetting and to retain active material coated on the positive electrode. Likewise, the fibrous mat may be provided to retain active material on the negative electrode.

This application is also directed to new and improved lead acid batteries and vehicles having these new and improved lead acid batteries. The flooded lead acid batteries exhibit reduced acid stratification, which is a problem that, if severe enough, could result in inoperability of the battery. In addition to exhibiting reduced acid stratification, the flooded lead acid batteries described herein may exhibit other desirable properties such as improved charge acceptance.

In one aspect, a flooded lead acid battery has an electrode array, which is provided with one or more negative electrodes or plates and one or more positive electrodes or plates alternately arranged and interleafed with respect to one another is described. In this electrode array, at least one negative electrode is wrapped with at least one of a woven material and a nonwoven material. A ribbed or unribbed porous membrane is wrapped around an adjacent positive electrode (a positive electrode adjacent to the at least one wrapped negative electrode).

In some embodiments wherein the negative electrode is wrapped with a woven material, the woven material may be at least one selected from the group consisting of an extrudable mesh, a woven glass mat, and a carbon fiber woven material.

In other embodiments, wherein the negative electrode is wrapped with a nonwoven material, the nonwoven material may be formed from at least one material selected from the group consisting of glass, pulp, a polymer, and combinations thereof. In embodiments wherein the nonwoven is formed from a polymer, it may be formed from a polymer alone or in combination with glass and/or pulp. The polymer may be at least one selected from the group consisting of a polyolefin, a polyester, a polyamide, a polyimide, and combinations thereof. In some embodiments, the nonwoven material may be provided with, in addition to at least one of glass, pulp, a polymer, and combinations thereof, an inorganic powder. The inorganic powder may be silica. In some embodiments, the nonwoven material may be a spun-bond melt-woven composite material. In some embodiments, the nonwoven material is a carbon fiber nonwoven material.

The porous membrane, in some embodiments, may be ribbed. The porous membrane may ribs on one or both sides of the membrane. The ribs have a height of about 10 to about 200 m. In some embodiments, the porous membrane may be unribbed. Regardless of whether the porous membrane is ribbed or unribbed, the porous membrane may be made from at least one natural or synthetic material selected from the group consisting of polyolefins, phenolic resins, polyvinyl chloride (PVC), rubber, synthetic wood pulp, glass fibers, cellulosic fibers or combinations thereof.

In some embodiments, the porous membrane may be provided with polyethylene, silica, and residual or unextracted processing oil.

In some embodiments, the porous membrane wrapping the positive electrodes is sealed on one or more, two or more, or three but not four sides. In some embodiments, the fibrous mat wrapping the negative electrode is sealed on one or more, two or more, or three or more, but not four sides.

In another aspect, a flooded lead acid battery having an electrode array, which is provided with one or more negative electrodes and one or more positive electrodes alternately arranged with respect to one another is described. In this array, a fibrous mat is at least partially integrated into the negative electrode. Additionally, in this embodiment, a ribbed or unribbed porous membrane is wrapped around either the negative electrode with the fibrous mat partially integrated therein or around an adjacent positive electrode. In some embodiments, the fibrous mat is from 2% to 50% integrated into the negative electrode. In some embodiments, the fibrous mat is from 5 to 25% integrated into the negative electrode. In some embodiments, the fibrous mat is from 5 to 20% integrated into the negative electrode. In some embodiments, the fibrous mat is from 10 to 15% integrated into the negative electrode.

In some embodiments, a woven material is at least partially integrated into the negative electrode. The woven material may be at least one selected from the group consisting of an extrudable mesh, a woven glass mat, and a carbon fiber woven material.

In some embodiments, a nonwoven material is at least partially integrated into the negative electrode. The nonwoven material may be formed from at least one material selected from the group consisting of glass, pulp, a polymer, and combinations thereof. In embodiments wherein the nonwoven material is formed from a polymer, the polymer may be used alone or in combination with at least glass and/or pulp. The polymer may be at least one selected from the group consisting of a polyolefin, a polyester, a polyamide, a polyimide, and combinations thereof. In some embodiments, the nonwoven material may be provided with an inorganic powder in addition to at least one material selected from the group consisting of glass, pulp, a polymer, and combinations thereof. The inorganic powder may be silica. In some embodiments, the nonwoven material may be a spun-bond melt-woven composite material. In some embodiments, the nonwoven material may be a carbon fiber nonwoven material.

The porous membrane, in some embodiments, may be ribbed. The porous membrane may ribs on one or both sides of the membrane. The ribs have a height of about 10 to about 200 μm. In some embodiments, the porous membrane may be unribbed. Regardless of whether the porous membrane is ribbed or unribbed, the porous membrane may be made from at least one natural or synthetic material selected from the group consisting of polyolefins, phenolic resins, poly vinyl chloride (PVC), rubber, synthetic wood pulp, glass fibers, cellulosic fibers or combinations thereof. In some embodiments the porous membrane has polyethylene, silica, and residual or unextracted processing oil.

In some embodiments, the porous membrane wrapped around either the negative electrode with the fibrous mat at least partially integrated therein or around an adjacent positive electrode is sealed on one or more, two or more, or three, but not four sides.

In another aspect, a flooded lead acid battery has an electrode array, which has one or more negative electrodes and one or more positive electrodes alternately arranged with respect to one another, is described. In some embodiments, a negative electrode of the electrode array is wrapped with a porous membrane having ribs on at least one side thereof, and a fibrous mat is present between the wrapped negative electrode and the porous membrane wrapping the negative electrode. In some preferred embodiments, the ribs of the porous membrane are at least on a side of the porous membrane closest to the fibrous mat. The ribs of the porous membrane, whether present on a side of the porous membrane closest to the fibrous mat or on the opposite side, may have a height of from 5 μm to 300 μm or from 25 μm to 200 μm.

In some embodiments, in addition to being wrapped with the porous membrane, the wrapped negative electrode is also wrapped with the fibrous mat. In some embodiments, the nonwoven or woven material is at least partially integrated into the wrapped negative electrode. In some embodiments, the nonwoven or woven material is present between the ribs of the porous membrane. In embodiments wherein the nonwoven or woven material is present between the ribs of the porous membrane, the nonwoven or woven material has a thickness that is between 50% and 150% of the height of the ribs.

In some embodiments, a woven material is present between the wrapped negative electrode and the porous membrane wrapping the electrode. In such embodiments, the woven material is at least one selected from the group consisting of an extrudable mesh, a woven glass mat, and a carbon fiber woven material.

In some embodiments, a nonwoven material is present between the wrapped negative electrode and the porous membrane wrapping the electrode. Sometimes, the nonwoven material is formed from at least one material selected from the group consisting of glass, pulp, a polymer, and combinations thereof. In embodiments wherein a polymer is present in the nonwoven material, either alone, in combination with glass and/or pulp, or in combination with another material, the polymer is at least one selected from the group consisting of a polyolefin, a polyester, a polyamide, a polyimide, and combinations thereof. In some embodiments, in addition to having at least one of glass, pulp, a polymer, and combinations thereof, the nonwoven material may also have an inorganic powder. The inorganic powder may be silica. In some embodiments, the nonwoven material may be a spun-bond melt-woven composite material. In some embodiments, the nonwoven material is a carbon fiber nonwoven material.

The porous membrane, in some embodiments described herein, may have ribs on both sides. The porous membrane may be made from at least one natural or synthetic material selected from the group consisting of polyolefins, phenolic resins, poly vinyl chloride (PVC), rubber, synthetic wood pulp, glass fibers, cellulosic fibers or combinations thereof. In some embodiments, the porous membrane has polyethylene, silica, and residual or unextracted processing oil. The porous membrane wrapped around negative electrode may be, in some embodiments, sealed on one or more, two or more, or three, but not four sides.

In some embodiments, the fibrous mat wrapped around the negative electrode may be sealed one or more, two or more, or three, but not four sides.

In another aspect, a vehicle, including a start/stop vehicle, having one of more of the flooded lead acid batteries is described herein.

In a first exemplary embodiment, a lead acid battery is provided with an electrode array having one or more negative electrodes, and one or more positive electrodes interleaved between the one or more negative electrodes. At least one of the one or more negative electrodes is enveloped with a fibrous mat, and the one or more positive electrodes adjacent to the at least one of the one or more negative electrodes are enveloped with a porous membrane. The porous membrane may be a microporous battery separator.

In exemplary aspects, the fibrous mat may be a nonwoven, mesh, fleece, and/or the like, and/or combinations thereof. The fibrous mat may further be glass fibers, pulp, a polymer, and/or the like, and/or combinations thereof. In addition, the fibrous mat may be formed from a polymer and additionally with glass fibers, pulp, and/or the like, and/or combinations thereof, and the polymer may be a polyolefin, a polyester, a polyamide, a polyimide, and/or the like, and/or combinations thereof. The fibrous mat may be an inorganic material, such as silica. The fibrous mat be a spun-bond melt-nonwoven composite material or a carbon fiber nonwoven material, and/or the like.

An exemplary porous membrane may be provided with one or more arrays of ribs on at least one surface thereof, or one or more arrays of ribs on two surfaces thereof. The ribs may have a height of about 10 μm to about 2.0 mm. The porous membrane may be one or more of natural materials, synthetic materials, polyolefins, phenolic resins, poly vinyl chloride (PVC), natural rubber, synthetic rubber, synthetic wood pulp, glass fibers, lignins, cellulosic fibers, and/or the like, and/or combinations thereof. Alternatively, the porous membrane may be polyethylene, silica, and processing oil, wherein the processing oil is in an amount of about 5% by weight of the porous membrane to about 15% by weight of the porous membrane.

In certain select aspects, the porous membrane has a porosity of greater than about 55%, about 60%, about 65%.

In another exemplary aspect, the porous membrane of an exemplary lead acid battery may be enveloped about the positive electrode and sealed on either on one side, two sides, and/or three sides of the positive electrode.

In yet another exemplary aspect, the fibrous mat of an exemplary lead acid battery may be enveloped about the negative electrode and sealed on one side, two sides, and/or three sides of the negative electrode.

In yet another exemplary embodiment, one example of a preferred lead acid battery may be provided with an electrode array comprising one or more negative electrodes, and one or more positive electrodes interleaved between the one or more negative electrodes. The battery may further be provided with one or more electrode and fibrous mat assemblies comprising a fibrous mat at least partially integrated into at least one of the negative electrodes. A porous membrane, which may be a microporous membrane, may be enveloping one or more of the one or more electrode and fibrous mat assemblies or at least one of the one or more positive electrodes adjacent to the one or more electrode and fibrous mat assemblies. In an exemplary aspect, the fibrous mat may be integrated into the active material from about 2% to about 50% of a mat thickness of the fibrous mat, from about 5% to about 25% of the mat thickness, from about 5% to about 20% of the mat thickness, or from about 10% to about 15% of the mat thickness.

Any exemplary fibrous mat may be one or more of a nonwoven, mesh, fleece, and/or the like, and/or combinations thereof. In addition, the fibrous mat may be one or more of glass fibers, pulp, a polymer, and/or the like, and/or combinations thereof. Furthermore, the fibrous mat may be formed of a polymer and additionally with one or more of glass fibers, pulp, and/or the like, and/or combinations thereof, and the polymer may be one or more of a polyolefin, a polyester, a polyamide, a polyimide, and/or the like, and/or combinations thereof.

In another aspect of an exemplary lead acid battery, an exemplary fibrous mat may be an inorganic material, such as silica. The fibrous mat may be a spun-bond melt-nonwoven, a carbon fiber nonwoven, and/or the like.

In a further aspect of an exemplary lead acid battery, an exemplary porous membrane may have one or more arrays of ribs on one or two surfaces thereof. The ribs of the one or more arrays of ribs may have a height of about 10 μm to about 2.0 mm.

An exemplary porous membrane may be at least one of natural materials, synthetic materials, polyolefins, phenolic resins, poly vinyl chloride (PVC), natural rubber, synthetic rubber, synthetic wood pulp, glass fibers, lignins, cellulosic fibers, and/or the like, and/or combinations thereof. In one particular embodiment, the porous membrane may be polyethylene, silica, and processing oil.

In another exemplary aspect, the porous membrane of an exemplary lead acid battery may be enveloped about the positive electrode and sealed on either on one side, two sides, and/or three sides of the positive electrode. In yet another exemplary aspect, the porous membrane of an exemplary lead acid battery may be sealed on one side, two sides, and/or three sides of the one or more electrode and fibrous mat assemblies.

In a further select embodiment of an exemplary preferred embodiment, a lead acid battery is provided with an electrode array of one or more negative electrodes and one or more positive electrodes alternately arranged with respect to one another. A porous membrane envelope is further provided to envelope at least one of the one or more negative electrodes disposed therein, with the porous membrane comprises ribs on one or more surfaces thereof and a fibrous mat is disposed within the envelope. The ribs may at least be partially on a surface of the porous membrane adjacent to the fibrous mat. The ribs may have a height of from about 10 μm to about 2.0 mm, or from about 5 μm to about 300 μm, or from about 25 μm to about 200 μm. In addition, the fibrous mat may envelope the at least one of the one or more negative electrodes. Furthermore, the fibrous mat may be at least partially integrated into the negative electrode.

Alternatively, the fibrous mat may be discrete pieces disposed between the ribs, and have a thickness from about 50% of the height of the ribs to about 150% of the height of the ribs. In select aspects of the present invention, the fibrous mat may be disposed between the negative electrode and the porous membrane. The fibrous mat may be one or more of glass fibers, pulp, a polymer, and combinations thereof. The fibrous mat may be formed from a polymer in combination with one or more of glass fibers, pulp, and combinations thereof; wherein the polymer may be one or more of a polyolefin, a polyester, a polyamide, a polyimide, and combinations thereof. In addition, the fibrous mat may be an inorganic material, such as silica. The fibrous mat may be a spun-bond melt-nonwoven composite material, or a carbon fiber nonwoven material.

Furthermore, the fibrous mat may additionally have a carbon component either as part of the mat or in a layer adjacent to the negative electrode. For example, the fibrous mat may have carbon fiber, conductive carbon, graphite, artificial graphite, activated carbon, carbon paper, acetylene black, carbon black, high surface area carbon black, graphene, high surface area graphene, keitjen black, carbon fibers, carbon filaments, carbon nanotubes, open-cell carbon foam, a carbon mat, carbon felt, carbon Buckminsterfullerene (Bucky Balls), an aqueous carbon suspension, flake graphite, oxidized carbon, and combinations thereof. In addition, the fibrous mat may have a nucleation additive such as carbon as described above or barium sulfate (BaSO₄).

In select embodiments, the porous membrane may have ribs on two surfaces thereof. In addition, the porous membrane may be one or more of natural materials, synthetic materials, polyolefins, phenolic resins, poly vinyl chloride (PVC), natural rubber, synthetic rubber, synthetic wood pulp, glass fibers, lignins, cellulosic fibers, and combinations thereof. Specifically, the porous membrane may be polyethylene, silica, and processing oil.

In select aspects of the present invention, the porous membrane may be sealed on one side of the negative electrode, two sides of the negative electrode, or three sides of the negative electrode. In addition, the fibrous mat may be sealed on one side of the negative electrode, two sides of the negative electrode, and three sides of the negative electrode.

In select embodiments of the present invention, a system is provided with a vehicle utilizing one or more batteries as substantially described herein. The vehicle may be an automobile, a truck, a motorcycle, an all-terrain vehicle, a motorcycle, a forklift, a golf cart, a hybrid vehicle, a hybrid-electric vehicle, an electric vehicle, an idling-start-stop (“ISS”) vehicle, an e-rickshaw battery, an e-trike, an e-bike, a wheel chair, or a marine vessel.

In select embodiments, a lead acid battery as substantially described herein may be a flat-plate battery, a flooded lead acid battery, an enhanced flooded lead acid battery (“EFB”), a valve regulated lead acid (“VRLA”) battery, a gel battery, an absorptive glass mat (“AGM”) battery, a deep-cycle battery, a tubular battery, an inverter battery, a vehicle battery, a starting-lighting-ignition (“SLI”) vehicle battery, an idling-start-stop (“ISS”) vehicle battery, an automobile battery, a truck battery, a motorcycle battery, an all-terrain vehicle battery, a forklift battery, a golf cart battery, a hybrid-electric vehicle battery, an electric vehicle battery, a wheel chair battery, an e-rickshaw battery, an e-trike battery, an e-bike battery, or a marine vessel battery.

In select embodiments, a method is provided for preventing or mitigating acid displacement in a lead acid battery, a flooded lead acid battery, or a flooded lead acid battery operating or intended to be operated in a partial state of charge. The method may include manufacturing a battery such that it has a structure substantially identical to any battery as described herein.

Novel or improved systems, vehicles, batteries, enhanced flooded lead acid batteries, deep-cycle batteries, separators, battery separators, enhanced flooded lead acid battery separators, deep-cycle battery separators, separators, fibrous mats, cells, electrodes, and/or methods of manufacture and/or use of such batteries, enhanced flooded lead acid batteries, deep-cycle batteries, separators, battery separators, enhanced flooded lead acid battery separators, deep-cycle battery separators, fibrous mats, cells, and/or electrodes as shown or described herein.

Novel or improved batteries, particularly lead acid batteries as shown and/or described herein; novel or improved systems, vehicles, batteries, enhanced flooded lead acid batteries, deep-cycle batteries, separators, battery separators, enhanced flooded lead acid battery separators, deep-cycle battery separators, separators, fibrous mats, cells, electrodes, and/or methods of manufacture and/or use of such systems, vehicles, batteries, enhanced flooded lead acid batteries, deep-cycle batteries, separators, battery separators, enhanced flooded lead acid battery separators, deep-cycle battery separators, separators, fibrous mats, cells, and/or electrodes; an improved battery with an improved separator for lead acid batteries and/or improved methods of using such batteries having such improved separators; methods, systems, treatments, and battery separators for enhancing battery life, reducing battery failure, reducing water loss, lowering float current, mitigating increases in internal resistance, increasing wettability, reducing acid stratification, improving acid diffusion, preserving active material, mitigating active material shedding, and/or improving uniformity in lead acid batteries; an improved separator for lead acid batteries wherein the separator includes improved functional coatings, improved battery separators that reduce acid stratification, improved battery separators that improve acid diffusion, improved lead acid batteries that preserve active material, improved lead acid battery separators that mitigate active material shedding, improved lead acid batteries including such improved separators, long-life automotive lead acid batteries, improved flooded lead acid batteries, and/or the like, and/or batteries having reduced acid stratification, improved acid diffusion, improved ability to preserve active material, and/or improved ability to reduce active material shedding, a battery having a polyethylene separator and a negative electrode with a fibrous mat disposed therebetween, and/or methods of manufacture and/or use of such a battery; a battery with a porous membrane and a fibrous mat laminated thereto, wherein the fibrous mat is adjacent to a negative electrode in such battery, and/or methods of manufacture, and/or use of such a battery.

As described herein, exemplary separators may be used in lead acid batteries that are utilized in a variety of applications. Such applications may include, for example: partial state of charge applications; deep-cycling applications; automobile applications; truck applications; motorcycle applications; motive power applications, such as fork trucks, golf carts (also called golf cars), and the like; electric vehicle applications; hybrid-electric vehicle (“HEVs”) applications; ISS vehicle applications; e-rickshaw applications; e-trike applications; e-bike applications; boat applications; energy collection and storage applications, such as renewable and/or alternative energy collection and storage, such as wind energy, solar energy, and the like. In addition, exemplary separators may be used in a variety of batteries. Such exemplary batteries may include, for example: flooded lead acid batteries, such as enhanced flooded lead acid batteries; AGM batteries; VRLA batteries; plate batteries; tubular batteries; partial state of charge batteries; deep-cycling batteries; automobile batteries; truck batteries; motorcycle batteries; motive power batteries, such as fork truck batteries, golf cart (also called golf cars) batteries, and the like; electric vehicle batteries; hybrid-electric vehicle (“HEVs”) batteries; ISS vehicle batteries; e-rickshaw batteries; e-trike batteries; e-bike batteries; boat batteries; energy collection and storage batteries, such as renewable and/or alternative energy collection and storage, such as wind energy, solar energy, and the like.

### BRIEF DESCRIPTION OF THE FIGURES

FIG. 1 schematically illustrates a typical flooded lead acid battery.

FIGS. 2A and 2B are side-view illustrations of an embodiments of an electrode/separator array according to exemplary embodiments of the present description.

FIGS. 3A and 3B are side-view depictions of an embodiments of an electrode/separator array according to exemplary embodiments of the present description.

FIG. 4 is a side-view of an embodiment of an electrode/separator array according to one exemplary embodiment of the present description.

FIGS. 5A and 5B are side-view illustrations of an embodiment of an electrode/separator array according to one exemplary embodiment of the present description.

FIGS. 6A and 6B are side-view illustrations of an embodiment of an electrode/separator array according to one exemplary embodiment of the present description.

FIGS. 7A and 7B are photographs of an exemplary fibrous mat as described in the present disclosure.

FIGS. 8A and 8B are higher resolution photographs of the exemplary fibrous mat of FIGS. 7A and 7B, with FIG. 8A taken from a top-down view and FIG. 8B taken at an oblique angle to the mat lying flat.

FIG. 9 shows SEM images at a low magnification comparing an exemplary fibrous mat as described herein to that of a conventional glass mat.

FIG. 10 shows SEM images at a higher magnification than that of FIG. 11 of an exemplary fibrous mat as described in the present disclosure.

FIG. 11 is an SEM image of an exemplary fibrous mat as described in the present disclosure highlighting fiber diameters.

FIG. 12 is an SEM image of an exemplary fibrous mat as described in the present disclosure highlighting pore areas.

FIGS. 13A and 13B illustrate longitudinal ribs in the machine direction and lateral or transverse ribs in the cross-machine direction.

FIGS. 14A through 15B are side views of an exemplary porous membrane detailing a membrane's dimensions of both positive ribs and negative ribs.

### DETAILED DESCRIPTION

Embodiments described herein may be best understood more readily by reference to the following detailed description, examples, and drawings or figures (i.e., “FIG.” or “Figs.”). Among other things, various batteries, vehicles, or devices, and methods for preventing acid stratification, among other things, are described herein, however, such are not limited to the specific embodiments presented in the detailed description, examples, and figures. It is recognized that these embodiments are merely illustrative of the principles of the present invention. Numerous modifications and adaptations will be readily apparent to those of skill in the art without departing from the disclosed subject matter.

### Lead Acid Battery

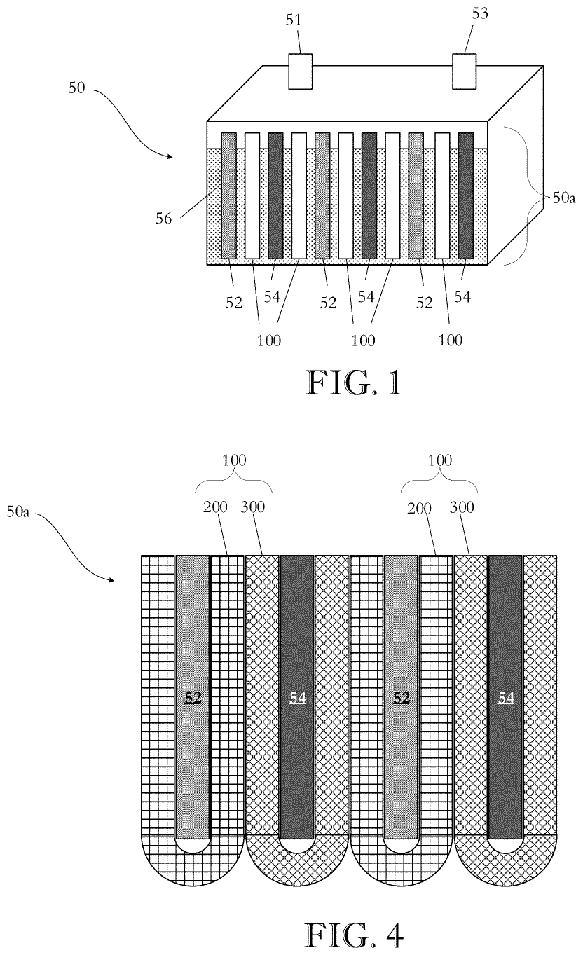

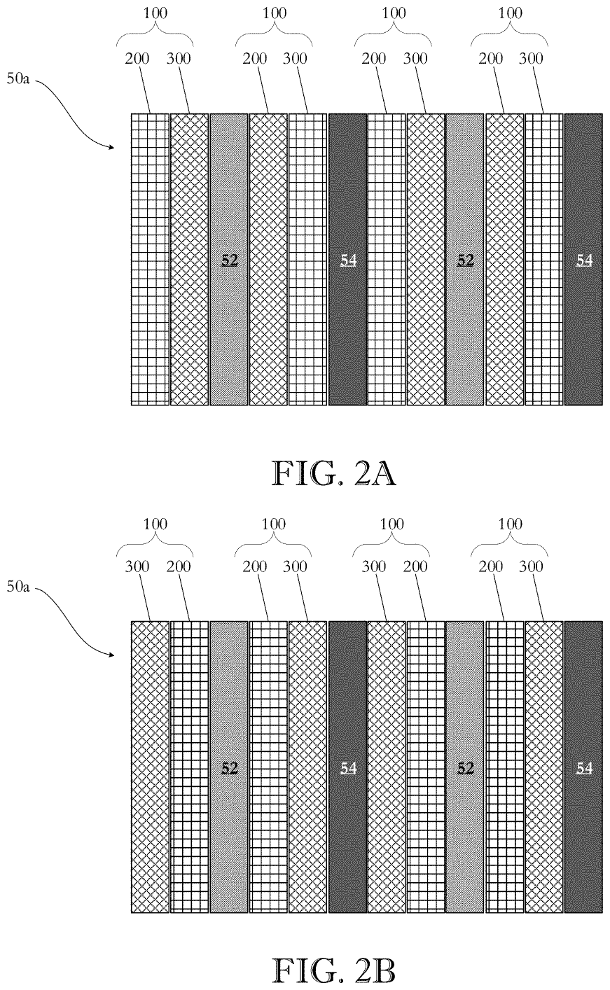

Referring now to FIG. 1, an exemplary flooded lead acid battery 50, such as an EFB, is provided with an array 50a of alternating positive electrodes 52 and negative electrodes 54, such that the positive electrodes 52 are interleaved between the negative electrodes 54. The array 50a is further provided with a separator assembly 100 interleaved between each electrode 52, 54, such that the separator assemblies 100 separator the electrodes 52, 54 to prevent contact between the electrodes 52, 54. The array 50a is substantially submerged in a sulfuric acid (H₂SO₄) electrolyte 56 (e.g., sulfuric acid with an exemplary specific weight with respect to water of between about 1.20 and 1.35). The positive electrodes 52 are in electrical communication with the positive terminal 51, and negative electrodes 54 are in electrical communication with the negative terminal 53. The separator assemblies 100 include a porous membrane (200 in FIGS. 2A-8), and may additionally be provided with one or more fibrous mat(s) (300 in FIGS. 2A-8).

The lead acid batteries described herein are not so limited and may be flooded lead acid batteries, such as enhanced flooded lead acid batteries, absorbent glass mat (“AGM”) batteries, valve regulated lead acid (“VRLA”) batteries, gel batteries, and/or the like. In some preferred embodiments, the lead acid batteries described herein are flooded lead acid batteries, at least because some of the disclosure herein is directed at solving a problem of flooded lead acid batteries, particularly flooded lead acid batteries operating at a partial state of charge or in a partial state of charge, namely acid stratification and active material shedding.

As described herein, exemplary separators may be used in lead acid batteries that are utilized in a variety of applications. Such applications may include, for example: partial state of charge applications; deep-cycling applications; automobile applications; truck applications; motorcycle applications; motive power applications, such as fork trucks, golf carts (also called golf cars), and the like; electric vehicle applications; hybrid-electric vehicle (“HEVs”) applications; ISS vehicle applications; e-rickshaw applications; e-trike applications; e-bike applications; boat applications; energy collection and storage applications, such as renewable and/or alternative energy collection and storage, such as wind energy, solar energy, and the like. In addition, exemplary separators may be used in a variety of batteries. Such exemplary batteries may include, for example: flooded lead acid batteries, such as enhanced flooded lead acid batteries; AGM batteries; VRLA batteries; plate batteries; tubular batteries; partial state of charge batteries; deep-cycling batteries; automobile batteries; truck batteries; motorcycle batteries; motive power batteries, such as fork truck batteries, golf cart (also called golf cars) batteries, and the like; electric vehicle batteries; hybrid-electric vehicle (“HEVs”) batteries; ISS vehicle batteries; e-rickshaw batteries; e-trike batteries; e-bike batteries; boat batteries; energy collection and storage batteries, such as renewable and/or alternative energy collection and storage, such as wind energy, solar energy, and the like.

### Negative and Positive Electrodes

The positive and negative electrodes or plates disclosed herein are not so limited and may be any positive or negative electrode known to be acceptable for use in a lead acid battery. Typically, in a lead acid battery, the negative electrode or plate is provided as a lead oxide (PbO₂) grid with a negative active material (“NAM”) coating the negative grid and the positive electrode or plate is provided as a sponge lead (Pb) grid with a positive active material (“PAM”) coating the positive grid. As used herein, “electrode,” and “plate,” may be used interchangeably. In some preferred embodiments, the electrodes may have either a plante plate construction, a flat plate construction, or a tubular electrode construction.

Exemplary electrodes having a flat plate construction is provided with a grid and active material (e.g., positive active material (“PAM”), or negative active material (“NAM”)). The grid may be made of lead alone, or a lead alloy having at least one of antimony, calcium, tin, selenium, and combinations thereof. The amount of the additive to lead may be, for example, from about 1% to about 20%, from about 1% to about 15%, from about 1% to about 10%, from about 1% to about 6%, from about 1% to about 5%, from about 1% to about 4%, from about 1% to about 3%, from about 1% to about 2%, etc. In certain select embodiments, the grid may be made of an alloy of lead and antimony. Antimony is believed to improve hardness. In other select embodiments, the grid may be made of an alloy of lead and calcium. Calcium is believed to improve the hardness. In some select embodiments, tin may be added to the alloy of lead and calcium or lead and antimony to improve cyclability. The active material in an electrode having a flat plate construction is formed by applying a paste onto the grid. The paste may be provide with a mixture of lead (e.g., lead oxide), water, and sulfuric acid. Following the pasting operation, in some embodiments, the electrodes may be cured.

Exemplary electrodes having a tubular construction is provided with a series of spines that extend downward from a top bar; this is called a comb. The comb may be made of lead alone or lead and at least one selected from antimony, calcium, tin, and selenium. The amount of the additive to lead may be from 1% to 20%, from 1% to 15%, from 1% to 10%, from 1% to 6%, from 1% to 5%, from 1% to 4%, from 1% to 3%, from 1% to 2%, etc. In some preferred embodiments, the comb or grid may be made of lead and antimony. Antimony is believed to improve hardness. In some other embodiments that may be preferred, the grid is made of lead and calcium. Calcium is believed to improve the hardness. In some embodiments, tin may be added to the alloy of lead and calcium or lead and antimony to improve cyclability. Parallel tubes or gauntlets surround the spines and retain the active material (positive or negative). These gauntlets may be made of a porous inert woven or nonwoven fabrics.

### Electrode Array

Referring now to FIGS. 2A and 2B, exemplary electrode/separator arrays 50a, as generally described hereinabove, are provided with an array of positive electrodes 52 with an array of negative electrodes 54 interleaved therebetween, and with an array of separator assemblies 100 interleaved between each electrode 52, 54. As shown, the separator assembly 100 is provided with a porous membrane 200, which may or may not be provided with positive ribs (not shown in FIG. 2A or 2B, but described hereinafter) and/or negative ribs (not shown in FIG. 2A or 2B, but described hereinafter), and a fibrous mat 300. Alternatively, the fibrous mat 300 may be one or more mats. As shown in FIG. 2A, the fibrous mat 300 is disposed adjacent to the positive electrode(s) 52 and the porous membrane 200; and the porous membrane 200 is disposed adjacent to the negative electrode(s) 54 and the fibrous mat 300. As shown in FIG. 2B, the fibrous mat 300 is disposed adjacent to, and in intimate contact with, the negative electrode(s) 54 and the porous membrane 200; and the porous membrane 200 is disposed adjacent to the positive electrode(s) 52 and the fibrous mat 300. The separator assembly 100 may provide the porous membrane 200 and fibrous mat 300 attached to one another via adhesives, heat-staking, ultrasonic welding or sealing, ultrasonic sewing, co-extrusion, and/or combinations thereof. Alternatively, the separator assembly 100 may provide the porous membrane 200 and fibrous mat 300 unattached to one another. As shown, the separator assembly 100 is provided in a loose-leaf configuration. Alternatively, the separator assembly 100 may be provided as an envelope, a hybrid envelope, a pocket, a sleeve, a wrap, a fold, or combinations thereof. A combination refers to the possibility that different configurations may be used throughout the electrode/separator array 50a.

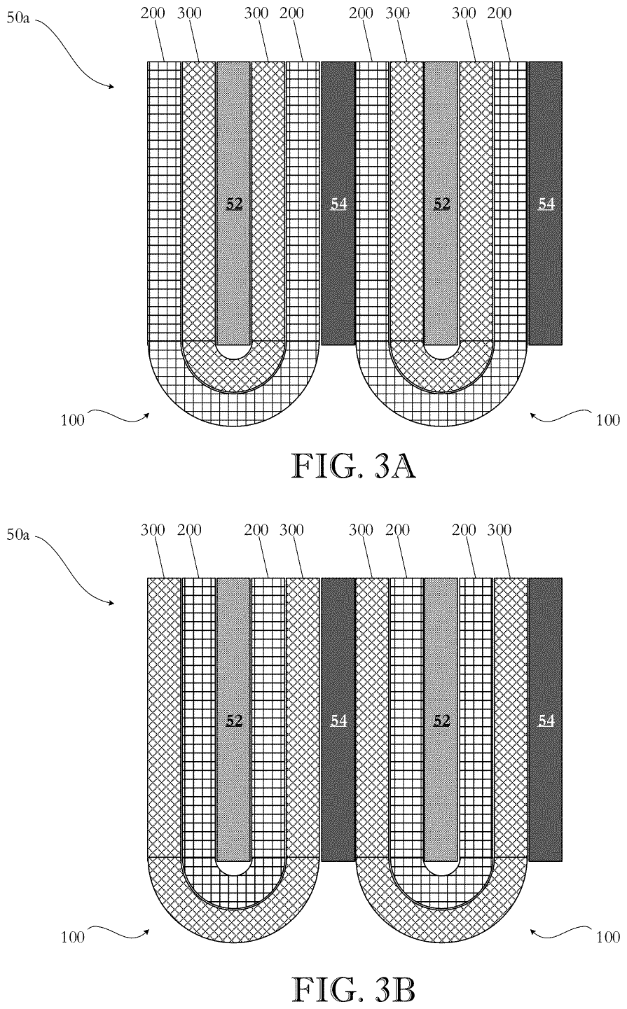

Referring now to FIGS. 3A and 3B, exemplary electrode/separator arrays 50a, as generally described hereinabove, are provided with an array of positive electrodes 52 with an array of negative electrodes 54 interleaved therebetween, and with an array of separator assemblies 100 interleaved between each electrode 52, 54. As shown, the separator assembly 100 is provided with a porous membrane 200, which may or may not be provided with positive ribs (not shown in FIG. 3A or 3B for clarity, but described hereinafter) and/or negative ribs (not shown in FIG. 3A or 3B for clarity, but described hereinafter), and a fibrous mat 300. Alternatively, the fibrous mat 300 may be one or more mats. As shown in FIG. 3A, the fibrous mat 300 is disposed about the positive electrode(s) 52 in an enveloped fashion; and the porous membrane 200 is disposed about the fibrous mat 300 in an enveloped fashion. As shown in FIG. 3B, the fibrous mat 300 is disposed about, and in intimate contact with, the negative electrode(s) 54 in an enveloped fashion; and the porous membrane 200 is disposed about the fibrous mat 300 in an enveloped fashion. The separator assembly 100 may provide the porous membrane 200 and fibrous mat 300 attached to one another via adhesives, heat-staking, ultrasonic welding or sealing, ultrasonic sewing, co-extrusion, and/or combinations thereof. Alternatively, the separator assembly 100 may provide the porous membrane 200 and fibrous mat 300 unattached to one another. As shown, the separator assembly 100 is provided in an enveloped configuration. Alternatively, the separator assembly 100 may be provided as a hybrid envelope, a pocket, a sleeve, a wrap, a fold, or combinations thereof. A combination refers to the possibility that different configurations may be used throughout the electrode/separator array 50a.

Referring now to FIG. 4, an exemplary electrode/separator array 50a, as generally described hereinabove, is provided with an alternating array of positive electrodes 52 and negative electrodes. In FIG. 4, the separator assemblies 100 are provided with a porous membrane 200, which may or may not be provided with positive ribs (not shown in FIG. 4, but described hereinafter) and/or negative ribs (not shown in FIG. 4, but described hereinafter), and a fibrous mat 300. Alternatively, the fibrous mat 300 may be one or more mats. As shown, the fibrous mat 300 is disposed about the negative electrode(s) 52 in an enveloped or pocketed fashion. The porous membrane 200 is disposed about the positive electrode(s) 54 in an enveloped or pocketed fashion. The porous membrane and fibrous mat may be configured as separator envelopes, which may or may not be a hybrid envelope configuration. Alternatively, the unattached porous membrane 200 and fibrous mat 300 may be provided as a loose-leaf, a pocket, a sleeve, a wrap, a fold, an S wrap, a Z fold, or combinations thereof. A combination refers to the possibility that different configurations may be used throughout the electrode/separator array 50a.

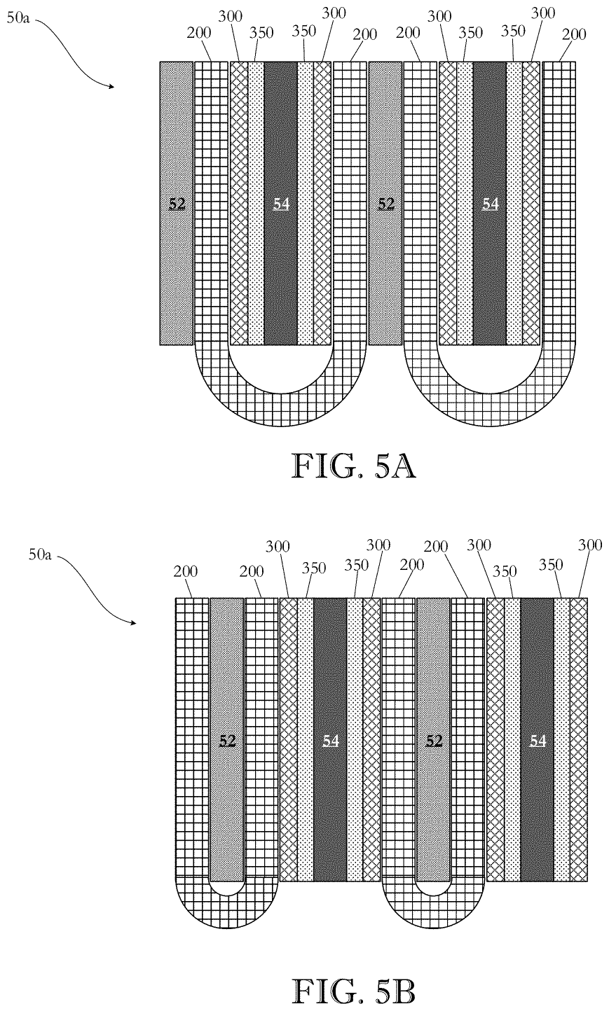

Referring now to FIGS. 5A and 5B, exemplary embodiments are provided with a fibrous mat(s) 300 at least partially integrated into the negative electrode 54 active material of the array 50a. In FIG. 5A, a porous membrane 200 is disposed about the negative electrode 54 and fibrous mat 300 integration in an enveloped fashion. Whereas in FIG. 5B, a porous membrane is disposed about the positive electrode 52 in an enveloped fashion. Regarding the porous membrane 200, it may be provided as an envelope (as shown), which may be a hybrid envelope, a loose leaf, a pocket, a sleeve, a wrap, and/or the like, or a combination thereof. A combination refers to the possibility that different configurations may be used throughout the electrode/separator array 50a. The porous membrane 200 may or may not be provided with positive ribs (not shown in FIG. 5A or 5B for clarity, but described hereinafter) and/or negative ribs (not shown in FIG. 5A or 5B for clarity, but described hereinafter).

As stated above, the fibrous mat 300 is at least partially integrated with the negative electrode active material. Therefore, the fibrous mat is more than just contacting the surface of the negative electrode; it is integrally attached to the negative electrode. The negative active material enters the gaps and pores of the fibrous mat so that a layer 350 is formed which is a mixture of the fibrous mat 300 and negative active material (“NAM”) of the negative electrode 54. In some embodiments, the fibrous mat is from 2% to 50% integrated into the NAM. This means that 2% to 50% of the thickness of the fibrous mat is embedded into the NAM forming a composite layer 350 that is a mixture of the fibrous mat 300 and the NAM. In some embodiments, the fibrous mat 300 is from 5% to 25% integrated into the negative electrode 54. In some embodiments, the fibrous mat 300 is from 5% to 20% integrated into the negative electrode 54. In some embodiments, the fibrous mat 300 is from 10% to 15% integrated into the negative electrode 54.

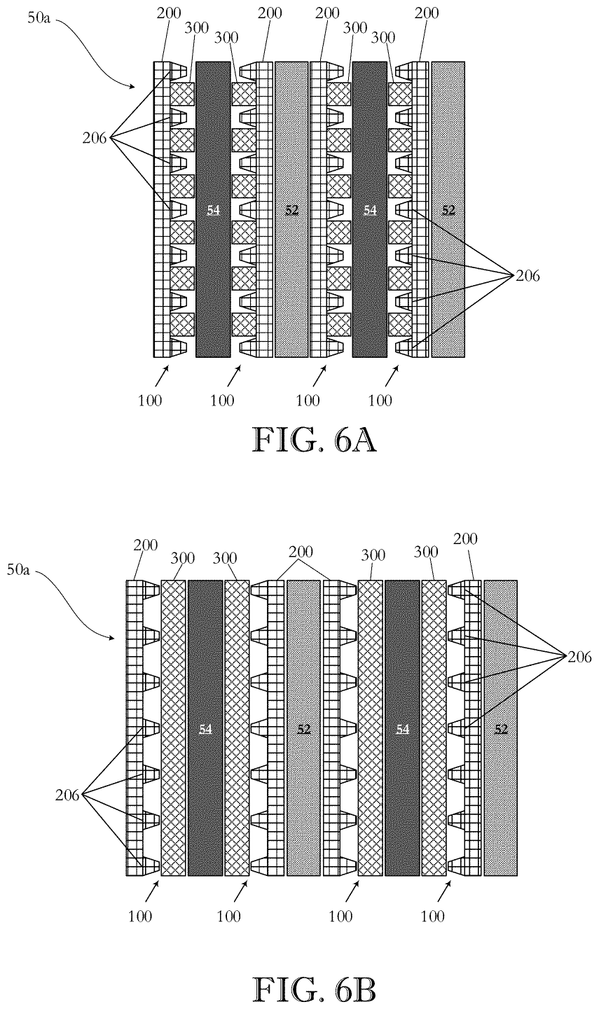

Referring now to FIGS. 6A and 6B, an exemplary electrode/separator array 50a, as generally described hereinabove, is provided with an array of positive electrodes 52 with an array of negative electrodes 54 interleaved therebetween, and with an array of separator assemblies 100 interleaved between each electrode 52, 54. In FIG. 6, the separator assembly 100 is provided with a porous membrane 200, which may or may not be provided with positive ribs (not shown in FIG. 6 for clarity, but described hereinafter) and/or negative ribs (not shown in FIG. 6 for clarity, but described hereinafter), and a fibrous mat 300. As shown, the fibrous mat 300 is disposed adjacent to the positive electrode(s) 52 and the porous membrane 200, and the porous membrane 200 is disposed adjacent to the negative electrode(s) 54 and the fibrous mat 300. The separator assembly 100 may provide the porous membrane 200 and fibrous mat 300 attached to one another via adhesives, heat-staking, ultrasonic welding or sealing, ultrasonic sewing, co-extrusion, and/or combinations thereof. Alternatively, the separator assembly 100 may provide the porous membrane 200 and fibrous mat 300 unattached to one another. As shown in FIGS. 6A and 6B, exemplary separator assemblies 100 may be provided with a porous membrane 200 having negative ribs 206 (i.e., ribs on the porous membrane surface that faces the negative electrode) arranged in a machine directions of the porous membrane 200 (i.e., longitudinally disposed from the top to bottom of the battery). As shown in FIG. 6A, strips of an exemplary fibrous mat 300 are disposed between these negative ribs 206. The strips of fibrous mat 300 may have a thickness from approximately 50% of the height of the ribs 206 to approximately 150% of the height of the ribs 206. As shown in FIG. 6B, an exemplary porous mat 300 is disposed between the porous membrane 200 and negative electrode 54.

It is appreciated that the fibrous mat will prevent or slow the process of shedding or detaching of the active material from the electrode that it is adjacent to, whether the active material is NAM or PAM.

### Fibrous Mat

A preferred fibrous mat composition may be, for example, glass fiber, synthetic fiber, or any combination thereof. An exemplary embodiment of a fibrous mat may be 5% to 25% synthetic fiber, with the remainder being glass and/or binder. However, the mat may be entirely glass or entirely synthetic. Such examples of synthetic fibers may be polyolefins, polyethylene, polypropylene, polyester, polyethylene terephthalate (“PET”), polyamides, polyimides, acrylic, other plastics, pulp; and combinations thereof. Further, the fiber composition may be a polymer, homopolymer, or copolymer, or a mix of fibers having a combination of these compositions. Whatever the composition of the fibrous mat, it is preferable that it be resistant to the acid electrolyte of the lead acid battery. These materials tend to be hydrophobic, thus causing gas entrapment. Therefore, a surfactant coating as generally described herein may be added.

The fibrous mat may further have fillers, such as particulate silica to increase the surface area and reduce pore size. Other exemplary fillers may include silica, talc (Mg₂SiO₄), aluminum oxide, hydrated alumina, titanium oxide, zirconium oxide, sodium silicate, and/or the like, and combinations thereof. Such fillers and silicas may also be utilized in the porous membrane and are further described herein. The fibrous mat composition may further have soluble fibers. The fibrous mat may also include a gelling agent to assist in resisting acid stratification. In addition, the fibrous mat may include a wetting agent additive or coating as generally described hereinbelow. Exemplary fibrous mats may further be provided with at least one of carbon, such as graphite, acetylene black, graphene, and/or the like.

Exemplary fibrous mats may be made from randomly-positioned fibers, cords, filaments, or threads which are held together by mechanical interlocking, by fusing of the fibers, and/or by bonding the fibers with a binder, such as a cementing medium. Web formation may be accomplished by various processes including, dry laying, wet laying, wet felting, needle felting, carroting, or extrusion of filaments onto a moving belt. Within the extrusion category, two processes include spunbonding, such as making spunbonded nonwovens, and melt-blowing, such as making melt-blown nonwovens. See, Turbak, A., Ed., Nonwovens: Theory, Process, Performance, and Testing, TAPPI Press, Atlanta, Ga. (1993). Chapter 8 being incorporated herein by reference. Spunbonded nonwovens are formed by filaments that have been extruded, drawn, and then laid on a continuous belt. Melt-blown nonwovens are formed by extruding molten polymer through a die, attenuating the extruded filament via air or steam, and collecting them on a moving belt. The nonwoven material may also be a melt-blown-spunbonded material having one or more melt-blown layers and one or more spunbonded layers provided in any order. For example a spunbonded layer and a melt-blown layer in any order, or more than two layers.

The fibrous mat described herein is not so limited. It may be a nonwoven material, a mesh, a fleece, a felt, scrims, pasting papers, or combinations thereof. For example, the fibrous mat may be a composite material of a nonwoven and a mesh material adjacent to one another, multiple different nonwoven mats adjacent to one another, multiple plies of the same nonwoven material adjacent to one another, or other various combinations. The composite materials may have one, two, or multiple (3 or more) plies or layers of materials adjacent to one another, or possibly attached to one another.

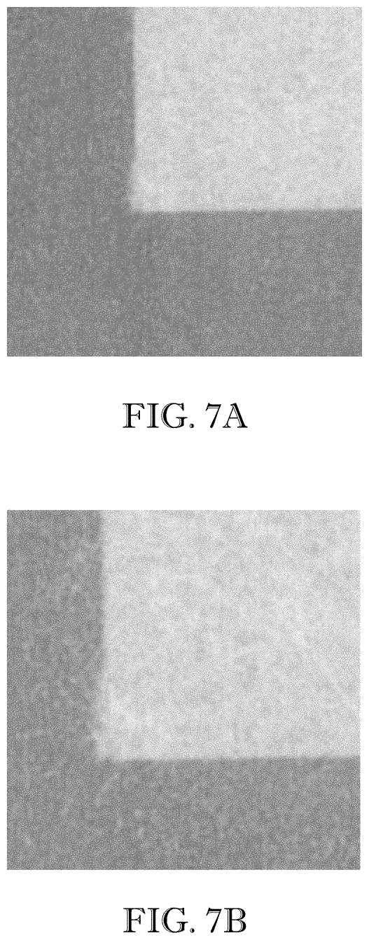

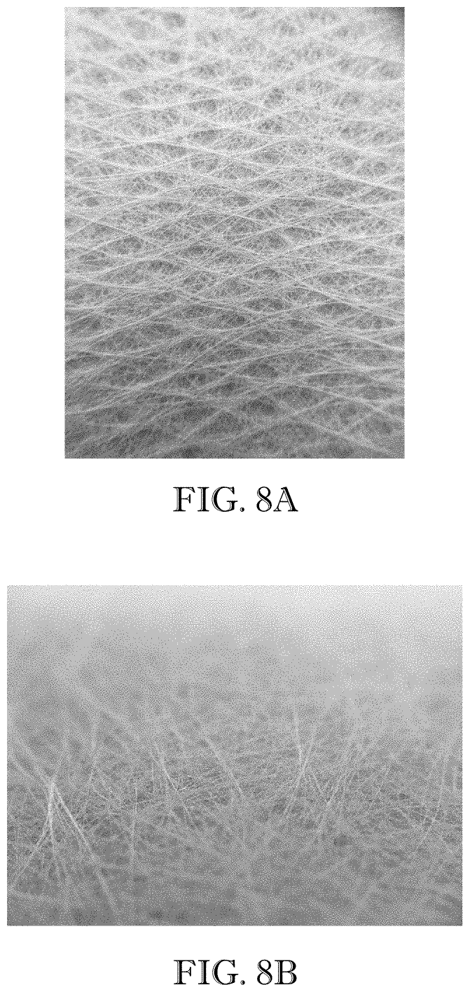

With reference now to FIGS. 7A and 7B, photographs of an exemplary embodiment of a fibrous mat are shown. FIGS. 8A and 8B are higher resolution photographs of an exemplary embodiment of a fibrous mat. The fibrous mat may be nonwoven, a fleece, a felt, a mesh, or any combination of layers thereof. The fibrous mat may be a single layer, double layer, or other multi-layer mat. An exemplary nonwoven mat may have a thickness in the range of approximately 100 μm to approximately 900 μm, and preferably in the range of approximately 200 μm to approximately 450 μm. FIGS. 8A and 8B show a pattern of bundled fibers. This may be accomplished during the forming of the mat, as the fiber carrier fluid is drained away, the fibers may collect at certain low points in the draining mesh. In addition, the mat may possess combed fibers.

An exemplary fiber, filament, or cord used in a nonwoven may have a fiber thickness or diameter of approximately 7.2 μm (±0.5 m) with confidence limits of ±95%. Table 1, below, compares fiber diameter in m of a nonwoven in accordance with the present invention to that of a conventional ass mat.

TABLE 1
Fiber Diameter

| | Exemplary Fibrous Mat | Conventional Glass Mat |
|---|---|---|
| Mean | 7.2408 μm | 13.83 μm |
| Standard Deviation | 1.9741 μm | 1.2350 μm |
| Sample Size | 66 | 37 |

An exemplary nonwoven may have a preferred air permeability in the range of approximately 1500 1/m²·s to approximately 2500 1/m²·s.

An exemplary nonwoven may have a pore size that is preferably less than approximately 4.0 μm to 5.0 μm (as measured as an effective diameter via SEM measurements). The fibrous mat pore size is preferably smaller than the grain size of the active material used on the associated negative or positive electrode. Table 2, below, compares pore size area of an exemplary fibrous mat in accordance with the present invention to that of a conventional glass mat.

TABLE 2
Pore Area

| | Exemplary Fibrous Mat | Conventional Glass Mat |
|---|---|---|
| Mean | 1332.65 μm² | 6896.95 μm² |
| Standard Deviation | 1573.57 μm² | 6461.03 μm² |
| Sample Size | 63 | 29 |

An exemplary fibrous mat may have a preferred electrical resistance (“ER”) in the range of approximately 6 mΩ·cm² to approximately 14 mΩ·cm², and preferably less than 14 mΩ·cm², or less than 13 mΩ·cm², or less than 12 mΩ·cm², or less than 11 mΩ·cm².

An exemplary fibrous mat may have a preferred area weight or basis weight in the range of approximately 50 g/m² to about 100 g/m², in some embodiments, 60 g/m² to approximately 80 g/m².

An exemplary fibrous mat may have a preferred binder content in the range of approximately 15% to approximately 21%.

An exemplary fibrous mat may have a preferred thickness in the range of approximately 200 m to about 450 m, in certain embodiments, about 350 m to approximately 450 m.

An exemplary fibrous mat may have a preferred tensile strength in the machine direction (MD) of approximately 200 N/50 mm, and a preferred tensile strength in the cross-machine direction (CMD) of approximately 150 N/50 mm.

Furthermore, the fibers of the fibrous mat may be solid or hollow, and the cross-sectional shape of the fibers may be round, circular, oval or oblong, kidney-shaped, dog-bone shaped, race-track shaped, polygonal shaped, or any combination thereof. In addition, exemplary fibers may have multiple components in a side-by-side configuration, or a sheath and core configuration, or an islands-in-the-sea configuration. Moreover, the sheath and core configuration may take on any of the above shapes, and the core may be centered or eccentric.

The fibrous mat may be provided either in sheet form or in the form of a wrap, a pocket, a sleeve, an envelope, or in combinations thereof throughout an electrode/separator array. An exemplary fibrous mat may envelope a negative electrode (“negative enveloping mat”), such that the separator has two interior surfaces facing a negative electrode and two opposite surfaces facing adjacent positive electrodes and/or porous membrane(s). Alternatively, another exemplary fibrous mat may envelope a positive electrode (“positive enveloping separator”), such that the fibrous mat has two interior surfaces facing a positive electrode and two opposite surfaces facing adjacent positive electrodes and/or porous membrane(s). In such enveloped mats, the bottom edge may be a folded or a sealed crease edge about the bottom of the enveloped electrode. Further, the lateral edges may be open, continuously sealed seam edges, or intermittently sealed seam edges. The edges may be bonded or sealed by adhesive, heat, ultrasonic welding, and/or the like, or any combination thereof.

Certain exemplary fibrous mats of the separator assemblies may be processed to form hybrid envelopes. The hybrid envelope may be provided by forming one or more slits or openings before, during or after, forming an envelope. The length of the openings or slits may be at least 1/50, 1/25, 1/20, 1/15, 1/10, ⅛, ⅕, ¼, or ⅓ of the length of the entire edge. The length of the openings may be 1/50 to ⅓, 1/25 to ⅓, 1/20 to ⅓, 1/20 to ¼, 1/15 to ¼, 1/15 to ⅕ or 1/10 to ⅕ of the length of the entire edge. The hybrid envelope can have at least 1-5 or more openings, 1-4, 2-4, 2-3 or 2 openings, which may or may not be equally disposed along the length of the bottom edge. It is preferred that no opening is in the corner of the envelope.

Some other exemplary embodiments of separator assembly configurations may include: a negative or positive electrode envelope; a negative or positive electrode sleeve, a negative or positive electrode hybrid envelope; both electrodes may be enveloped or sleeved, and any combination thereof.

Sealing may be performed by at least one of sealing by adhesives, heat (melt) sealing, mechanical sealing, ultrasonic sealing, compression, welding, or combinations thereof. Mechanical sealing may use pressure rolls with or without gear teeth. Mechanical sealing may be done with or without the addition of heat. A skilled artisan would understand that certain methods of sealing may be more appropriate depending on the material of the fibrous mat. For example, an adhesive sealing may be more appropriate for a predominantly glass fibrous mat, while adhesive sealing or heat sealing may be more appropriate if the fibrous mat includes a polymer that melts.

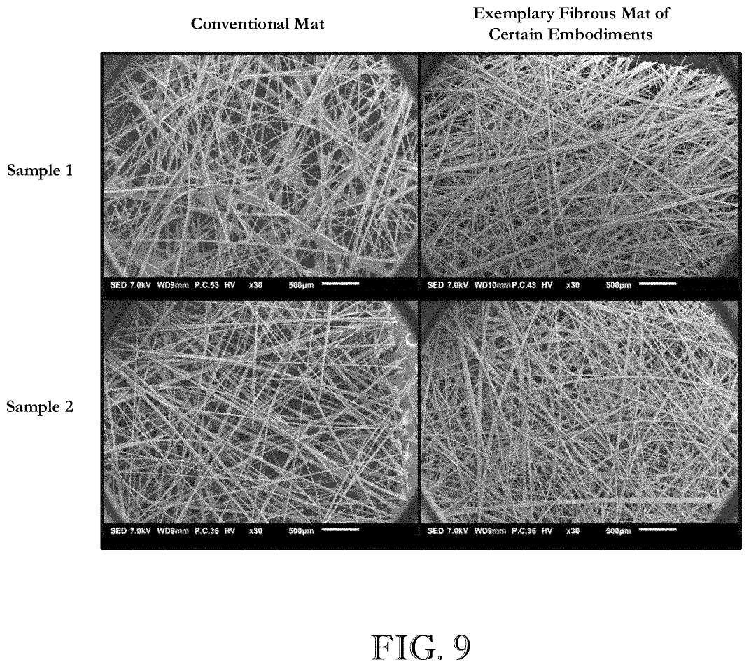

Turning now to FIG. 9 shows four SEM images at a low magnification taken from two separate locations of an exemplary fibrous mat and two separate locations of a conventional glass mat. The images show that the exemplary fibrous mat possesses a more densely packed web of fibers than the conventional glass mat. Further, the fibers and open areas of the exemplary fibrous mat are smaller than that of a conventional glass mat.

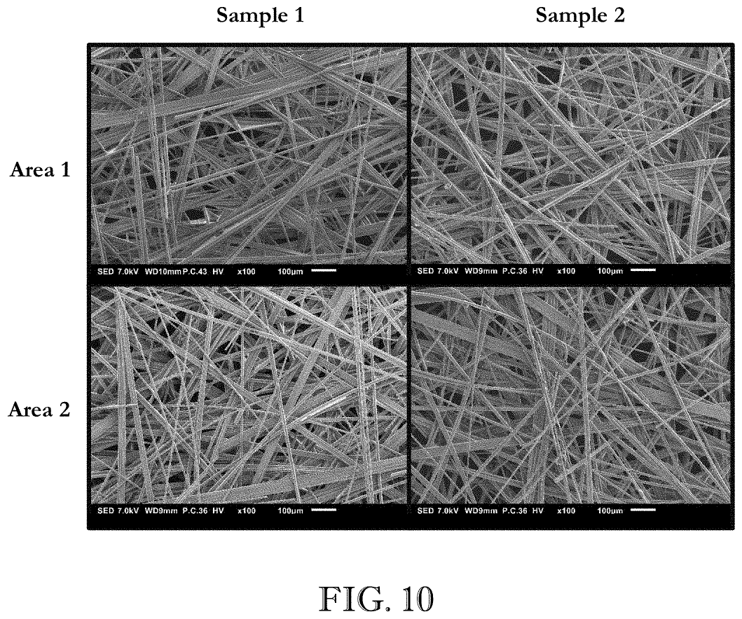

In FIG. 10, SEM images were acquired from samples taken from two separate locations and then two separate areas from each sample location. This was done to avoid any area bias. The images were taken at a higher magnification than that of FIG. 9. These images further show the packing density of the fibers and also show some bundling of the fibers, likely due to the binder used and its content. Fibrous mats useful in various embodiments described herein may include bunches or bundles of fibers, such as bunches or bundles of glass fibers and/or synthetic fibers. Such bunches or bundles, in certain embodiments, may be twisted before the fibers are bonded together. In such embodiments, the twisting may occur and binder may be applied to hold such twisting in place. In such embodiments, separators with fibrous mats having bunches or bundles of fibers may exhibit increased strength compared to separators having conventional mats. Similarly, where fibers are twisted, such separators having such fibrous mats may exhibit even more significant increases in strength compared with separators having conventional mats. When a wet-laid process is used to make such a fibrous mat according to various preferred embodiments defined herein, composite fiber bundles may be produced, where such composite fiber bundles are provided with glass fibers as well as synthetic polymer fibers, by way of example only, polyester fibers or PET fibers.

Additionally, the fibrous mat may be formed with bundled fibers either prior to forming the mat or while forming the mat. The bundles may be combed or twisted with multiple fibers having different material compositions, different cross-sectional shapes, different fiber diameters, and any combination thereof. The bundles may be laid in a patterned orientation, randomly deposited, or a combination thereof. The bundled fibers may be laid on and/or within a randomly laid nonwoven or fibrous mat layer. The resulting fibrous mat may therefore have a corrugated surface or a non-corrugated surface, or a combination thereof. FIGS. 8A and 8B are photographs of an exemplary fibrous mat having a corrugated surface. The bundles may also form during production of the mat.

The bundles may form simply by the profile of the carrier wires or surfaces used in the mat production. Further, the mat may be laid in two separate processes. For instance, the bundles may be formed with a water insoluble binder and then a second layer of nonwoven fibers may be laid down to hold the fibers together. The bundles may be deposited on either or both surfaces of the mat.

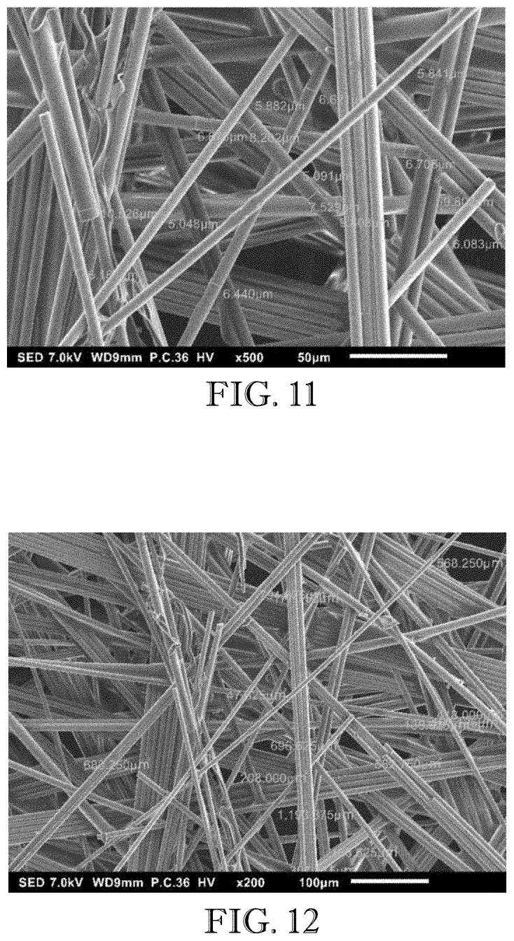

FIG. 11 shows an image used to measure fiber diameter of an exemplary fibrous mat, as taken by the linear distance across individual fibers, fibers in bundles were not measured and two diameters were taken of each measured fiber (if possible). The data from FIG. 12 is shown in Table 1, above.

FIG. 12 is an image used to measure pore size of the fibrous mat. The data from FIG. 12 is shown in Table 2, above.

The fibrous mat may additionally have a carbon component either as part of the mat or in a layer adjacent to the negative electrode. For example, the fibrous mat may have carbon fiber, conductive carbon, graphite, artificial graphite, activated carbon, carbon paper, acetylene black, carbon black, high surface area carbon black, graphene, high surface area graphene, keitjen black, carbon fibers, carbon filaments, carbon nanotubes, open-cell carbon foam, a carbon mat, carbon felt, carbon Buckminsterfullerene (Bucky Balls), an aqueous carbon suspension, flake graphite, oxidized carbon, and combinations thereof. In addition, the fibrous mat may have a nucleation additive such as carbon as described above or barium sulfate (BaSO₄).

### Porous Membrane

Physical Description The porous membrane is not so limited and may be any porous membrane; a porous membrane with any size pore (e.g., macroporous, microporous, nanoporous, etc.) and being made from any material. In some preferred embodiments, the porous membrane is a microporous membrane such as a battery separator. For example, the microporous membrane may be any polyethylene battery separator manufactured by Daramic® or any other lead acid battery separator manufacturer, now or in the future.

In preferred embodiments, the porous membrane is preferably a microporous membrane having pores less than about 1 micron, a mesoporous membrane, or a macroporous membrane having pores greater than about 1 micron) made of natural or synthetic materials, such as polyolefin, polyethylene, polypropylene, phenolic resin, PVC, rubber, synthetic wood pulp (SWP), glass fibers, cellulosic fibers, or combinations thereof. More preferably, the porous membrane is a microporous membrane made from thermoplastic polymers. The preferred microporous membranes may have pore diameters of about 0.1 μm (100 nanometers) and porosities of about 60%. The thermoplastic polymers may, in principle, include all acid-resistant thermoplastic materials suitable for use in lead acid batteries. The preferred thermoplastic polymers include polyvinyls and polyolefins. The polyvinyls include, for example, polyvinyl chloride (PVC). The polyolefins include, for example, polyethylene, such as ultrahigh molecular weight polyethylene (UHMWPE), and polypropylene. One preferred embodiment might include a mixture of filler (for example, silica) and UHMWPE.

In some embodiments, the pore size of the porous membrane is less than 5 μm, preferably less than 1 μm. Preferably more than 50% of the pores are approximately 0.5 μm or less. It may be preferred that at least 90% of the pores have a diameter of less than approximately 0.9 μm. The microporous separator preferably has an average pore size within the range of approximately 0.05 μm to approximately 0.9 μm, in some instances, approximately 0.1 μm to approximately 0.3 μm.

The pore size may be measured, in some instances, using the mercury intrusion method described in Ritter, H. L., and Drake, L. C., Ind. Eng. Chem. Anal. Ed., 17, 787 (1945). According to this method, mercury is forced into different sized pores by varying the pressure exerted on the mercury by means of a porosimeter (porosimeter model 2000, Carlo Erba). The pore distribution may be determined by evaluation of the crude data with the MILESTONE 200 software.

In certain exemplary embodiments, the porous membrane 200 is provided with a backweb 202 that may be provided with an array of one or more ribs 204, 206 extending from one or both major surfaces. As a porous membrane 200 is placed in a typical lead acid battery, the backweb 202 typically has a positive electrode facing surface 202p and a negative electrode facing surface 202n.

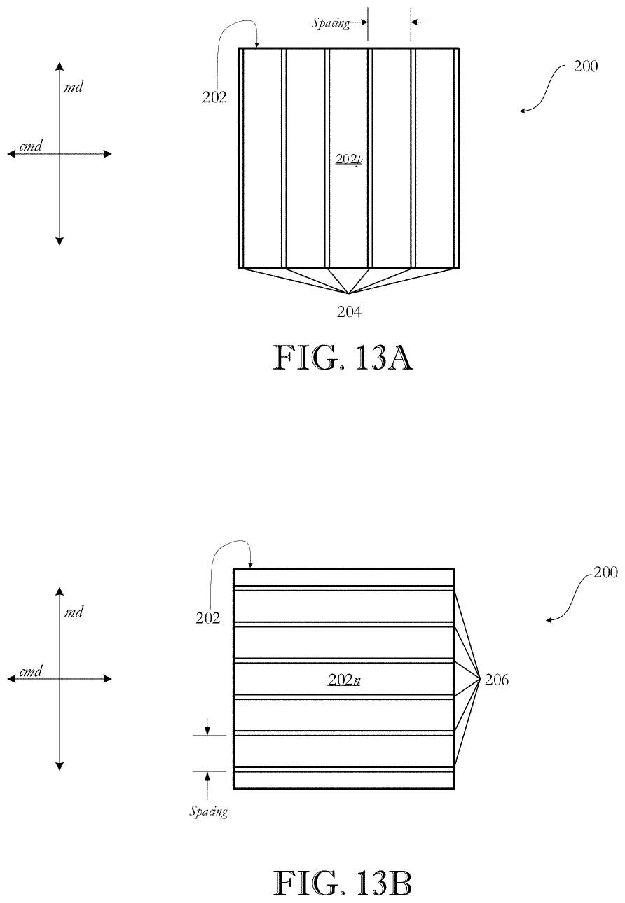

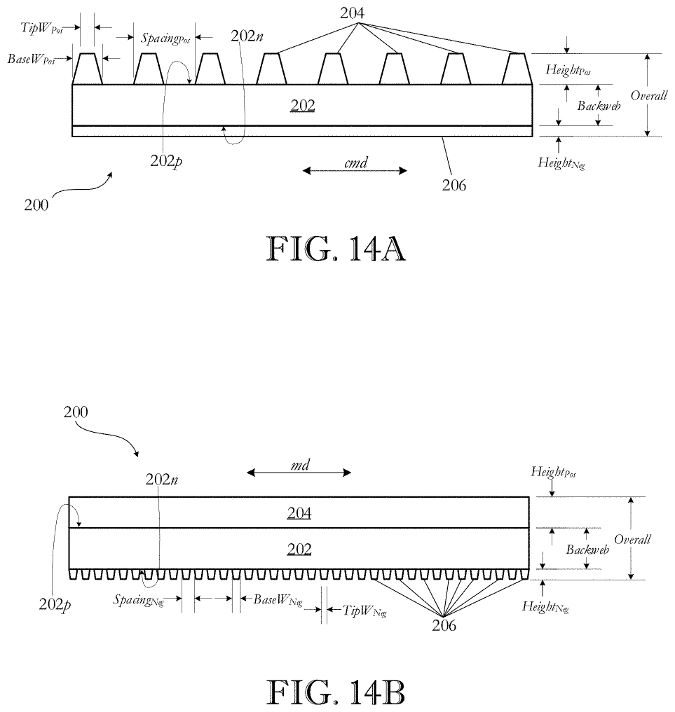

Referring to FIGS. 13A through 15B, exemplary porous membranes are described or defined according to a set of typical dimensions in relation to its backweb and ribs, though not all are necessary.

Referring to FIG. 13A, an exemplary porous membrane 200 is provided with a backweb 202 having a machine direction, which is delineated by the vertical arrowed line labeled “md,” and a cross-machine direction, which is delineated by the horizontal arrowed line labeled “cmd.” The porous membrane 200 is further provided with an array of positive ribs 204 that extend from a surface that faces a positive electrode 202p when disposed in a lead acid battery. The positive ribs 204 are substantially longitudinally aligned in the machine direction md. The array of positive ribs 204 are spaced apart with substantially equal spacing Spacing_{Pos} transversely across the cross-machine direction cmd. The ribs 204 may be positive ribs 204 Referring now to FIG. 13B, an exemplary porous membrane 200 is provided with a backweb 202 having a machine direction, which is delineated by the vertical arrowed line labeled “md,” and a cross-machine direction, which is delineated by the horizontal arrowed line labeled “cmd.” The porous membrane 200 is further provided with an array of negative ribs 206 extending from a negative electrode facing surface 202n when disposed in a lead acid battery. The negative ribs 206 are substantially transversely aligned in the cross-machine direction cmd, and may be referred to as cross-negative ribs 206. The array of negative ribs 204 are spaced apart with substantially equal spacing Spacing_{Neg} longitudinally across the machine direction md.

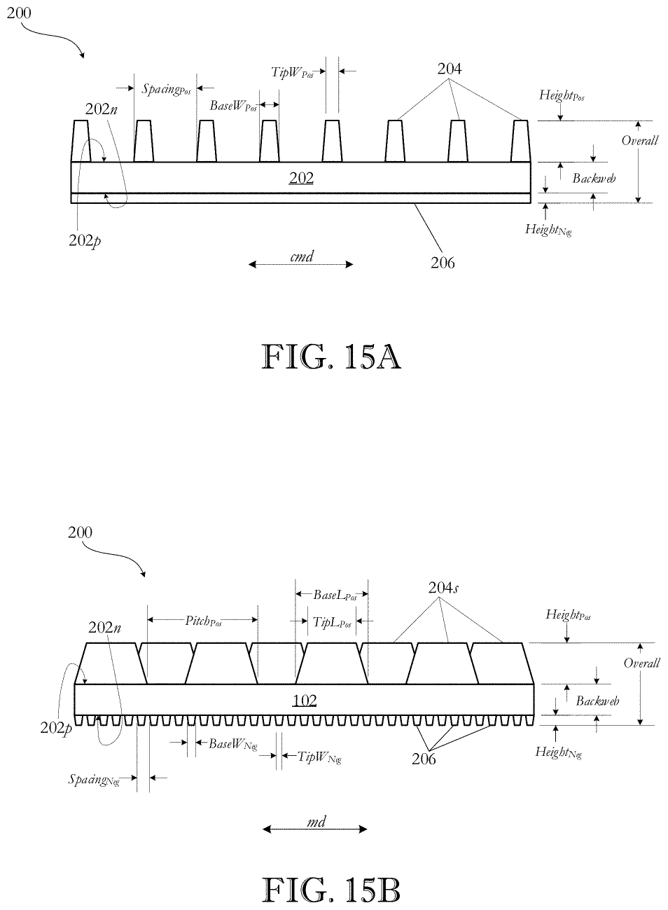

With reference to FIG. 14A, an exemplary porous membrane 200 is provided with a backweb 202 having a backweb thickness, dimensioned as Backweb. The porous membrane 200 is further provided with an array of positive ribs 204 extending from the porous membrane positive electrode facing surface 202p and substantially aligned in the machine direction md. The positive ribs 204 are provided with a rib base width, dimensioned as BaseW_{Pos}; a rib tip width, dimensioned as TipW_{Pos}; a positive rib height, dimensioned as Height_{Pos}; and a rib-to-rib spacing, dimensioned as Spacing_{Pos}. The porous membrane 200 is also provided with an array of negative ribs 206 extending from the porous membrane negative electrode facing surface 202n. The negative ribs 206 are substantially aligned in the cross-machine direction cmd with a negative rib height, dimensioned as Height_{Neg}. Finally, the porous membrane is defined by an overall thickness, dimensioned as Overall, which is equal to the sum of the backweb thickness Backweb, the positive rib height Height_{Pos}, and the negative rib height Height_{Neg}. Referring now to FIG. 14B, an exemplary porous membrane 200 as substantially identical as that shown in FIG. 14A, is further provided with a negative rib base width BaselW_{Neg}, a negative rib tip width TipW_{Neg}, and a negative rib-to-rib spacing Spacing_{Neg}. With reference to FIG. 15A, an exemplary porous membrane 200 is provided with a backweb 202 having a backweb thickness, dimensioned as Backweb. The porous membrane 200 is further provided with an array of positive ribs 204 extending from the porous membrane positive electrode facing surface 202p and substantially aligned in the machine direction md. The positive ribs 204 are provided with a rib base width, dimensioned as BaseW_{Pos}; a rib tip width, dimensioned as TipW_{Pos}; a positive rib height, dimensioned as Height_{Pos}; and a rib-to-rib spacing, dimensioned as Spacing_{Pos}. The porous membrane 200 is also provided with an array of negative ribs 206 extending from the porous membrane negative electrode facing surface 202n. The negative ribs 206 are substantially aligned in the cross-machine direction cmd with a negative rib height, dimensioned as Height_{Neg}. Finally, the porous membrane is defined by an overall thickness, dimensioned as Overall, which is equal to the sum of the backweb thickness Backweb, the positive rib height Height_{Pos}, and the negative rib height Height_{Neg}. Referring now to FIG. 15B, an exemplary porous membrane 200 as substantially identical as that shown in FIG. 15A, is further provided with a negative rib base width BaseW_{Neg}, a negative rib tip width TipW_{Neg}, and a negative rib-to-rib spacing Spacing_{Neg}. In addition, the positive ribs 204 are segmented into serrations 204s. The positive serrations 204s are provided with a base length BaseL_{Pos}, a rib tip length TipL_{Pos}, and a serration-to-serration pitch Pitch_{Pos}.

In certain select aspects of the present invention, either or both arrays of ribs are chosen from the group consisting of solid ribs, discrete broken ribs, continuous ribs, discontinuous ribs, angled ribs, linear ribs, longitudinal ribs extending substantially in a machine direction of the porous membrane, lateral ribs extending substantially in a cross-machine direction of the porous membrane, transverse ribs extending substantially in a cross-machine direction of the porous membrane, cross ribs extending substantially in a cross-machine direction of the porous membrane, negative cross ribs (NCRs), discrete teeth or toothed ribs, serrations, serrated ribs, battlements or battlemented ribs, curved or sinusoidal ribs, disposed in a solid or broken zig-zag-like fashion, grooves, channels, textured areas, embossments, dimples, porous, non-porous, mini ribs or cross-mini ribs, and combinations thereof. One possibly preferred rib or profile embodiment is positive side serrated ribs and negative side cross ribs (NCRs). Another possibly preferred rib or profile embodiment is positive side longitudinal ribs and negative side cross ribs (NCRs).

The overall thickness of the porous membrane or microporous membrane (which includes backweb thickness and rib height) is preferably greater than approximately 100 μm and less than or equal to approximately 5.0 mm. The overall thickness of the separator can be within the range approximately of 0.15 mm to approximately 2.5 mm, approximately 0.25 mm to approximately 2.25 mm, approximately 0.5 mm to approximately 2.0 mm, approximately 0.5 mm to approximately 1.5 mm, or approximately 0.75 mm to approximately 1.5 mm. In some instances, the separator overall thickness can be approximately 0.8 mm or approximately 1.1 mm thick.

Exemplary porous membranes of the separator assemblies may be provided as a flat sheet, a leaf or leaves, a wrap, a sleeve, or as an envelope or pocket separator. An exemplary envelope porous membrane may envelope a positive electrode (“positive enveloping separator”), such that the porous membrane has two interior sides facing the positive electrode and two exterior sides facing adjacent negative electrodes. Alternatively, another exemplary envelope porous membrane may envelope a negative electrode (“negative enveloping separator”), such that the porous membrane has two interior sides facing the negative electrode and two exterior sides facing adjacent positive electrodes. In such enveloped porous membranes, the bottom edge 350 may be a folded or a sealed crease edge. Further, the lateral edges 105a, 105b may be continuously or intermittently sealed seam edges. The edges may be bonded or sealed by mechanical means, adhesive, heat, ultrasonic welding, and/or the like, or any combination thereof.

Certain exemplary porous membranes may be processed to form hybrid envelopes. The hybrid envelope may be provided by forming one or more slits or openings before, during or after, forming an envelope. The length of the openings may be at least 1/50, 1/25, 1/20, 1/15, 1/10, ⅛, ⅕, ¼, or ⅓ the length of the entire edge. The length of the openings may be 1/50 to ⅓, 1/25 to ⅓, 1/20 to ⅓, 1/20 to ¼, 1/15 to ¼ 1/15 to ⅕ or 1/10 to ⅕ the length of the entire edge. The hybrid envelope can have 1-5 or more openings, 1-4, 2-4, 2-3 or 2 openings, which may or may not be equally disposed along the length of the bottom edge. It is preferred that no opening is in the corner of the envelope.

Some other exemplary embodiments of porous membrane configurations include: a negative or positive electrode envelope; a negative or positive electrode sleeve, a negative or positive electrode hybrid envelope; both electrodes may be enveloped or sleeved, and any combination thereof.

In some embodiments of the present invention, the ribs having a rib height of at least about 0.005 mm, 0.01 mm, 0.025 mm, 0.05 mm, 0.075 mm, 0.1 mm, 0.2 mm, 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, or 3.0 mm.

In some embodiments of the present invention, the protrusions are short length ribs having a rib width of at least about 0.005 mm, 0.01 mm, 0.025 mm, 0.05 mm, 0.075 mm, 0.1 mm, 0.2 mm, 0.3 mm, 0.4 mm, 0.5 mm, 0.6 mm, 0.7 mm, 0.8 mm, 0.9 mm, 1.0 mm, 1.1 mm, 1.2 mm, 1.3 mm, 1.4 mm, or 1.5 mm. The ribs can have a width between about 0.005-1.5 mm, 0.01-1.0 mm, 0.025-1.0 mm, 0.05-1.0 mm, 0.075-1.0 mm, 0.1-1.0 mm, 0.2-1.0 mm, 0.3-1.0 mm, 0.4-1.0 mm, 0.5-1.0 mm, 0.4-0.8 mm or 0.4-0.6 mm.

The separator may include negative longitudinal or cross-ribs or mini-ribs, such as negative ribs having a height of about 25 μm to about 250 μm, possibly preferably about 50 μm to about 125 μm, and more preferably about 75 μm.

In certain embodiments, the protrusions can include ribs, wherein each rib has a longitudinal axis disposed at an angle from 0° to less than 180° relative to the top edge of the separator. In some instances, all the ribs in the separator can be disposed at the same angle, whereas in other embodiments, there can be ribs disposed at different angles. For instance, in some embodiments, the separator can include rows of ribs, wherein at least some of the rows have ribs at an angle θ relative to the top edge of the separator. All the ribs in a single row can have the same approximate angle, although in other cases a single row can contain ribs at differing angles.

In certain cases, an entire face of the separator will contain ribs (e.g., continuous or discontinuous rows of ribs, ribs randomly provided, ribs provided in a pattern, or discontinuous ribs in rows that are off set from one another), while in other embodiments, certain fragments of the separator face will not include ribs. These fragments may occur along any edge of the separator, including top, bottom or sides, or may occur towards the middle of the separator, wherein the fragment is surround on one or more sides with portions having ribs.

In various possibly preferred embodiments, the porous or microporous membrane have a backweb with one or more ribs on a surface thereof such as serrated, embattlemented, angled ribs, or broken ribs, or combinations thereof. The preferred ribs may be 8 m to 1 mm tall and may be spaced 8 m to 20 mm apart, while the preferred backweb thickness of the microporous polyolefin separator layer (not including the ribs or embossments) may be about 0.05 mm to about 0.50 mm (for instance, in certain embodiments, about 0.25 mm). For example, the ribs can be about 0.05 mm, 0.1 mm, 0.2 mm, 0.3 mm, 0.4 mm, 0.5 mm, 0.6 mm, 0.7 mm, 0.8 mm, 0.9 mm, 1.0 mm, 1.2 mm, 1.4 mm, 1.6 mm, 1.8 mm, 2.0 mm, 2.25 mm, 2.5 mm, 2.75 mm, 3 mm, 4 mm, 5 mm, 6 mm, 7 mm, 8 mm, 9 mm, or about 10 mm apart. In some embodiments, the ribs may be in a pattern such as they may be on one side of the separator layer or on both sides of the polyolefin separator, from 0°-90° in relation to each other. In some embodiments, the acid mixing ribs may be front, positive or positive side ribs. Various patterns including ribs on both sides of the separator or separator layer may include positive ribs and negative longitudinal or cross-ribs on the second side or back of the separator, such as smaller, more closely spaced negative longitudinal or cross-ribs or mini-ribs. Such negative longitudinal or cross-ribs may, in some instances, be about 0.025 mm to about 0.1 mm in height, and preferably about 0.075 mm in height, but may be as large as 0.25 mm. Other patterns may include ribs on both sides of the separator layer with negative mini-ribs on the second side or back of the separator (mini-ribs that extend in the same direction, versus a cross-direction, compared with the major ribs on the other side of the separator). Such negative mini-ribs may, in some instances, be about 0.025 mm to about 0.25 mm in height, and preferably be about 0.050 mm to about 0.125 mm in height.

The ribs may be serrated in certain preferred embodiments. The serrations may have an average tip length of from about 0.05 mm to about 1 mm. For example, the average tip length can be greater than or equal to about 0.05 mm, 0.1 mm, 0.2 mm, 0.3 mm, 0.4 mm, 0.5 mm, 0.6 mm, 0.7 mm, 0.8 mm, or about 0.9 mm; and/or less than or equal to about 1.0 mm, 0.9 mm, 0.8 mm, 0.7 mm, 0.6 mm, 0.5 mm, 0.4 mm, 0.3 mm, 0.2 mm, or about 0.1 mm.

The serrations may have an average base length of from about 0.05 mm to about 1 mm. For example, the average base length can be greater than or equal to about 0.05 mm, 0.1 mm, 0.2 mm, 0.3 mm, 0.4 mm, 0.5 mm, 0.6 mm, 0.7 mm, 0.8 mm, or about 0.9 mm; and/or less than or equal to about 1.0 mm, 0.9 mm, 0.8 mm, 0.7 mm, 0.6 mm, 0.5 mm, 0.4 mm, 0.3 mm, 0.2 mm, or about 0.1 mm.

If serrations are present, they may have an average height of from about 0.05 mm to about 4 mm. For example, the average height can be greater than or equal to about 0.05 mm, 0.1 mm, 0.2 mm, 0.3 mm, 0.4 mm, 0.5 mm, 0.6 mm, 0.7 mm, 0.8 mm, or about 0.9 mm; and/or less than or equal to about 1.0 mm, 0.9 mm, 0.8 mm, 0.7 mm, 0.6 mm, 0.5 mm, 0.4 mm, 0.3 mm, 0.2 mm, or about 0.1 mm. For embodiments in which the serration height is the same as the rib height, the serrated ribs may also be referred to as protrusions. Such ranges may apply to separators for industrial traction-type start/stop batteries, where the total thickness of the separator may typically be about 1 mm to about 4 mm, as well as automotive start/stop batteries, where the total thickness of the separator may be a little less (e.g., typically about 0.3 mm to about 1 mm).

The serrations can have an average center-to-center pitch of from about 0.1 mm to about 50 mm. For example, the average center-to-center pitch can be greater than or equal to about 0.2 mm, 0.3 mm, 0.4 mm, 0.5 mm, 0.6 mm, 0.7 mm, 0.8 mm, 0.9 mm, 1.0 mm, 1.25 mm, or about 1.5 mm; and/or less than or equal to about 1.5 mm, 1.25 mm, 1.0 mm, 0.9 mm, 0.8 mm, 0.7 mm, 0.6 mm, 0.5 mm, 0.4 mm, 0.3 mm, or about 0.2 mm.

The serrations can have an average height to base width ratio of from about 0.1:1 to about 500:1. For example, the average height to base width ratio can be greater than or equal to about 0.1:1, 25:1, 50:1, 100:1, 150:1, 200:1, 250:1, 300:1, 350:1, or 450:1; and/or less than or equal to about 500:1, 450:1, 400:1, 350:1, 300:1, 250:1, 200:1, 150:1, 100:1, 50:1, or 25:1.

The serrations can have average base width to tip width ratio of from about 1000:1 to about 0.1:1. For example, the average base width to tip width ratio can be greater than or equal to about 0.1:1, 1:1, 2:1, 3:1, 4:1, 5:1, 6:1, 7:1, 8:1, 9:1, 10:1, 15:1, 20:1, 25:1, 50:1, 100:1, 150:1, 200:1, 250:1, 300:1, 350:1, 450:1, 500:1, 550:1, 600:1, 650:1, 700:1, 750:1, 800:1, 850:1, 900:1, 950:1, and/or less than or equal to about 1000:1, 950:1, 900:1, 850:1, 800:1, 750:1, 700:1, 650:1, 600:1, 550:1, 500:1, 450:1, 400:1, 350:1, 300:1, 250:1, 200:1, 150:1, 100:1, 50:1, 25:1, 20:1, 15:1, 10:1, 9:1, 8:1, 7:1, 6:1, 5:1, 4:1, 3:1, 2:1, or 1:1.

In some embodiments, the separator can be dimpled. Dimples are typically protrusion-type features or nubs on one or more surfaces of the separator. The thickness of the dimples can be from 1-99% the thickness of the separator. For example, the average thickness of the dimples can be less than about 95%, 90%, 85%, 80%, 75%, 70%, 65%, 60%, 55%, 50%, 45%, 40%, 35%, 30%, 25%, 20%, 15%, 10%, or 5% that of the separator. Dimples may be arranged in rows along the separator. The rows or lines may be spaced about 1 m to about 10 mm apart. For example, the rows can be about 0.05 mm, 0.1 mm, 0.2 mm, 0.3 mm, 0.4 mm, 0.5 mm, 0.6 mm, 0.7 mm, 0.8 mm, 0.9 mm, 1.0 mm, 1.2 mm, 1.4 mm, 1.6 mm, 1.8 mm, 2.0 mm, 2.25 mm, 2.5 mm, 2.75 mm, 3 mm, 4 mm, 5 mm, 6 mm, 7 mm, 8 mm, 9 mm, or 10 mm apart. Conversely, the dimples may be arranged in a random array or random manner.

The dimples may have an average dimple length of from about 0.05 mm to about 1 mm. For example, the average dimple length can be greater than or equal to about 0.05 mm, 0.1 mm, 0.2 mm, 0.3 mm, 0.4 mm, 0.5 mm, 0.6 mm, 0.7 mm, 0.8 mm, or 0.9 mm; and/or less than or equal to about 1.0 mm, 0.9 mm, 0.8 mm, 0.7 mm, 0.6 mm, 0.5 mm, 0.4 mm, 0.3 mm, 0.2 mm, or 0.1 mm.

The dimples may have an average dimple width of from about 0.01 mm to about 1.0 mm. For example, the average dimple width can be greater than or equal to about 0.05 mm, 0.1 mm, 0.2 mm, 0.3 mm, 0.4 mm, 0.5 mm, 0.6 mm, 0.7 mm, 0.8 mm, or 0.9 mm; and/or less than or equal to about 1.0 mm, 0.9 mm, 0.8 mm, 0.7 mm, 0.6 mm, 0.5 mm, 0.4 mm, 0.3 mm, 0.2 mm, or 0.1 mm.

The dimples can have an average center-to-center pitch of from about 0.10 mm to about 50 mm. For example, the average center-to-center pitch can be greater than or equal to about 0.2 mm, 0.3 mm, 0.4 mm, 0.5 mm, 0.6 mm, 0.7 mm, 0.8 mm, 0.9 mm, 1.0 mm, 1.25 mm, or 1.5 mm; and/or less than or equal to about 1.5 mm, 1.25 mm, 1.0 mm, 0.9 mm, 0.8 mm, 0.7 mm, 0.6 mm, 0.5 mm, 0.4 mm, 0.3 mm, or 0.2 mm.

The dimples can be quadrangular in shape, for instance, square and rectangles. The dimples can have an average dimple length to dimple width ratio of from about 0.1:1 to about 100:1. For example, the average length to base width ratio can be greater than or equal to about 0.1:1, 1:1, 2:1, 3:1, 4:1, 5:1, 6:1, 7:1, 8:1, 9:1, 10:1, 15:1, 20:1, 25:1, 50:1, 100:1, 150:1, 200:1, 250:1, 300:1, 350:1, 450:1, 500:1, 550:1, 600:1, 650:1, 700:1, 750:1, 800:1, 850:1, 900:1, 950:1, and/or less than or equal to about 1000:1, 950:1, 900:1, 850:1, 800:1, 750:1, 700:1, 650:1, 600:1, 550:1, 500:1, 450:1, 400:1, 350:1, 300:1, 250:1, 200:1, 150:1, 100:1, 50:1, 25:1, 20:1, 15:1, 10:1, 9:1, 8:1, 7:1, 6:1, 5:1, 4:1, 3:1, 2:1, or 1:1.

In some embodiments, the dimples can be substantially circular. Circular dimples can have a diameter from about 0.05 to about 1.0 mm. For example, the average dimple diameter can be greater than or equal to about 0.05 mm, 0.1 mm, 0.2 mm, 0.3 mm, 0.4 mm, 0.5 mm, 0.6 mm, 0.7 mm, 0.8 mm, or 0.9 mm; and/or less than or equal to about 1.0 mm, 0.9 mm, 0.8 mm, 0.7 mm, 0.6 mm, 0.5 mm, 0.4 mm, 0.3 mm, 0.2 mm, or 0.1 mm.

Various other shapes for the dimples may be included as well. By way of example only, such dimples might be triangular, pentagonal, hexagonal, heptagonal, octagonal, oval, elliptical, and combinations thereof.

In some embodiments, the separator can feature a combination of ribs, serrations, dimples, or combinations thereof. For instance, a separator can have a series of serrated ribs running top to bottom along the separator, and a second series of serrated ribs running horizontally along the separator. In other embodiments, the separator can have an alternating sequence of serrated ribs, dimples, continuous, interrupted, or broken solid ribs, or combinations thereof.

### Membrane Composition

In certain embodiments, the improved separator may include a porous membrane that may be used as a separator alone or in conjunction with a fibrous mat, particularly a lead acid battery separator, and the separator may be made of: a natural or synthetic base material; a processing plasticizer; a filler; one or more natural or synthetic rubber(s) and/or or latex, the rubber(s) and/or latex may be cured or cross-linked, or uncured or uncross-linked; one or more other additives and/or coatings, such as surfactants, antioxidants and/or the like; and any combination thereof.

### Base Materials

In certain embodiments, exemplary natural or synthetic base materials may include: polymers; thermoplastic polymers; phenolic resins; natural or synthetic rubbers; synthetic wood pulp; lignins; glass fibers; synthetic fibers; cellulosic fibers; and any combination thereof. In certain preferable embodiments, an exemplary separator may be a porous membrane made from thermoplastic polymers. Exemplary thermoplastic polymers may, in principle, include all acid-resistant thermoplastic materials suitable for use in lead acid batteries. In certain preferred embodiments, exemplary thermoplastic polymers may include polyvinyls and polyolefins. In certain embodiments, the polyvinyls may include, for example, polyvinyl chloride (“PVC”). In certain preferred embodiments, the polyolefins may include, for example, polyethylene, polypropylene, ethylene-butene copolymer, and any combination thereof, but preferably polyethylene. In certain embodiments, exemplary natural or synthetic rubbers may include, for example, latex, uncured or uncross-linked rubbers, cross-linked or cured rubbers, crumb or ground rubber, and combination thereof.

### Polyolefins

In certain embodiments, the porous membrane layer preferably includes a polyolefin, specifically polyethylene. Preferably, the polyethylene is high molecular weight polyethylene (“HMWPE”), (e.g., polyethylene having a molecular weight of at least about 600,000). Even more preferably, the polyethylene is ultra-high molecular weight polyethylene (“UHMWPE”). Exemplary UHMWPE may have a molecular weight of at least about 1,000,000, in particular more than about 4,000,000, and most preferably approximately 5,000,000 to approximately 8,000,000 as measured by viscosimetry and calculated by Margolie's equation. Furthermore, exemplary UHMWPE may possess a standard load melt index of substantially zero (0) as measured as specified in ASTM D 1238 (Condition E) using a standard load of 2,160 g. Moreover, exemplary UHMWPE may have a viscosity number of not less than about 600 ml/g, preferably not less than about 1,000 ml/g, more preferably not less than approximately 2,000 ml/g, and most preferably not less than approximately 3,000 ml/g, as determined in a solution of 0.02 g of polyolefin in 100 g of decalin at 130° C.

### Rubber

The novel porous membrane and/or fibrous mat disclosed herein may contain latex and/or rubber. As used herein, rubber shall describe rubber, latex, natural rubber, synthetic rubber, uncured or uncross-linked rubbers, cross-linked or cured rubbers, crumb or ground rubber, and/or the like, or mixtures or combinations thereof. Exemplary natural rubbers may include one or more blends of polyisoprenes, which are commercially available from a variety of suppliers. Exemplary synthetic rubbers include methyl rubber, polybutadiene, chloropene rubbers, butyl rubber, bromobutyl rubber, polyurethane rubber, epichlorhydrin rubber, polysulphide rubber, chlorosulphonyl polyethylene, polynorbornene rubber, acrylate rubber, fluorine rubber and silicone rubber and copolymer rubbers, such as styrene/butadiene rubbers, acrylonitrile/butadiene rubbers, ethylene/propylene rubbers (“EPM” and “EPDM”) and ethylene/vinyl acetate rubbers. The rubber may be a cross-linked rubber or an uncross-linked rubber; in certain preferred embodiments, the rubber is uncross-linked rubber. In certain embodiments, the rubber may be a blend of cross-linked and uncross-linked rubber.

### Plasticizer

In certain embodiments of the porous membrane, exemplary processing plasticizers may include processing oil, petroleum oil, paraffin-based mineral oil, mineral oil, and any combination thereof. Typically, exemplary embodiments utilize a plasticizer while extruding the base materials to form a membrane, sheet, or web. After formation of the porous membrane, the plasticizer is extracted leaving a small amount of residual plasticizer, such as residual oil.

### Fillers

The separator can contain a filler having a high structural morphology. Exemplary fillers can include: silica, dry finely divided silica; precipitated silica; amorphous silica; highly friable silica; alumina; talc; fish meal; fish bone meal; carbon; carbon black; and the like, and combinations thereof. In certain preferred embodiments, the filler is one or more silicas. High structural morphology refers to increased surface area. The filler can have a high surface area, for instance, greater than about 100 m²/g, 110 m²/g, 120 m²/g, 130 m²/g, 140 m²/g, 150 m²/g, 160 m²/g, 170 m²/g, 180 m²/g, 190 m²/g, 200 m²/g, 210 m²/g, 220 m²/g, 230 m²/g, 240 m²/g, or 250 m²/g. In some embodiments, the filler (e.g., silica) can have a surface area from about 100 m²/g to about 300 m²/g, about 125 m²/g to about 275 m²/g, about 150 m²/g to about 250 m²/g, or preferably from about 170 m²/g to about 220 m²/g. Surface area can be assessed using TriStar 3000™ for multipoint BET nitrogen surface area. High structural morphology permits the filler to hold more oil during the manufacturing process. For instance, a filler with high structural morphology has a high level of oil absorption, for instance, greater than about 150 ml/100 g, 175 ml/100 g, 200 ml/100 g, 225 ml/100 g, 250 ml/100 g, 275 ml/100 g, 300 ml/100 g, 325 ml/100 g, or 350 ml/100 g. In some embodiments the filler (e.g., silica) can have an oil absorption from about 200 ml/100 g to about 500 ml/100 g, about 200 ml/100 g to about −400 ml/100 g, about 225 ml/100 g to about 375 ml/100 g, about 225 ml/100 g to about 350 ml/100 g, about 225 ml/100 g to about 325 ml/100 g, and preferably about 250 ml/100 g to about 300 ml/100 g. In some instances, a silica filler is used having an oil absorption of approximately 266 ml/100 g. Such a silica filler has a moisture content of approximately 5.1%, a BET surface area of approximately 178 m²/g, an average particle size of about 23 μm, a sieve residue 230 mesh value of approximately 0.1%, and a bulk density of about 135 g/L.

Silica with relatively high levels of oil absorption and relatively high levels of affinity for the plasticizer (e.g., mineral oil) becomes desirably dispersible in the mixture of polyolefin (e.g., polyethylene) and the plasticizer when forming an exemplary lead acid battery separator of the type shown herein. In the past, some separators have experienced the detriment of poor dispersibility caused by silica aggregation when large amounts of silica are used to make such separators or membranes. In at least certain of the inventive separators shown and described herein, the polyolefin, such as polyethylene, forms a shish-kebab structure, since there are few silica aggregations or agglomerates that inhibit the molecular motion of the polyolefin at the time of cooling the molten polyolefin. All of this contributes to improved ion permeability through the resulting separator membrane, and the formation of the shish-kebab structure or morphology means that mechanical strength is maintained or even improved while a lower overall ER separator is produced.

In some select embodiments, the filler (e.g., silica) has an average particle size no greater than about 25 μm, in some instances, no greater than about 22 μm, 20 μm, 18 μm, 15 μm, or 10 μm. In some instances, the average particle size of the filler particles is about 15 μm to about 25 μm. The particle size of the silica filler and/or the surface area of the silica filler contributes to the oil absorption of the silica filler. Silica particles in the final product or separator may fall within the sizes described above. However, the initial silica used as raw material may come as one or more agglomerates and/or aggregates and may have sizes around 200 μm or more.

In some preferred embodiments, the silica used to make the inventive separators has an increased amount of or number of surface silanol groups (surface hydroxyl groups) compared with silica fillers used previously to make lead acid battery separators. For example, the silica fillers that may be used with certain preferred embodiments herein may be those silica fillers having at least about 10%, at least about 15%, at least about 20%, at least about 25%, at least about 30%, or at least about 35% more silanol and/or hydroxyl surface groups compared with known silica fillers used to make known polyolefin lead acid battery separators.

The ratio of silanol groups (Si—OH) to elemental silicon (Si) (i.e., (Si—OH)/Si) can be measured, for example, as follows.

1. Freeze-crush a polyolefin porous membrane (where certain inventive membranes contain a certain variety of oil-absorbing silica according to the present invention), and prepare the powder-like sample for the solid-state nuclear magnetic resonance spectroscopy (²⁹Si-NMR).
2. Perform the ²⁹Si-NMR to the powder-like sample, and observe the spectrums including the Si spectrum strength which is directly bonding to a hydroxyl group (Spectrum: Q₂ and Q₃) and the Si spectrum strength which is only directly bonding to an oxygen atom (Spectrum: Q₄), wherein the molecular structure of each NMR peak spectrum can be delineated as follows:
Q₂: (SiO)₂—Si′—(OH)₂: having two hydroxyl groups
Q₃: (SiO)₃—Si′—(OH): having one hydroxyl group
Q₄: (SiO)₄—Si′: All Si bondings are SiO
   Where Si′ is proved element by NMR observation.
   3. The conditions for ²⁹Si-NMR used for observation are as follows:
Instrument: Bruker BioSpin Avance 500
Resonance Frequency: 99.36 MHz
Sample amount: 250 mg
NMR Tube: 7 mφ
Observing Method: DD/MAS
Pulse Width: 450
Repetition time: 100 sec
Scans: 800
Magic Angle Spinning: 5,000 Hz
Chemical Shift Reference: Silicone Rubber as −22.43 ppm
   4. Numerically, separate peaks of the spectrum, and calculate the area ratio of each peak belonging to Q₂, Q₃, and Q₄. After that, based on the ratios, calculate the molar ratio of hydroxyl groups (—OH) bonding directly to Si. The conditions for the numerical peak separation is conducted in the following manner:
Fitting region: −80 to −130 ppm
Initial peak top: −93 ppm for Q₂, −101 ppm for Q₃, −111 ppm for Q₄, respectively.
Initial full width half maximum: 400 Hz for Q₂, 350 Hz for Q₃, 450 Hz for Q₄, respectively.
Gaussian function ratio: 80% at initial and 70 to 100% while fitting.
   5. The peak area ratios (Total is 100) of Q₂, Q₃, and Q₄ are calculated based on the each peak obtained by fitting. The NMR peak area corresponded to the molecular number of each silicate bonding structure (thus, for the Q₄ NMR peak, four Si—O—Si bonds are present within that silicate structure; for the Q₃ NMR peak, three Si—O—Si bonds are present within that silicate structure while one Si—OH bond is present; and for the Q₂ NMR peak, two Si—O—Si bonds are present within that silicate structure while two Si—OH bonds are present). Therefore each number of the hydroxyl group (—OH) of Q₂, Q₃, and Q₄ is multiplied by two (2) one (1), and zero (0), respectively. These three results are summed. The summed value displays the mole ratio of hydroxyl groups (—OH) directly bonding to Si.

In certain embodiments, the silica may have a molecular ratio of OH to Si groups (i.e., OH/Si), measured by ²⁹Si-NMR, that may be within a range of approximately 21:100 to 35:100, in some preferred embodiments approximately 23:100 to approximately 31:100, in certain preferred embodiments, approximately 25:100 to approximately 29:100, and in other preferred embodiments at least approximately 27:100 or greater.

In some select embodiments, use of the fillers described above permits the use of a greater proportion of processing oil during the extrusion step. As the porous structure in the separator is formed, in part, by removal of the oil after the extrusion, higher initial absorbed amounts of oil results in higher porosity or higher void volume. While processing oil is an integral component of the extrusion step, oil is a non-conducting component of the separator. Residual oil in the separator protects the separator from oxidation when in contact with the positive electrode. The precise amount of oil in the processing step may be controlled in the manufacture of conventional separators. Generally speaking, conventional separators are manufactured using about 50% to about 70% processing oil, in some embodiments, about 55% to about 65%, in some embodiments, about 60% to about 65%, and in some embodiments, about 62% processing oil. The percentages are by weight relative to the weight of the other base materials (e.g., polymer, filler, etc.). Reducing oil below about 59% is known to cause burning due to increased friction against the extruder components. However, increasing oil much above the prescribed amount may cause shrinking during the drying stage, leading to dimensional instability. Although previous attempts to increase oil content resulted in pore shrinkage or condensation during the oil removal, separators prepared as disclosed herein exhibit minimal, if any, shrinkage and condensation during oil removal. Thus, porosity can be increased without compromising pore size and dimensional stability, thereby decreasing electrical resistance.

In certain select embodiments, the use of the filler described above allows for a reduced final oil concentration in the finished separator. Since oil is a non-conductor, reducing oil content can increase the ionic conductivity of the separator and assist in lowering the electrical resistance (“ER”) of the separator. As such, separators having reduced final or residual oil contents can have increased efficiency. In certain select embodiments, membranes are provided having a final or residual processing oil content (by weight) less than about 20%, for example, between about 14% to about 20%, and in some particular embodiments, less than approximately 19%, 18%, 17%, 16%, 15%, 14%, 13%, 12%, 11%, 10%, 9%, 8%, 7%, 6%, or 5%.

The fillers may further reduce what is called the hydration sphere of the electrolyte ions, enhancing their transport across the membrane, thereby once again lowering the overall ER of the battery, such as an enhanced flooded battery or system.

The filler or fillers may contain various species (e.g., polar species, such as metals) that facilitate the flow of electrolyte and ions across the separator. Such also leads to decreased overall electrical resistance as such a separator is used in a flooded battery, such as an enhanced flooded battery.

### Friability

In certain select embodiments, the filler can be an alumina, talc, silica, or a combination thereof. In some embodiments, the filler can be a precipitated silica, and in some embodiments, the precipitated silica is amorphous silica. In some embodiments, it is preferred to use aggregates and/or agglomerates of silica which allow for a fine dispersion of filler throughout the separator, thereby decreasing tortuosity and electrical resistance. In certain preferred embodiments, the filler (e.g., silica) is characterized by a high level of friability. Good friability enhances the dispersion of the filler throughout the polymer during extrusion of the porous membrane, enhancing porosity and thus overall ionic conductivity through the separator.

Friability may be measured as the ability, tendency or propensity of the silica particles or material (aggregates or agglomerates) to be broken down into smaller sized and more dispersible particles, pieces or components. As shown on the left side of FIG. 30, the NEW silica is more friable (is broken down into smaller pieces after 30 seconds and after 60 seconds of sonication) than the STANDARD silica. For example, the NEW silica had a 50% volume particle diameter of 24.90 m at 0 seconds sonication, 5.17 μm at 30 seconds and 0.49 μm at 60 seconds. Hence, at 30 seconds sonication there was over a 50% reduction in size (diameter) and at 60 seconds there was over a 75% reduction in size (diameter) of the 50% volume silica particles. Hence, one possibly preferred definition of “high friability” may be at least a 50% reduction in average size (diameter) at 30 seconds of sonication and at least a 75% reduction in average size (diameter) at 60 seconds of sonication of the silica particles (or in processing of the resin silica mix to form the membrane). In at least certain embodiments, it may be preferred to use a more friable silica, and may be even more preferred to use a silica that is friable and multi-modal, such as bi-modal or tri-modal, in its friability. With reference to FIG. 30, the STANDARD silica appears single modal in it friability or particle size distribution, while the NEW silica appears more friable, and bi-modal (two peaks) at 30 seconds sonication and tri-modal (three peaks) at 60 seconds sonication. Such friable and multi-modal particle size silica or silicas may provide enhanced membrane and separator properties.

The use of a filler having one or more of the above characteristics enables the production of a separator having a higher final porosity. The separators disclosed herein can have a final porosity greater than about 60%, 61%, 62%, 63%, 64%, 65%, 66%, 67%, 68%, 69%, or 70%. Porosity may be measured using gas adsorption methods. Porosity can be measured by BS-TE-2060.

In some select embodiments, the porous separator can have a greater proportion of larger pores while maintaining the average pore size no greater than about 1 μm, 0.9 μm, 0.8 μm, 0.7 μm, 0.6 μm, 0.5 μm, or 0.1 μm.

In accordance with at least one embodiment, the separator is made up of polyethylene, such as an ultrahigh molecular weight polyethylene (“UHMWPE”), mixed with a processing oil and filler as well as any desired additive. In accordance with at least one other embodiment, the separator is made up of an ultrahigh molecular weight polyethylene (UHMWPE) mixed with a processing oil and talc. In accordance with at least one other embodiment, the separator is made up of UHMWPE mixed with a processing oil and silica, for instance, precipitated silica, for instance, amorphous precipitated silica. The additive can then be applied to the separator via one or more of the techniques described above.

Besides reducing electrical resistance and increasing cold cranking amps, preferred separators are also designed to bring other benefits. With regard to assembly, the separators are more easily passed through processing equipment, and therefore more efficiently manufactured. To prevent shorts during high speed assembly and later in life, the separators have superior puncture strength and oxidation resistance when compared to standard PE separators. Combined with reduced electrical resistance and increased cold cranking amps, battery manufacturers are likely to find improved and sustained electrical performance in their batteries with these new separators.

### Additives/Surfactants

In certain embodiments, exemplary separators may contain one or more performance enhancing additives added to the separator or porous membrane. The performance enhancing additive may be surfactants, wetting agents, colorants, antistatic additives, an antimony suppressing additive, UV-protection additives, antioxidants, and/or the like, and any combination thereof. In certain embodiments, the additive surfactants may be ionic, cationic, anionic, or non-ionic surfactants.

In certain embodiments described herein, a reduced amount of anionic or non-ionic surfactant is added to the inventive porous membrane or separator. Because of the lower amount of surfactant, a desirable feature may include lowered total organic carbons (“TOCs”) and/or lowered volatile organic compounds (“VOCs”).

Certain suitable surfactants are non-ionic while other suitable surfactants are anionic. The additive may be a single surfactant or a mixture of two or more surfactants, for instance two or more anionic surfactants, two or more non-ionic surfactants, or at least one ionic surfactant and at least one non-ionic surfactant. Certain suitable surfactants may have HLB values less than 6, preferably less than 3. The use of these certain suitable surfactants in conjunction with the inventive separators described herein can lead to even further improved separators that, when used in a lead acid battery, lead to reduced water loss, reduced antimony poisoning, improved cycling, reduced float current, reduced float potential, and/or the like, or any combination thereof for that lead acid batteries. Suitable surfactants include surfactants such as salts of alkyl sulfates; alkylarylsulfonate salts; alkylphenol-alkylene oxide addition products; soaps; alkyl-naphthalene-sulfonate salts; one or more sulfo-succinates, such as an anionic sulfo-succinate; dialkyl esters of sulfo-succinate salts; amino compounds (primary, secondary, tertiary amines, or quaternary amines); block copolymers of ethylene oxide and propylene oxide; various polyethylene oxides; and salts of mono and dialkyl phosphate esters. The additive can include a non-ionic surfactant such as polyol fatty acid esters, polyethoxylated esters, polyethoxylated alcohols, alkyl polysaccharides such as alkyl polyglycosides and blends thereof, amine ethoxylates, sorbitan fatty acid ester ethoxylates, organosilicone based surfactants, ethylene vinyl acetate terpolymers, ethoxylated alkyl aryl phosphate esters and sucrose esters of fatty acids.

In certain embodiments, the additive may be represented by a compound of Formula (I)

R(OR¹)ₙ(COOM_{1/x}^{x+})ₘ (1)

in which:
R is a linear or non-aromatic hydrocarbon radical with 10 to 4200 carbon atoms, preferably 13 to 4200, which may be interrupted by oxygen atoms;
R¹=H, —(CH₂)ₖCOOM_{1/x}^{x+}+, or —(CH₂)ₖ—SO₃M_{1/x}^{x+}, preferably H, where k=1 or 2;
M is an alkali metal or alkaline-earth metal ion, H⁺ or NH₄⁺, where not all the variables M simultaneously have the meaning H⁺;
n=0 or 1;
m=0 or an integer from 10 to 200; and
x=1 or 2.

The ratio of oxygen atoms to carbon atoms in the compound according to Formula (I) being in the range from 1:1.5 to 1:30 and m and n not being able to simultaneously be 0. However, preferably only one of the variables n and m is different from 0.

By non-aromatic hydrocarbon radicals is meant radicals which contain no aromatic groups or which themselves represent one. The hydrocarbon radicals may be interrupted by oxygen atoms (i.e., contain one or more ether groups).

R is preferably a straight-chain or branched aliphatic hydrocarbon radical which may be interrupted by oxygen atoms. Saturated, uncross-linked hydrocarbon radicals are quite particularly preferred. However, as noted above, R may, in certain embodiments, be aromatic ring-containing.

Through the use of the compounds of Formula (I) for the production of battery separators, they may be effectively protected against oxidative destruction.

Battery separators are preferred which contain a compound according to Formula (1) in which:
R is a hydrocarbon radical with 10 to 180, preferably 12 to 75 and quite particularly preferably 14 to 40 carbon atoms, which may be interrupted by 1 to 60, preferably 1 to 20 and quite particularly preferably 1 to 8 oxygen atoms, particularly preferably a hydrocarbon radical of formula R²—[(OC₂H₄)ₚ(OC₃H₆)_{q}]—, in which:
   R² is an alkyl radical with 10 to 30 carbon atoms, preferably 12 to 25, particularly preferably 14 to 20 carbon atoms, wherein R² can be linear or non-linear such as containing an aromatic ring;
   P is an integer from 0 to 30, preferably 0 to 10, particularly preferably 0 to 4; and
   q is an integer from 0 to 30, preferably 0 to 10, particularly preferably 0 to 4;
   compounds being particularly preferred in which the sum of p and q is 0 to 10, in particular 0 to 4;
n=1; and
m=0.

Formula R²—[(OC₂H₄)ₚ(OC₃H₆)_{q}]— is to be understood as also including those compounds in which the sequence of the groups in square brackets differs from that shown. For example according to the invention compounds are suitable in which the radical in brackets is formed by alternating (OC₂H₄) and (OC₃HL) groups.

Additives in which R² is a straight-chain or branched alkyl radical with 10 to 20, preferably 14 to 18 carbon atoms have proved to be particularly advantageous. OC₂H₄ preferably stands for OCH₂CH₂, OC₃H₆ for OCH(CH₃)₂ and/or OCH₂CH₂CH₃.

As preferred additives there may be mentioned in particular alcohols (p=q=0; m=0) primary alcohols being particularly preferred, fatty alcohol ethoxylates (p=1 to 4, q=0), fatty alcohol propoxylates (p=0; q=1 to 4) and fatty alcohol alkoxylates (p=1 to 2; q=1 to 4) ethoxylates of primary alcohols being preferred. The fatty alcohol alkoxylates are for example accessible through reaction of the corresponding alcohols with ethylene oxide or propylene oxide.

Additives of the type m=0 which are not, or only difficulty, soluble in water and sulphuric acid have proved to be particularly advantageous.

Also preferred are additives which contain a compound according to Formula (I), in which:
R is an alkane radical with 20 to 4200, preferably 50 to 750 and quite particularly preferably 80 to 225 carbon atoms;
M is an alkali metal or alkaline-earth metal ion, H⁺ or NH₄, in particular an alkali metal ion such as Li⁺, Na⁺ and K⁺ or H⁺, where not all the variables M simultaneously have the meaning H⁺;
n=0;
m is an integer from 10 to 200; and
x=1 or 2.

Manufacture of Porous Membrane In some embodiments, an exemplary porous membrane may be made by mixing the constituent parts in an extruder. For example, about 5% to about 15% by weight polymer (e.g., polyethylene, UHMWPE, etc.), about 10% to about 75% by weight filler (e.g., silica), about 10% to about 85% processing oil, and optionally about 1% to about 50% by weight rubber and/or latex, and may be mixed in an extruder. The exemplary porous membrane may be made by passing the constituent parts through a heated extruder, passing the extrudate generated by the extruder through a die and into a nip formed by two heated presses or calendar stack or rolls to form a continuous web. A substantial amount of the processing oil from the web may be extracted by use of a solvent. The web may then be dried and slit into lanes of predetermined width, and then wound onto rolls. Additionally, the presses or calendar rolls may be engraved with various groove patterns (or embossing rolls may have raised elements) to impart ribs, grooves, textured areas, embossments, and/or the like as substantially described herein. The amounts of the rubber, filler, oil, and polymer are all balanced for runnability and desirable separator properties, such as electrical resistance, basis weight, puncture resistance, bending stiffness, oxidation resistance, porosity, physical strength, tortuosity, and the like.

In addition to being added to the constituent parts of the extruder, certain embodiments combine the rubber to the porous membrane after extrusion. For example, the rubber may be coated onto one or both sides, preferably on the side facing the negative electrode, with a liquid slurry composed of the rubber and/or latex, optionally, silica, and water, and then dried such that a film of this material is formed upon the surface of an exemplary porous membrane. For better wettability of this layer, wetting agents may be added to the slurry for use in lead acid batteries. In certain embodiments, the slurry can also contain one or more performance enhancing additives as described herein. After drying, a porous layer and/or film forms on the surface of the separator, which adheres very well to the porous membrane and increases electrical resistance only insignificantly, if at all. After the rubber is added, it may be further compressed using either a machine press or calendar stack or roll. Other possible methods to apply the rubber and/or latex are to apply a rubber and/or latex slurry by dip coat, roller coat, spray coat, or curtain coat one or more surfaces of the separator, or any combination thereof. These processes may occur before or after the processing oil has been extracted, or before or after it is slit into lanes.

A further embodiment of the present invention involves depositing rubber onto the membrane by impregnation and drying.

Manufacture with Performance Enhancing Additives

In certain embodiments, performance enhancing additives or agents, such as surfactants, wetting agents, colorants, antistatic additives, antioxidants, and/or the like, and any combination thereof, may also be mixed together with the other constituent parts within the extruder. A porous membrane according to the present disclosure may then be extruded into the shape of a sheet or web, and finished in substantially the same way as described above.

In certain embodiments, and in addition or alternative to adding into the extruder, the additive or additives may, for example, be applied to the separator porous membrane when it is finished (e.g., after extracting a bulk of the processing oil, and before or after the introduction of the rubber).

According to certain preferred embodiments, the additive or a solution (e.g., an aqueous solution) of the additive is applied to one or more surfaces of the separator. This variant is suitable in particular for the application of non-thermostable additives and additives which are soluble in the solvent used for the extraction of processing oil. Particularly suitable as solvents for the additives according to the invention are low-molecular-weight alcohols, such as methanol and ethanol, as well as mixtures of these alcohols with water. The application can take place on the side facing the negative electrode, the side facing the positive electrode, or on both sides of the separator. The application may also take place during the extraction of the pore forming agent (e.g., the processing oil) while in a solvent bath. In certain select embodiments, some portion of a performance enhancing additive, such as a surfactant coating or a performance enhancing additive added to the extruder before the separator is made (or both) may combine with the antimony in the battery system and may inactivate it and/or form a compound with it and/or cause it to drop down into the mud rest of the battery and/or prevent it from depositing onto the negative electrode. The surfactant or additive may also be added to the electrolyte, the glass mat, the battery case, pasting paper, pasting mat, and/or the like, or combinations thereof.

In certain exemplary embodiments, the additive (e.g., an ionic surfactant, a cationic surfactant, a non-ionic surfactant, an anionic surfactant, or combinations thereof) may be present at a surface area density (i.e., grams per separator surface area) or add-on level of at least about 0.5 g/m², 1.0 g/m², 1.5 g/m², 2.0 g/m², 2.5 g/m², 3.0 g/m², 3.5 g/m², 4.0 g/m², 4.5 g/m², 5.0 g/m², 5.5 g/m², 6.0 g/m², 6.5 g/m², 7.0 g/m², 7.5 g/m², 8.0 g/m², 8.5 g/m², 9.0 g/m², 9.5 g/m² or 10.0 g/m² or even up to about 25.0 g/m². The additive may be present on the separator at a surface area density or add-on level between about 0.5 g/m² to about 15 g/m², about 0.5 g/m² to about 10 g/m², about 1.0 g/m² to about 10.0 g/m², 1.5 g/m² to about 10.0 g/m², 2.0 g/m² to about 10.0 g/m², about 2.5 g/m² to about 10.0 g/m², about 3.0 g/m² to about 10.0 g/m², about 3.5 g/m² to about 10.0 g/m², about 4.0 g/m² to about 10.0 g/m², about 4.5 g/m² to about 10.0 g/m², about 5.0 g/m² to about 10.0 g/m², about 5.5 g/m² to about 10.0 g/m², about 6.0 g/m² to about 10.0 g/m², about 6.5 g/m² to about 10.0 g/m², about 7.0 g/m² to about 10.0 g/m², about 7.5 g/m² to about 10.0 g/m², about 4.5 g/m² to about 7.5 g/m², about 5.0 g/m² to about 10.5 g/m², about 5.0 g/m² to about 11.0 g/m², about 5.0 g/m² to about 12.0 g/m², about 5.0 g/m² to about 15.0 g/m², about 5.0 g/m² to about 16.0 g/m², about 5.0 g/m² to about 17.0 g/m², about 5.0 g/m² to about 18.0 g/m², about 5.0 g/m² to about 19.0 g/m², about 5.0 g/m² to about 20.0 g/m², about 5.0 g/m² to about 21.0 g/m², about 5.0 g/m² to about 22.0 g/m², 5.0 g/m² to about 23.0 g/m², about 5.0 g/m² to about 24.0 g/m², or 5.0 g/m² to about 25.0 g/m².

The application may also take place by dipping the battery separator in the additive or a solution of the additive (solvent bath addition) and removing the solvent if necessary (e.g., by drying). In this way the application of the additive may be combined, for example, with the extraction often applied during membrane production. Other preferred methods are to spray the surface with additive, dip coat, roller coat, or curtain coat the one or more additives on the surface of separator.

In certain embodiments described herein, a reduced amount of ionic, cationic, anionic, or non-ionic surfactant is added to the inventive separator. In such instances, a desirable feature may include lowered total organic carbons and/or lowered volatile organic compounds (because of the lower amount of surfactant) may produce a desirable inventive separator according to such embodiment.

Applications Exemplary separators as described herein may be used in a variety of exemplary batteries. Such batteries may be any lead acid battery, such as a flooded lead acid battery, enhanced flooded lead acid batteries, flat-plate batteries, tubular batteries, valve regulated lead acid (“VRLA”) batteries, gel batteries, absorptive glass mat (“AGM”) batteries, deep cycle lead acid batteries, and/or batteries operating in a partial state of charge. Such batteries may be used in a variety of exemplary applications, such as in vehicles, alternative energy collection and storage such as those used in solar and wind energy harvesting and other renewable and/or alternative energy sources, inverters, uninterruptible power supply (“UPS”) devices, and/or the like. Exemplary vehicles described herein are not so limited, but is at least a vehicle provided with one or more of the separators or batteries described herein. In preferred embodiments, exemplary vehicles may be an automobile, a truck, a motorcycle, an all-terrain vehicle, a motorcycle, a forklift, a golf cart, a wheelchair, an idling-start-stop (“ISS”) vehicle, a hybrid vehicle, a hybrid-electric vehicle, micro-HEVs, an electric vehicle, an e-rickshaw battery, an e-trike, an e-bike, marine vessels, or any other motorized vehicle. Exemplary batteries that preferred embodiments of the inventive separator may be used in may include: a flat-plate battery, a flooded lead acid battery, an enhanced flooded lead acid battery (“EFB”), a valve regulated lead acid (“VRLA”) battery, a gel battery, an absorptive glass mat (“AGM”) battery, a deep-cycle battery, a tubular battery, an inverter battery, a vehicle battery, a starting-lighting-ignition (“SLI”) vehicle battery, an idling-start-stop (“ISS”) vehicle battery, an automobile battery, a truck battery, a motorcycle battery, an all-terrain vehicle battery, a forklift battery, a golf cart battery, a hybrid-electric vehicle battery, an electric vehicle battery, an e-rickshaw battery, an e-trike battery, an e-bike battery, a wheelchair battery, marine vessel batteries, and/or the like.

In some preferred embodiments, the batteries are used in devices where they will be operating at a partial state of charge. For example, the batteries are used in devices where they will be operating at a partial state of charge under normal every day conditions (i.e., in their normal state of use, not misuse).

### Methods

The methods described herein are not so limited. The method may be a method for preventing acid displacement in a lead acid battery, a flooded lead acid battery, or a flooded lead acid battery operating or intended to be operated in a partial state of charge in the normal state of operation, not misuse. The method may be a method for providing an electrode array as described herein in the lead acid battery.

Various embodiments of the invention have been described in fulfillment of the various objects of the invention. It should be recognized that these embodiments are merely illustrative of the principles of the present invention. Numerous modifications and adaptations will be readily apparent to those skilled in the art without departing from the spirit and scope of this invention.

### Conclusion

In accordance with at least selected embodiments, the present disclosure or invention is directed to separators, particularly separators for flooded lead acid batteries capable of reducing or mitigating acid starvation; reducing or mitigating acid stratification; reducing or mitigating dendrite growth; and having reduced electrical resistance and/or capable of increasing cold cranking amps. In addition, disclosed herein are methods, systems, and battery separators for enhancing battery life; reducing or mitigating acid starvation; reducing or mitigating acid stratification; reducing to mitigating dendrite growth; reducing the effects of oxidation; reducing water loss; reducing internal resistance; increasing wettability; improving acid diffusion; improving cold cranking amps, improving uniformity, and any combination thereof in at least enhanced flooded lead acid batteries. In accordance with at least particular embodiments, the present disclosure or invention is directed to an improved separator for enhanced flooded lead acid batteries wherein the separator includes an improved and novel rib design, and improved separator resiliency. In accordance with at least particular embodiments, the present disclosure or invention is directed to an improved separator for enhanced flooded lead acid batteries wherein the separator includes performance enhancing additives or coatings, increased oxidation resistance, increased porosity, increased void volume, amorphous silica, higher oil absorption silica, higher silanol group silica, silica with an OH to Si ratio of 21:100 to 35:100, a shish-kebab structure or morphology, a polyolefin microporous membrane containing particle-like filler in an amount of 40% or more by weight of the membrane and polymer, such as ultrahigh molecular weight polyethylene (“UHMWPE”), having shish-kebab formations with extended chain crystal (shish formation) and folded chain crystal (kebab formation) and the average repetition periodicity of the kebab formation from 1 nm to 150 nm, decreased sheet thickness, decreased tortuosity, reduced thickness, reduced oil content, increased wettability, increased acid diffusion, and/or the like, and any combination thereof.

In accordance with at least a first aspect of certain selected embodiments, a lead acid battery separator is provided with a porous membrane having a polymer and a filler. The porous membrane is provided with at least a first surface with at least a first plurality of ribs extending from the first surface. The first plurality of ribs are provided with a first plurality of teeth or discontinuous peaks or protrusions, where each of the first plurality of teeth or discontinuous peaks or protrusions are in such proximity to one another so as to provide resiliency to the separator. Such resiliency may refer to the separators ability to resist deflecting while under pressure resulting from NAM swelling. Such proximity may be at least approximately 1.5 mm from one tooth, peak, or protrusion to another. The separator may be further provided with a continuous base portion with the first plurality of teeth or discontinuous peaks or protrusions extending from the base portion.

In certain embodiments, the separator may be provided with a continuous base portion with the first plurality of teeth or discontinuous peaks or protrusions extending from the base portion. The base portion may be wider than the width of the teeth or discontinuous peaks or protrusions. In addition, the base portion may extend continuously between each of the teeth or discontinuous peaks or protrusions.

In accordance with at least certain select embodiments, the separator may be provided with ribs that are one or more of the following: solid ribs, discrete broken ribs, continuous ribs, discontinuous ribs, discontinuous peaks, discontinuous protrusions, angled ribs, linear ribs, longitudinal ribs extending substantially in a machine direction of the porous membrane, lateral ribs extending substantially in a cross-machine direction of the porous membrane, transverse ribs extending substantially in the cross-machine direction of the separator, teeth, toothed ribs, serrations, serrated ribs, battlements, battlemented ribs, curved ribs, sinusoidal ribs, disposed in a continuous zig-zag-sawtooth-like fashion, disposed in a broken discontinuous zig-zag-sawtooth-like fashion, grooves, channels, textured areas, embossments, dimples, columns, mini columns, porous, non-porous, mini ribs, cross-mini ribs, and combinations thereof.

At least a portion of the first plurality of ribs may be defined by an angle that may be neither parallel nor orthogonal relative to an edge of the separator. Furthermore, the angle may be defined as an angle relative to a machine direction of the porous membrane and the angle may be one of the following: between greater than zero degrees (0°) and less than 180 degrees (180°), and greater than 180 degrees (180°) and less than 360 degrees (360°). In certain aspects of disclosed embodiments, the angle may vary throughout the plurality of ribs.

In certain select aspects of the present invention, the first plurality of ribs may have a cross-machine direction spacing pitch of approximately 1.5 mm to approximately 10 mm, and the plurality of teeth or discontinuous peaks or protrusions may have a machine direction spacing pitch of approximately 1.5 mm to approximately 10 mm.

In certain select embodiments, the separator may be provided with a second plurality of ribs extending from a second surface of the porous membrane. The second plurality of ribs may be one or more of the following: solid ribs, discrete broken ribs, continuous ribs, discontinuous ribs, discontinuous peaks, discontinuous protrusions, angled ribs, linear ribs, longitudinal ribs extending substantially in a machine direction of the porous membrane, lateral ribs extending substantially in a cross-machine direction of the porous membrane, transverse ribs extending substantially in the cross-machine direction of the separator, teeth, toothed ribs, battlements, battlemented ribs, curved ribs, sinusoidal ribs, disposed in a continuous zig-zag-sawtooth-like fashion, disposed in a broken discontinuous zig-zag-sawtooth-like fashion, grooves, channels, textured areas, embossments, dimples, columns, mini columns, porous, non-porous, mini ribs, cross-mini ribs, and combinations thereof.

At least a portion of the second plurality of ribs may be defined by an angle that may be neither parallel nor orthogonal relative to an edge of the separator. Furthermore, the angle may be defined as an angle relative to a machine direction of the porous membrane and the angle may be one of the following between greater than zero degrees (0°) and less than 180 degrees (180°), and greater than 180 degrees (180°) and less than 360 degrees (360°). In certain aspects of disclosed embodiments, the angle may vary throughout the plurality of ribs.

The second plurality of ribs have a cross-machine or machine direction spacing pitch of approximately 1.5 mm to approximately 10 mm.

The first surface may be provided with one or more ribs that are of a different height than the first plurality of ribs disposed adjacent to an edge of the lead acid battery separator. Likewise, the second surface may be provided with one or more ribs that are of a different height than the second plurality of ribs disposed adjacent to an edge of the lead acid battery separator.

In select embodiments, the polymer may be one of the following: a polymer, polyolefin, polyethylene, polypropylene, ultra-high molecular weight polyethylene (“UHMWPE”), phenolic resin, polyvinyl chloride (“PVC”), rubber, synthetic wood pulp (“SWP”), lignins, glass fibers, synthetic fibers, cellulosic fibers, and combinations thereof.

A fibrous mat may be provided. The mat may be one of the following: glass fibers, synthetic fibers, silica, at least one performance enhancing additive, latex, natural rubber, synthetic rubber, and combinations thereof, and may be nonwoven, mesh, fleece, and combinations thereof.

In addition, the separator may be a cut-piece, a leaf, a pocket, a sleeve, a wrap, a fold, an envelope, and a hybrid envelope.

According to at least certain select exemplary embodiments, a separator may be provided with resilient means for mitigating separator deflection.

In accordance with at least certain select embodiments, a lead acid battery is provided with a positive electrode, and a negative electrode provided with swollen negative active material. A separator is provided with at least a portion of the separator being disposed between the positive electrode and the negative electrode. An electrolyte is provided that substantially submerges at least a portion of the positive electrode, at least a portion of the negative electrode, and at least a portion of the separator. In at least certain select embodiments, the separator may have a porous membrane made of at least a polymer and a filler. A first plurality of ribs may extend from a surface of the porous membrane. The ribs may be arranged such as to prevent acid starvation in the presence of NAM swelling. The lead acid battery may operate in any one or more of the following conditions: in motion, stationary, in a backup power application, in a cycling applications, in a partial state of charge, and any combination thereof.

The ribs may be provided with a plurality of teeth, or discontinuous peaks or protrusions. Each tooth, or discontinuous peak or protrusion may be at least approximately 1.5 mm from another of the plurality of discontinuous peaks. A continuous base portion may be provided, with the plurality of teeth, or discontinuous peaks or protrusions extending therefrom.

The first plurality of ribs may further be provided so as to enhance acid mixing in a battery, particularly during movement of the battery. The separator may be disposed parallel to a start and stop motion of the battery. The separator may be provided with a mat adjacent to the positive electrode, the negative electrode, or the separator. The mat may be at least partially made of glass fibers, synthetic fibers, silica, at least one performance enhancing additive, latex, natural rubber, synthetic rubber, and any combination thereof. The mat may be nonwoven, woven, mesh, fleece, and combinations thereof.

In at least certain select embodiments of the present invention, the lead acid battery may be a flat-plate battery, a flooded lead acid battery, an enhanced flooded lead acid battery (“EFB”), a valve regulated lead acid (“VRLA”) battery, a deep-cycle battery, a gel battery, an absorptive glass mat (“AGM”) battery, a tubular battery, an inverter battery, a vehicle battery, a starting-lighting-ignition (“SLI”) vehicle battery, an idling-start-stop (“ISS”) vehicle battery, an automobile battery, a truck battery, a motorcycle battery, an all-terrain vehicle battery, a forklift battery, a golf cart battery, a hybrid-electric vehicle battery, an electric vehicle battery, an e-rickshaw battery, or an e-bike battery, or any combination thereof.

In certain embodiments, the battery may operate at a depth of discharge of between approximately 1% and approximately 99%.

In accordance with at least one embodiment, a microporous separator with decreased tortuosity is provided. Tortuosity refers to the degree of curvature/turns that a pore takes over its length. Thus, a microporous separator with decreased tortuosity will present a shorter path for ions to travel through the separator, thereby decreasing electrical resistance. Microporous separators in accordance with such embodiments can have decreased thickness, increased pore size, more interconnected pores, and/or more open pores.

In accordance with at least certain selected embodiments, a microporous separator with increased porosity, or a separator with a different pore structure whose porosity is not significantly different from a known separator, and/or decreased thickness is provided. An ion will travel more rapidly though a microporous separator with optimized porosity, optimized void volume, optimized tortuosity, and/or decreased thickness, thereby decreasing electrical resistance. Such decreased thickness may result in decreased overall weight of the battery separator, which in turn decreases the weight of the enhanced flooded battery in which the separator is used, which in turn decreases the weight of the overall vehicle in which the enhanced flooded battery is used. Such decreased thickness may alternatively result in increased space for the positive active material (“PAM”) or the negative active material (“NAM”) in the enhanced flooded battery in which the separator is used.

In accordance with at least certain selected embodiments, a microporous separator with increased wettability (in water or acid) is provided. The separator with increased wettability will be more accessible to the electrolyte ionic species, thus facilitating their transit across the separator and decreasing electrical resistance.

In accordance with at least one embodiment, a microporous separator with decreased final oil content is provided. Such a microporous separator will also facilitate lowered ER (electrical resistance) in an enhanced flooded battery or system.

The separator may contain improved fillers that have increased friability, and that may increase the porosity, pore size, internal pore surface area, wettability, and/or the surface area of the separator. In some embodiments, the improved fillers have high structural morphology and/or reduced particle size and/or a different amount of silanol groups than previously known fillers and/or are more hydroxylated than previously known fillers. The improved fillers may absorb more oil and/or may permit incorporation of a greater amount of processing oil during separator formation, without concurrent shrinkage or compression when the oil is removed after extrusion. The fillers may further reduce what is called the hydration sphere of the electrolyte ions, enhancing their transport across the membrane, thereby once again lowering the overall electrical resistance or ER of the battery, such as an enhanced flooded battery or system.

The filler or fillers may contain various species (such as polar species, such as metals) that increase the ionic diffusion, and facilitate the flow of electrolyte and ions across the separator. Such also leads to decreased overall electrical resistance as such a separator is used in a flooded battery, such as an enhanced flooded battery.

The microporous separator further comprises a novel and improved pore morphology and/or novel and improved fibril morphology such that the separator contributes to significantly decreasing the electrical resistance in a flooded lead acid battery when such a separator is used in such a flooded lead acid battery. Such improved pore morphology and/or fibril morphology may result in a separator whose pores and/or fibrils approximate a shish-kebab (or shish kabob) type morphology. Another way to describe the novel and improved pore shape and structure is a textured fibril morphology in which silica nodes or nodes of silica are present at the kebab-type formations on the polymer fibrils (the fibrils sometimes called shishes) within the battery separator. Additionally, in certain embodiments, the silica structure and pore structure of a separator according to the present invention may be described as a skeletal structure or a vertebral structure or spinal structure, where silica nodes on the kebabs of polymer, along the fibrils of polymer, appear like vertebrae or disks (the “kebabs”), and sometimes are oriented substantially perpendicularly to, an elongate central spine or fibril (extended chain polymer crystal) that approximates a spinal column-like shape (the “shish”). In some instances, the improved battery comprising the improved separator with the improved pore morphology and/or fibril morphology may exhibit 20% lower, in some instances, 25% lower, in some instances, 30% lower electrical resistance, and in some instances, even more than a 30% drop in electrical resistance (“ER”) (which may reduce battery internal resistance) while such a separator retains and maintains a balance of other key, desirable mechanical properties of lead acid battery separators. Further, in certain embodiments, the separators described herein have a novel and/or improved pore shape such that more electrolyte flows through or fills the pores and/or voids as compared to known separators.

In addition, the present disclosure provides improved enhanced flooded lead acid batteries comprising one or more improved battery separators for an enhanced flooded battery, which separator combines for the battery the desirable features of decreased acid stratification, lowered voltage drop (or an increase in voltage drop durability), and increased CCA, in some instances, more than 8%, or more than 9%, or in some embodiments, more than 10%, or more than 15%, increased CCA. Such an improved separator may result in an enhanced flooded battery whose performance matches or even exceeds the performance of an AGM battery. Such low electrical resistance separator may also be treated so as to result in an enhanced flooded lead acid battery having reduced water loss.

The separator may contain one or more performance enhancing additives, such as a surfactant, along with other additives or agents, residual oil, and fillers. Such performance enhancing additives can reduce separator oxidation and/or even further facilitate the transport of ions across the membrane contributing to the overall lowered electrical resistance for the enhanced flooded battery described herein.

The separator for a lead acid battery described herein may comprise a polyolefin microporous membrane, wherein the polyolefin microporous membrane comprises: polymer, such as polyethylene, such as ultrahigh molecular weight polyethylene, particle-like filler, and processing plasticizer (optionally with one or more additional additives or agents). The polyolefin microporous membrane may comprise the particle-like filler in an amount of 40% or more by weight of the membrane. And the ultrahigh molecular weight polyethylene may comprise polymer in a shish-kebab formation comprising a plurality of extended chain crystals (the shish formations) and a plurality of folded chain crystals (the kebab formations), wherein the average repetition or periodicity of the kebab formations is from 1 nm to 150 nm, preferably, from 10 nm to 120 nm, and more preferably, from 20 nm to 100 nm (at least on portions of the rib side of the separator). The average repetition or periodicity of the kebab formations is calculated in accordance with the following definition:
The surface of the polyolefin microporous membrane is observed using a scanning electron microscope (“SEM”) after being subjected to metal vapor deposition, and then the image of the surface is taken at, for example 30,000 or 50,000-fold magnification at 1.0 kV accelerating voltage.
In the same visual area of the SEM image, at least three regions where shish-kebab formations are continuously extended in the length of at least 0.5 μm or longer are indicated. Then, the kebab periodicity of each indicated region is calculated.
The kebab periodicity is specified by Fourier transform of concentration profile (contrast profile) obtained by projecting in the vertical direction to the shish formation of the shish-kebab formation in each indicated region to calculate the average of the repetition periods.
The images are analyzed using general analysis tools, for example, MATLAB (R2013a).
Among the spectrum profiles obtained after the Fourier transform, spectrum detected in the short wavelength region are considered as noise. Such noise is mainly caused by deformation of contrast profile. The contrast profiles obtained for separators in accordance with the present invention appear to generate square-like waves (rather than sinusoidal waves). Further, when the contrast profile is a square-like wave, the profile after the Fourier transform becomes a Sine function and therefore generates plural peaks in the short wavelength region besides the main peak indicating the true kebab periodicity. Such peaks in the short wavelength region can be detected as noise.

In some embodiments, the separator for a lead acid battery described herein comprises a filler selected from the group consisting of silica, precipitated silica, fumed silica, and precipitated amorphous silica; wherein the molecular ratio of OH to Si groups within said filler, measured by ²⁹Si-NMR, is within a range of from 21:100 to 35:100, in some embodiments, 23:100 to 31:100, in some embodiments, 25:100 to 29:100, and in certain preferred embodiments, 27:100 or higher.

Silanol groups change a silica structure from a crystalline structure to an amorphous structure, since the relatively stiff covalent bond network of Si—O has partially disappeared. The amorphous-like silicas such as Si(—O—Si)₂(—OH)₂ and Si(—O—Si)₃(—OH) have plenty of distortions, which may function as various oil absorption points. Therefore oil absorbability becomes high when the amount of silanol groups (Si—OH) is increased for the silica. Additionally, the separator described herein may exhibit increased hydrophilicity and/or may have higher void volume and/or may have certain aggregates surrounded by large voids when it comprises a silica comprising a higher amount of silanol groups and/or hydroxyl groups than a silica used with a known lead acid battery separator.

The microporous separator further comprises a novel and improved pore morphology and/or novel and improved fibril morphology such that the separator contributes to significantly decreasing the electrical resistance in a flooded lead acid battery when such a separator is used in such a flooded lead acid battery. Such improved pore morphology and/or fibril morphology may result in a separator whose pores and/or fibrils approximate a shish-kebab (or shish kabob) type morphology. Another way to describe the novel and improved pore shape and structure is a textured fibril morphology in which silica nodes or nodes of silica are present at the kebab-type formations on the polymer fibrils (the fibrils sometimes called shishes) within the battery separator. Additionally, in certain embodiments, the silica structure and pore structure of a separator according to the present invention may be described as a skeletal structure or a vertebral structure or spinal structure, where silica nodes on the kebabs of polymer, along the fibrils of polymer, appear like vertebrae or disks (the “kebabs”), and sometimes are oriented substantially perpendicularly to, an elongate central spine or fibril (extended chain polymer crystal) that approximates a spinal column-like shape (the “shish”).

In certain selected embodiments, a vehicle may be provided with a lead acid battery as generally described herein. The battery may further be provided with a separator as described herein. The vehicle may be an automobile, a truck, a motorcycle, an all-terrain vehicle, a forklift, a golf cart, a hybrid vehicle, a hybrid-electric vehicle battery, an electric vehicle, an idling-start-stop (“ISS”) vehicle, an e-rickshaw, an e-bike, an e-bike battery, and combinations thereof.

In certain preferred embodiments, the present disclosure or invention provides a flexible battery separator whose components and physical attributes and features synergistically combine to address, in unexpected ways, previously unmet needs in the deep cycle battery industry, with an improved battery separator (a separator having a porous membrane of polymer, such as polyethylene, plus a certain amount of a performance enhancing additive and ribs) that meets or, in certain embodiments, exceeds the performance of the previously known flexible, which are currently used in many deep cycle battery applications. In particular, the inventive separators described herein are more robust, less fragile, less brittle, more stable over time (less susceptible to degradation) than separators traditionally used with deep cycle batteries. The flexible, performance enhancing additive-containing and rib possessing separators of the present invention combine the desired robust physical and mechanical properties of a polyethylene-based separator with the capabilities of a conventional separator, while also enhancing the performance of the battery system employing the same.

In accordance with at least select embodiments, aspects or objects, disclosed herein or provided are novel or improved separators, battery separators, enhanced flooded battery separators, batteries, cells, and/or methods of manufacture and/or use of such separators, battery separators, enhanced flooded battery separators, cells, and/or batteries. In accordance with at least certain embodiments, the present disclosure or invention is directed to novel or improved battery separators for enhanced flooded batteries. In addition, there is disclosed herein methods, systems, and battery separators having a reduced ER, improved puncture strength, improved separator CMD stiffness, improved oxidation resistance, reduced separator thickness, reduced basis weight, and any combination thereof. In accordance with at least particular embodiments, the present disclosure or invention is directed to an improved separator for enhanced flooded batteries wherein the separator has a reduced ER, improved puncture strength, improved separator CMD stiffness, improved oxidation resistance, reduced separator thickness, reduced basis weight, or any combination thereof. In accordance with at least certain embodiments, separators are provided that include or exhibit a reduced ER, improved puncture strength, improved separator CMD stiffness, improved oxidation resistance, reduced separator thickness, reduced basis weight, and any combination thereof. In accordance with at least certain embodiments, separators are provided in battery applications for flat-plate batteries, tubular batteries, vehicle SLI, and HEV ISS applications, deep cycle applications, golf car or golf cart and e-rickshaw batteries, batteries operating in a partial state of charge (“PSOC”), inverter batteries; and storage batteries for renewable energy sources, and any combination thereof.

In a particular exemplary embodiment, a lead acid battery is provided with an electrode array having one or more negative electrodes, and one or more positive electrodes interleaved between the one or more negative electrodes. At least one of the one or more negative electrodes is enveloped with a fibrous mat, and the one or more positive electrodes adjacent to the at least one of the one or more negative electrodes are enveloped with a porous membrane. The porous membrane may be a microporous battery separator.

In exemplary aspects, the fibrous mat may be a nonwoven, mesh, fleece, and/or the like, and/or combinations thereof. The fibrous mat may further be glass fibers, pulp, a polymer, and/or the like, and/or combinations thereof. In addition, the fibrous mat may be formed from a polymer and additionally with glass fibers, pulp, and/or the like, and/or combinations thereof, and the polymer may be a polyolefin, a polyester, a polyamide, a polyimide, and/or the like, and/or combinations thereof. The fibrous mat may be an inorganic material, such as silica. The fibrous mat be a spun-bond melt-nonwoven composite material or a carbon fiber nonwoven material, and/or the like.

An exemplary porous membrane may be provided with one or more arrays of ribs on at least one surface thereof, or one or more arrays of ribs on two surfaces thereof. The ribs may have a height of about 10 μm to about 2.0 mm. The porous membrane may be one or more of natural materials, synthetic materials, polyolefins, phenolic resins, poly vinyl chloride (PVC), natural rubber, synthetic rubber, synthetic wood pulp, glass fibers, lignins, cellulosic fibers, and/or the like, and/or combinations thereof. Alternatively, the porous membrane may be polyethylene, silica, and processing oil, wherein the processing oil is in an amount of about 5% by weight of the porous membrane to about 15% by weight of the porous membrane.

In certain select aspects, the porous membrane has a porosity of greater than about 55%, about 60%, about 65%.

In another exemplary aspect, the porous membrane of an exemplary lead acid battery may be enveloped about the positive electrode and sealed on either on one side, two sides, and/or three sides of the positive electrode.

In yet another exemplary aspect, the fibrous mat of an exemplary lead acid battery may be enveloped about the negative electrode and sealed on one side, two sides, and/or three sides of the negative electrode.

In yet another exemplary embodiment, one example of a preferred lead acid battery may be provided with an electrode array comprising one or more negative electrodes, and one or more positive electrodes interleaved between the one or more negative electrodes. The battery may further be provided with one or more electrode and fibrous mat assemblies comprising a fibrous mat at least partially integrated into at least one of the negative electrodes. A porous membrane, which may be a microporous membrane, may be enveloping one or more of the one or more electrode and fibrous mat assemblies or at least one of the one or more positive electrodes adjacent to the one or more electrode and fibrous mat assemblies. In an exemplary aspect, the fibrous mat may be integrated into the active material from about 2% to about 50% of a mat thickness of the fibrous mat, from about 5% to about 25% of the mat thickness, from about 5% to about 20% of the mat thickness, or from about 10% to about 15% of the mat thickness.

Any exemplary fibrous mat may be one or more of a nonwoven, mesh, fleece, and/or the like, and/or combinations thereof. In addition, the fibrous mat may be one or more of glass fibers, pulp, a polymer, and/or the like, and/or combinations thereof. Furthermore, the fibrous mat may be formed of a polymer and additionally with one or more of glass fibers, pulp, and/or the like, and/or combinations thereof, and the polymer may be one or more of a polyolefin, a polyester, a polyamide, a polyimide, and/or the like, and/or combinations thereof.

In another aspect of an exemplary lead acid battery, an exemplary fibrous mat may be an inorganic material, such as silica. The fibrous mat may be a spun-bond melt-nonwoven, a carbon fiber nonwoven, and/or the like.

In a further aspect of an exemplary lead acid battery, an exemplary porous membrane may have one or more arrays of ribs on one or two surfaces thereof. The ribs of the one or more arrays of ribs may have a height of about 10 m to about 2.0 mm.

An exemplary porous membrane may be at least one of natural materials, synthetic materials, polyolefins, phenolic resins, poly vinyl chloride (PVC), natural rubber, synthetic rubber, synthetic wood pulp, glass fibers, lignins, cellulosic fibers, and/or the like, and/or combinations thereof. In one particular embodiment, the porous membrane may be polyethylene, silica, and processing oil.

In another exemplary aspect, the porous membrane of an exemplary lead acid battery may be enveloped about the positive electrode and sealed on either on one side, two sides, and/or three sides of the positive electrode. In yet another exemplary aspect, the porous membrane of an exemplary lead acid battery may be sealed on one side, two sides, and/or three sides of the one or more electrode and fibrous mat assemblies.

In a further select embodiment of an exemplary preferred embodiment, a lead acid battery is provided with an electrode array of one or more negative electrodes and one or more positive electrodes alternately arranged with respect to one another. A porous membrane envelope is further provided to envelope at least one of the one or more negative electrodes disposed therein, with the porous membrane comprises ribs on one or more surfaces thereof and a fibrous mat is disposed within the envelope. The ribs may at least be partially on a surface of the porous membrane adjacent to the fibrous mat. The ribs may have a height of from about 10 μm to about 2.0 mm, or from about 5 μm to about 300 μm, or from about 25 μm to about 200 μm. In addition, the fibrous mat may envelope the at least one of the one or more negative electrodes. Furthermore, the fibrous mat may be at least partially integrated into the negative electrode.

Alternatively, the fibrous mat may be discrete pieces disposed between the ribs, and have a thickness from about 50% of the height of the ribs to about 150% of the height of the ribs. In select aspects of the present invention, the fibrous mat may be disposed between the negative electrode and the porous membrane. The fibrous mat may be one or more of glass fibers, pulp, a polymer, and combinations thereof. The fibrous mat may be formed from a polymer in combination with one or more of glass fibers, pulp, and combinations thereof; wherein the polymer may be one or more of a polyolefin, a polyester, a polyamide, a polyimide, and combinations thereof. In addition, the fibrous mat may be an inorganic material, such as silica. The fibrous mat may be a spun-bond melt-nonwoven composite material, or a carbon fiber nonwoven material.

In select embodiments, the porous membrane may have ribs on two surfaces thereof. In addition, the porous membrane may be one or more of natural materials, synthetic materials, polyolefins, phenolic resins, poly vinyl chloride (PVC), natural rubber, synthetic rubber, synthetic wood pulp, glass fibers, lignins, cellulosic fibers, and combinations thereof. Specifically, the porous membrane may be polyethylene, silica, and processing oil.

In select aspects of the present invention, the porous membrane may be sealed on one side of the negative electrode, two sides of the negative electrode, or three sides of the negative electrode. In addition, the fibrous mat may be sealed on one side of the negative electrode, two sides of the negative electrode, and three sides of the negative electrode.

In select embodiments of the present invention, a system is provided with a vehicle utilizing one or more batteries as substantially described herein. The vehicle may be an automobile, a truck, a motorcycle, an all-terrain vehicle, a motorcycle, a forklift, a golf cart, a hybrid vehicle, a hybrid-electric vehicle, an electric vehicle, an idling-start-stop (“ISS”) vehicle, an e-rickshaw battery, an e-trike, an e-bike, a wheel chair, or a marine vessel.

In select embodiments, a lead acid battery as substantially described herein may be a flat-plate battery, a flooded lead acid battery, an enhanced flooded lead acid battery (“EFB”), a valve regulated lead acid (“VRLA”) battery, a gel battery, an absorptive glass mat (“AGM”) battery, a deep-cycle battery, a tubular battery, an inverter battery, a vehicle battery, a starting-lighting-ignition (“SLI”) vehicle battery, an idling-start-stop (“ISS”) vehicle battery, an automobile battery, a truck battery, a motorcycle battery, an all-terrain vehicle battery, a forklift battery, a golf cart battery, a hybrid-electric vehicle battery, an electric vehicle battery, a wheel chair battery, an e-rickshaw battery, an e-trike battery, an e-bike battery, or a marine vessel battery.

In select embodiments, a method is provided for preventing or mitigating acid displacement in a lead acid battery, a flooded lead acid battery, or a flooded lead acid battery operating or intended to be operated in a partial state of charge. The method may include manufacturing a battery such that it has a structure substantially identical to any battery as described herein.

Novel or improved systems, vehicles, batteries, enhanced flooded lead acid batteries, deep-cycle batteries, separators, battery separators, enhanced flooded lead acid battery separators, deep-cycle battery separators, separators, fibrous mats, cells, electrodes, and/or methods of manufacture and/or use of such batteries, enhanced flooded lead acid batteries, deep-cycle batteries, separators, battery separators, enhanced flooded lead acid battery separators, deep-cycle battery separators, fibrous mats, cells, and/or electrodes as shown or described herein.

Novel or improved batteries, particularly lead acid batteries as shown and/or described herein; novel or improved systems, vehicles, batteries, enhanced flooded lead acid batteries, deep-cycle batteries, separators, battery separators, enhanced flooded lead acid battery separators, deep-cycle battery separators, separators, fibrous mats, cells, electrodes, and/or methods of manufacture and/or use of such systems, vehicles, batteries, enhanced flooded lead acid batteries, deep-cycle batteries, separators, battery separators, enhanced flooded lead acid battery separators, deep-cycle battery separators, separators, fibrous mats, cells, and/or electrodes; an improved battery with an improved separator for lead acid batteries and/or improved methods of using such batteries having such improved separators; methods, systems, treatments, and battery separators for enhancing battery life, reducing battery failure, reducing water loss, lowering float current, mitigating increases in internal resistance, increasing wettability, reducing acid stratification, improving acid diffusion, preserving active material, mitigating active material shedding, and/or improving uniformity in lead acid batteries; an improved separator for lead acid batteries wherein the separator includes improved functional coatings, improved battery separators that reduce acid stratification, improved battery separators that improve acid diffusion, improved lead acid batteries that preserve active material, improved lead acid battery separators that mitigate active material shedding, improved lead acid batteries including such improved separators, long-life automotive lead acid batteries, improved flooded lead acid batteries, and/or the like, and/or batteries having reduced acid stratification, improved acid diffusion, improved ability to preserve active material, and/or improved ability to reduce active material shedding, a battery having a polyethylene separator and a negative electrode with a fibrous mat disposed therebetween, and/or methods of manufacture and/or use of such a battery; a battery with a porous membrane and a fibrous mat laminated thereto, wherein the fibrous mat is adjacent to a negative electrode in such battery, and/or methods of manufacture, and/or use of such a battery. It may be preferred in certain embodiments that the fibrous mat is bonded to the polymer membrane (for example, to the ribs thereof, such as to the negative ribs) and that the fibrous mat is not embedded in the backweb of the membrane.

As described herein, exemplary separators may be used in lead acid batteries that are utilized in a variety of applications. Such applications may include, for example: partial state of charge applications; deep-cycling applications; automobile applications; truck applications; motorcycle applications; motive power applications, such as fork trucks, golf carts (also called golf cars), and the like; electric vehicle applications; hybrid-electric vehicle (“HEVs”) applications; ISS vehicle applications; e-rickshaw applications; e-trike applications; e-bike applications; boat applications; energy collection and storage applications, such as renewable and/or alternative energy collection and storage, such as wind energy, solar energy, and the like. In addition, exemplary separators may be used in a variety of batteries. Such exemplary batteries may include, for example: flooded lead acid batteries, such as enhanced flooded lead acid batteries; AGM batteries; VRLA batteries; plate batteries; tubular batteries; partial state of charge batteries; deep-cycling batteries; automobile batteries; truck batteries; motorcycle batteries; motive power batteries, such as fork truck batteries, golf cart (also called golf cars) batteries, and the like; electric vehicle batteries; hybrid-electric vehicle (“HEVs”) batteries; ISS vehicle batteries; e-rickshaw batteries; e-trike batteries; e-bike batteries; boat batteries; energy collection and storage batteries, such as renewable and/or alternative energy collection and storage, such as wind energy, solar energy, and the like.

In accordance with at least select embodiments, the present disclosure or invention is directed to novel or improved separators for lead acid batteries, such as flooded lead acid batteries, and in particular enhanced flooded lead acid batteries (“EFBs”), and various other lead acid batteries, such as gel and absorptive glass mat (“AGM”) batteries. In accordance with at least select embodiments, the present disclosure or invention is directed to novel or improved separators, battery separators, resilient separators, balanced separators, EFB separators, batteries, cells, systems, methods involving the same, vehicles using the same, methods of manufacturing the same, the use of the same, and combinations thereof. In addition, disclosed herein are methods, systems, and battery separators for enhancing battery life and reducing battery failure by reducing battery electrode acid starvation.

A flooded lead acid battery and a vehicle comprising the same are described herein. The flooded lead acid battery comprises an electrode array, comprising one or more negative plates and one or more positive plates alternately arranged and interleafed with one another. In some embodiments, a negative plate is wrapped or enveloped with a fibrous mat, and a porous membrane is wrapped or enveloped about an adjacent positive electrode. In some embodiments, a fibrous mat is at least partially integrated into a negative plate, and a porous membrane is enveloped about either the negative plate with the fibrous mat partially integrated therein or around an adjacent positive plate. In other embodiments, a negative plate is enveloped with a porous membrane having ribs, and a fibrous mat is present between the wrapped negative plate and the porous membrane enveloping the negative plate. Methods, systems, and vehicles utilizing the disclosed batteries are also provided.

In accordance with at least selected embodiments, the present disclosure or invention is directed to novel or improved separators, battery separators, enhanced flooded battery separators, batteries, cells, and/or methods of manufacture and/or use of such separators, battery separators, enhanced flooded battery separators, cells, batteries, systems, methods, and/or vehicles using the same. In accordance with at least certain embodiments, the present disclosure or invention is directed to novel or improved battery separators, resilient separators, balanced separators, flooded lead acid battery separators, or enhanced flooded lead acid battery separators such as those useful for deep-cycling and/or partial state of charge (“PSoC”) applications. Such applications may include such non-limiting examples as: electric motive machine applications, such as fork lifts and golf carts (sometimes referred to as golf cars), e-rickshaws, e-bikes, e-trikes, and/or the like; automobile applications such as starting lighting ignition (“SLI”) batteries, such as those used for internal combustion engine vehicles; idle-start-stop (“ISS”) vehicle batteries; hybrid vehicle applications, hybrid-electric vehicle applications; batteries with high power requirements, such as uninterrupted power supply (“UPS”) or valve regulated lead acid (“VRLA”), and/or for batteries with high CCA requirements; inverters; and energy storage systems, such as those found in renewable and/or alternative energy systems, such as solar and wind power collection systems.

In accordance with at least selected embodiments, the present disclosure or invention is directed to separators, resilient separators, balanced separators, particularly separators for flooded lead acid batteries capable of reducing or mitigating acid starvation; reducing or mitigating acid stratification; reducing or mitigating dendrite growth; having reduced electrical resistance and/or capable of increasing cold cranking amps; having reduced electrical resistance and negative cross ribs; having low water loss, reduced electrical resistance and/or negative cross ribs; having dendrite blocking or prevention performance, characteristics and/or structures; having acid mixing prevention performance, characteristics and/or structures; having enhanced negative cross ribs; having glass mat on the positive and/or negative side of a PE membrane, piece, sleeve, fold, wrap, pocket, envelope, and/or the like; having the glass mat laminated to the PE membrane; and/or combinations or sub-combinations thereof.

Disclosed herein are exemplary embodiments of improved separators for lead acid batteries, improved lead acid batteries incorporating the improved separators, and systems or vehicles incorporating the improved separators and/or batteries. A lead acid battery separator is provided with a porous membrane with a plurality of ribs extending from a surface thereon. The ribs are provided with a plurality of discontinuous peaks arranged such as to provide resilient support for the porous membrane in order to resist forces exerted by swelling NAM and thus mitigate the effects of acid starvation associated with NAM swelling. The separator is also provided to be capable utilizing any motion experienced by the battery housing such a separator in order to mitigate the effects of acid stratification by facilitating acid mixing. A lead acid battery is further provided that incorporates the provided separator. Such a lead acid battery may be a flooded lead acid battery, an enhanced flooded lead acid battery, and may be provided as operating in a partial state of charge. Systems incorporating such a lead acid battery are also provided, such as a vehicle or any other energy storage system, such as solar or wind energy collection. Other exemplary embodiments are provided such as to have any one or more of the following: a lowered electrical resistance; increased puncture resistance; increased oxidation resistance; increased ability to mitigate the effects of dendrite growth, and other improvements.

In accordance with at least selected embodiments, aspects or objects, the present disclosure or invention may address the issues or problems of prior batteries, separators or membranes, especially but not limited to EFB batteries and separators, and/or may provide and/or may be directed to novel or improved separators, battery separators, membranes, separator membranes, enhanced flooded battery separators, fibrous mats, batteries, cells, and/or methods of manufacture and/or use of such separators, battery separators, fibrous mats, enhanced flooded battery separators, cells, and/or batteries. In accordance with at least certain embodiments, the present disclosure or invention is directed to novel or improved enhanced flooded lead acid battery separators for starting lighting ignition (“SLI”) batteries, fibrous mats, flooded batteries for deep cycle applications, and/or enhanced flooded batteries, and/or systems, vehicles, and/or the like including such separators, mats, batteries, and/or improved methods of making and/or using such improved separators, mats, cells, batteries, systems, vehicles, and/or the like. In accordance with at least certain embodiments, the present disclosure or invention is directed to an improved separator for enhanced flooded batteries and/or improved methods of making and/or using such batteries having such improved separators. In accordance with at least selected embodiments, the present disclosure or invention is directed to separators, particularly separators for enhanced flooded batteries having reduced electrical resistance and/or increased cold cranking amps. In addition, disclosed herein are methods, systems and battery separators for enhancing active material retention, enhancing battery life, reducing water loss, reducing internal resistance, increasing wettability, reducing acid stratification, improving acid diffusion, improving cold cranking amps, improving uniformity in at least enhanced flooded batteries, and/or the like. In accordance with at least particular embodiments, the present disclosure or invention is directed to an improved separator for enhanced flooded batteries wherein the separator includes one or more performance enhancing additives or coatings, increased porosity, increased void volume, amorphous silica, higher oil absorption silica, higher silanol group silica, retention and/or improved retention of active material on electrodes, and/or any combination thereof.

In accordance with at least certain embodiments, the present disclosure or invention is directed to novel or improved separators, battery separators, flooded battery separators, enhanced flooded battery separators, fibrous mats, batteries, cells, and/or methods of manufacture and/or use of such separators, battery separators, fibrous mats, flooded battery separators, enhanced flooded battery separators, cells, and/or batteries. In accordance with at least certain embodiments, the present disclosure or invention is directed to novel or improved enhanced flooded battery separators for starting lighting ignition (“SLI”) batteries, fibrous mats, flooded batteries for deep cycle applications, flooded batteries for motive power applications, flooded batteries for partial state of charge (PSoC) applications, and/or enhanced flooded batteries, and/or systems, vehicles, and/or the like including such separators, fibrous mats, batteries, and/or improved methods of making and/or using such improved separators, fibrous mats, cells, batteries, systems, vehicles, and/or the like. In accordance with at least certain embodiments, the present disclosure or invention is directed to an improved separator for enhanced flooded batteries and/or improved methods of making and/or using such batteries having such improved separators. In accordance with at least selected embodiments, the present disclosure or invention is directed to separators, particularly separators for enhanced flooded batteries having reduced electrical resistance and/or increased cold cranking amps. In addition, disclosed herein are methods, systems, and battery separators for enhancing active material retention, enhancing battery life, reducing water loss, reducing internal resistance, increasing wettability, reducing acid stratification, improving acid diffusion, improving cold cranking amps, improving uniformity in at least enhanced flooded batteries, and/or the like. In accordance with at least particular embodiments, the present disclosure or invention is directed to an improved separator for enhanced flooded batteries wherein the separator includes one or more performance enhancing additives or coatings, optimized porosity, optimized void volume, amorphous silica, higher oil absorption silica, higher silanol group silica, retention, and/or improved retention of active material on electrodes, and/or any combination thereof.

In accordance with at least particular embodiments, the present disclosure or invention is directed to an improved separator for flooded or enhanced flooded batteries wherein the separator includes an improved formulation designed to further reduce water loss, reduce maintenance, and increase abuse tolerance in heavy duty deep cycle applications such as golf car, renewables, floor machine, and traction vehicles.

Features may include:
Incorporates a new polyethylene formulation, which counteracts the effects of antimony migration. Suppression is comparable with rubber separators.
Sealable for both envelope or sleeve automation providing protection from shorts.
High oxidation resistance.
High porosity for lower electrical resistance.
Optional glass mat for active material retention

Benefits may include:
Exceeds battery life requirements by counteracting negative effects of antimony poisoning including superior oxidation resistance and reduced water loss.
Enveloping and sleeving on high-speed equipment allow manufacturing efficiency and consistency, while reducing field failures.

In accordance with at least other particular embodiments, the present disclosure or invention is directed to an improved separator for tubular, flooded or enhanced flooded batteries wherein the separator helps to extend battery life in motive power applications through a special reduced water loss feature and unique profile design. As motive power batteries experience increased operations in partial-state-of-charge, this separator may help defend against accelerated grid corrosion and acid stratification, thus increasing battery life.

Features may include:
Serrated rib pattern
Low water loss property
Closer rib pitch

Benefits may include:
Enhanced acid circulation and improved acid mixing (less acid stratification)
Lower acid displacement
Lower water loss
Even plate spacing and no up moving under vibration
Uniform element compression with closer rib pitch

In selected embodiments, a flooded lead acid battery and a system, vehicle or device comprising the same are described herein. In certain selected embodiments, the flooded lead acid battery comprises an electrode array, comprising one or more negative plates and one or more positive plates alternately arranged and interleafed with one another. In some embodiments, a negative plate is wrapped or enveloped with a fibrous mat, and a porous membrane is wrapped or enveloped about an adjacent positive electrode. In some embodiments, a fibrous mat is at least partially integrated into a negative plate, and a porous membrane is enveloped about either the negative plate with the fibrous mat partially integrated therein or around an adjacent positive plate. In other embodiments, a negative plate is enveloped with a porous membrane having ribs, and a fibrous mat is present between the wrapped negative plate and the porous membrane enveloping the negative plate. In some embodiments, a positive plate is wrapped or enveloped with a fibrous mat, and a porous membrane is wrapped or enveloped about an adjacent negative electrode. In some embodiments, a fibrous mat is at least partially integrated into a positive plate, and a porous membrane is enveloped about either the positive plate with the fibrous mat partially integrated therein or around an adjacent negative plate. In other embodiments, a positive and/or negative plate is enveloped with a porous membrane having ribs, and a fibrous mat is present between the wrapped positive and/or negative plate and the porous membrane enveloping the positive and/or negative plate. In certain embodiments, methods, systems, devices, and/or vehicles utilizing the disclosed separators, plates, mats, membranes, composite mats and membranes, laminated mats and membranes, wrapped plates, pocketed plates, wrapped and pocketed plates, and/or batteries are also provided.

In accordance with at least selected embodiments, the present disclosure or invention is directed to separators for lead acid batteries, in particular flooded lead acid batteries, and various lead acid batteries, such as flooded lead acid batteries or enhanced flooded lead acid batteries, having the same. In accordance with at least selected embodiments, the present disclosure or invention is directed to novel or improved separators, cells, batteries, and/or methods of manufacture and/or use of such separators, cells, and/or batteries. In accordance with at least certain embodiments, the present disclosure or invention is directed to an improved separator for lead acid batteries and/or improved methods of using such batteries having such improved separators. Such batteries may be 6-volt (or 6V) or 12-volt batteries, battery banks of 12, 18, 24, 30, 36, 42, or 48 volts, 24-volt, 36-volt, 48-volt, 60-volt, 72-volt, or 84-volt batteries or banks, in series wired, in parallel wired, battery strings of 2 or more batteries, and/or the like. Such lead acid batteries may be used in combination with one or more capacitors, lithium batteries, fuel cells, and/or the like. Such batteries and battery combinations may be used in a variety of exemplary applications, such as in vehicles, alternative energy collection and storage such as those used in solar and wind energy harvesting and other renewable and/or alternative energy sources, inverters, uninterruptible power supply (“UPS”) devices, and/or the like. In addition, disclosed herein are methods, systems and battery separators for enhancing active material retention, battery life, reducing battery failure, reducing water loss, improving oxidation stability, improving, maintaining, and/or lowering float current, improving end of charge (EOC) current, decreasing the current and/or voltage needed to charge and/or fully charge a deep cycle battery, minimizing internal electrical resistance increases, lowering electrical resistance, increasing wettability, lowering wet out time with electrolyte, reducing time of battery formation, reducing antimony poisoning, reducing acid stratification, improving acid diffusion, and/or improving uniformity in lead acid batteries. In accordance with at least particular embodiments, the present disclosure or invention is directed to an improved separator for lead acid batteries wherein the separator includes one or more improved performance enhancing additives and/or coatings. In accordance with at least certain embodiments, the disclosed separators are useful for deep-cycling applications, for instance in motive machines or vehicles and/or stationary machines or vehicles, such as golf carts, fork trucks, inverters, renewable energy systems and/or alternative energy systems, by way of example only, solar power systems and wind power systems; in particular, the disclosed separators are useful in battery systems wherein deep cycling and/or partial state of charge operations are part of the battery life, even more particularly, in battery systems where additives and/or alloys (e.g., antimony (Sb)) are added to the battery to enhance the life and/or performance of the battery and/or to enhance the deep cycling and/or partial state of charge operating capability of the battery.

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” may be used in place of “comprising” and “including” to provide for more specific embodiments of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

The present invention may be embodied in other forms without departing from the spirit and the essential attributes thereof, and, accordingly, reference should be made to the appended claims, rather than to the foregoing specification, as indicating the scope of the invention. Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that may be performed it is understood that each of these additional steps may be performed with any specific embodiment or combination of embodiments of the disclosed methods.

The foregoing written description of structures and methods has been presented for purposes of illustration only. Examples are used to disclose exemplary embodiments, including the best mode, and also to enable any person skilled in the art to practice the invention, including making and using any devices or systems and performing any incorporated methods. These examples are not intended to be exhaustive or to limit the invention to the precise steps and/or forms disclosed, and many modifications and variations are possible in light of the above teaching. Features described herein may be combined in any combination. Steps of a method described herein may be performed in any sequence that is physically possible. The patentable scope of the invention is defined by the appended claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The compositions and methods of the appended claims are not limited in scope by the specific compositions and methods described herein, which are intended as illustrations of a few aspects of the claims. Any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

As used in the specification and the appended claims, the singular forms “a,” “an,” and “the” include plural referents unless the context clearly dictates otherwise. Ranges may be expressed herein as from “about” or “approximately” one particular value, and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. “Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers, or steps. The terms “consisting essentially of” and “consisting of” may be used in place of “comprising” and “including” to provide for more specific embodiments of the invention and are also disclosed. “Exemplary” or “for example” means “an example of” and is not intended to convey an indication of a preferred or ideal embodiment. Similarly, “such as” is not used in a restrictive sense, but for explanatory or exemplary purposes.

Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

Additionally, the invention illustratively disclosed herein suitably may be practiced in the absence of any element which is not specifically disclosed herein.

1. A lead acid battery comprising:
an electrode array comprising one or more negative electrodes, and one or more positive electrodes interleaved between said one or more negative electrodes;
a fibrous mat envelope with one of said one or more negative electrodes disposed therein; and
a porous membrane envelope with said fibrous mat envelope disposed therein, wherein
said battery may be selected from the group consisting of: a flat Plate battery, a flooded lead acid battery, an enhanced flooded lead acid battery (“EFB”), a valve regulated lead acid (“VRLA”) battery, a gel battery, an absorptive glass mat (“AGM”) battery, a deep cycle battery, a tubular battery, a motive battery, an inverter battery, a PSoC battery, a vehicle battery, a starting-lighting-ignition (“SLI”) vehicle battery, an idling-start-stop (“ISS”) vehicle battery, an automobile battery, a truck battery, a motorcycle battery, an all-terrain vehicle battery, a forklift battery, a golf cart battery, a hybrid-electric vehicle battery, an electric vehicle battery, a wheel chair battery, an e-rickshaw battery, an e-trike battery, an e-bike battery, and a marine vessel battery.

2. The lead acid battery of claim 0, wherein said fibrous mat envelope:
is one of the list consisting of a nonwoven, mesh, fleece, and combinations thereof;
is formed from a polymer and additionally with one or more of the group consisting of glass fibers, pulp, and combinations thereof;
is formed from a polymer and additionally with one or more of the group consisting of glass fibers, pulp, and combinations thereof, said polymer comprising one or more material selected from the group consisting of a polyolefin, a polyester, a polyamide, a polyimide, and combinations thereof;
comprises an inorganic material;
comprises an inorganic material, wherein said inorganic material comprises silica;
comprises a spun-bond melt-nonwoven composite material;
comprises a carbon fiber nonwoven material;
comprises a carbon fiber nonwoven material, wherein said carbon fiber nonwoven material comprises conductive carbon, graphite, artificial graphite, activated carbon, acetylene black, carbon black, high surface area carbon black, graphene, high surface area graphene, keitjen black, carbon fibers, carbon filaments, carbon nanotubes, open-cell carbon foam, a carbon mat, carbon felt, carbon Buckminsterfullerene (Bucky Balls), flake graphite, oxidized carbon, and combinations thereof;
comprises conductive carbon, graphite, artificial graphite, activated carbon, carbon paper, acetylene black, carbon black, high surface area carbon black, graphene, high surface area graphene, keitjen black, carbon fibers, carbon filaments, carbon nanotubes, open-cell carbon foam, a carbon mat, carbon felt, carbon Buckminsterfullerene (Bucky Balls), an aqueous carbon suspension, flake graphite, oxidized carbon, and combinations thereof;
comprises a nucleation additive;
comprises a nucleation additive, wherein said nucleation additive is one of a form of carbon, Barium Sulfate (BaSO₄), or combinations thereof;
comprises a nucleation additive, wherein said nucleation additive is a form of carbon, said form of carbon comprises conductive carbon, graphite, artificial graphite, activated carbon, carbon paper, acetylene black, carbon black, high surface area carbon black, graphene, high surface area graphene, keitjen black, carbon fibers, carbon filaments, carbon nanotubes, open-cell carbon foam, a carbon mat, carbon felt, carbon Buckminsterfullerene (Bucky Balls), an aqueous carbon suspension, flake graphite, oxidized carbon, and combinations thereof; or
is sealed on one of the following consisting of one side of said negative electrode, two sides of said negative electrode, and three sides of said negative electrode.

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. The lead acid battery of claim 0, wherein said fibrous mat envelope comprises a conductive layer disposed adjacent to said negative electrode, wherein said conductive layer may comprise conductive carbon, graphite, artificial graphite, activated carbon, carbon paper, acetylene black, carbon black, high surface area carbon black, graphene, high surface area graphene, keitjen black, carbon fibers, carbon filaments, carbon nanotubes, open-cell carbon foam, a carbon mat, carbon felt, carbon Buckminsterfullerene (Bucky Balls), an aqueous carbon suspension, flake graphite, oxidized carbon, and combinations thereof.

15. (canceled)

16. The lead acid battery of claim 0, wherein said porous membrane comprises one or more arrays of ribs on at least one surface thereof or on two surfaces thereof, and wherein said one or more arrays of ribs may have a height of about 10 □m to about 2.0 mm.

17. (canceled)

18. The lead acid battery of claim 0, wherein said porous membrane:
comprises at least one material selected from the group consisting of natural materials, synthetic materials, polyolefins, phenolic resins, poly vinyl chloride (PVC), natural rubber, synthetic rubber, synthetic wood pulp, glass fibers, lignins, cellulosic fibers, and combinations thereof;
comprises polyethylene, silica, and processing oil;
is sealed on one of the following consisting of one side of said positive electrode, two sides of said positive electrode, and three sides of said positive electrode;
has a Porosity of greater than about 55%, greater than about 60%, or greater than about 65%; or
is a microporous battery separator.

19. (canceled)

20. (canceled)

21. (canceled)

22. (canceled)

23. (canceled)

24. (canceled)

25. (canceled)

26. A lead acid battery comprising:
an electrode array comprising one or more negative electrodes, and one or more positive electrodes interleaved between said one or more negative electrodes;
one or more electrode and fibrous mat assemblies comprising a fibrous mat at least partially integrated into at least one of said one or more negative electrodes; and
a porous membrane enveloping one of said one or more electrode and fibrous mat assemblies or at least one of said one or more positive electrodes adjacent to said one or more electrode and fibrous mat assemblies, wherein
said battery may be selected from the group consisting of: a flat Plate battery, a flooded lead acid battery, an enhanced flooded lead acid battery (“EFB”), a valve regulated lead acid (“VRLA”) battery, a gel battery, an absorptive glass mat (“AGM”) battery, a deep cycle battery, a tubular battery, a motive battery, an inverter battery, a PSoC battery, a vehicle battery, a starting-lighting-ignition (“SLI”) vehicle battery, an idling-start-stop (“ISS”) vehicle battery, an automobile battery, a truck battery, a motorcycle battery, an all-terrain vehicle battery, a forklift battery, a golf cart battery, a hybrid-electric vehicle battery, an electric vehicle battery, a wheel chair battery, an e-rickshaw battery, an e-trike battery, an e-bike battery, and a marine vessel battery.

27. The lead acid battery of claim 26 further comprising an active material associated with said one or more negative electrodes; wherein said fibrous mat is integrated into said active material from about 2% to about 50%, from about 5% to about 25%, from about 5% to about 20%, or from about 5% to about 15% of a mat thickness of said fibrous mat.

28. (canceled)

29. (canceled)

30. (canceled)

31. The lead acid battery of claim 26, wherein said fibrous mat:
is one of the list consisting of a nonwoven, mesh, fleece, and combinations thereof;
is formed of a polymer and additionally with one or more chosen from one of the group consisting of glass fibers, pulp, and combinations thereof;
is formed of a polymer and additionally with one or more chosen from one of the group consisting of glass fibers, pulp, and combinations thereof, wherein said polymer comprises at least one selected from the group consisting of a polyolefin, a polyester, a polyamide, a polyimide, and combinations thereof;
comprises an inorganic material;
comprises an inorganic material, which comprises silica;
is a spun-bond melt-nonwoven composite material; or
comprises conductive carbon, graphite, artificial graphite, activated carbon, carbon paper, acetylene black, carbon black, high surface area carbon black, graphene, high surface area graphene, keitjen black, carbon fibers, carbon filaments, carbon nanotubes, open-cell carbon foam, a carbon mat, carbon felt, carbon Buckminsterfullerene (Bucky Balls), an aqueous carbon suspension, flake graphite, oxidized carbon, and combinations thereof.

32. (canceled)

33. (canceled)

34. (canceled)

35. (canceled)

36. (canceled)

37. The lead acid battery of claim 26, wherein said fibrous mat is a carbon fiber nonwoven material, and said carbon fiber nonwoven material may comprise conductive carbon, graphite, artificial graphite, activated carbon, acetylene black, carbon black, high surface area carbon black, graphene, high surface area graphene, keitjen black, carbon fibers, carbon filaments, carbon nanotubes, open-cell carbon foam, a carbon mat, carbon felt, carbon Buckminsterfullerene (Bucky Balls), flake graphite, oxidized carbon, and combinations thereof.

38. (canceled)

39. (canceled)

40. The lead acid battery of claim 26, wherein said fibrous mat comprises a nucleation additive, wherein said nucleation additive may be one of a form of carbon, barium sulfate (BaSO₄), and combinations thereof, and
wherein said form of carbon may comprise conductive carbon, graphite, artificial graphite, activated carbon, carbon paper, acetylene black, carbon black, high surface area carbon black, graphene, high surface area graphene, keitjen black, carbon fibers, carbon filaments, carbon nanotubes, open-cell carbon foam, a carbon mat, carbon felt, carbon Buckminsterfullerene (Bucky Balls), an aqueous carbon suspension, flake graphite, oxidized carbon, and combinations thereof.

41. (canceled)

42. (canceled)

43. The lead acid battery of claim 26, wherein said fibrous mat comprises a conductive layer disposed adjacent to said negative electrode, and wherein said conductive layer may comprise conductive carbon, graphite, artificial graphite, activated carbon, carbon paper, acetylene black, carbon black, high surface area carbon black, graphene, high surface area graphene, keitjen black, carbon fibers, carbon filaments, carbon nanotubes, open-cell carbon foam, a carbon mat, carbon felt, carbon Buckminsterfullerene (Bucky Balls), an aqueous carbon suspension, flake graphite, oxidized carbon, and combinations thereof.

44. (canceled)

45. The lead acid battery of claim 26, wherein said porous membrane comprises one or more arrays of ribs on at least one surface thereof or on each of two surfaces thereof, wherein said arrays of ribs may have a height of about 10 μm to about 2.0 mm.

46. (canceled)

47. (canceled)

48. The lead acid battery of claim 26, wherein said porous membrane:
comprises at least one material selected from the group consisting of natural materials, synthetic materials, polyolefins, phenolic resins, poly vinyl chloride (PVC), natural rubber, synthetic rubber, synthetic wood pulp, glass fibers, lignins, cellulosic fibers, and combinations thereof; or
comprises polyethylene, silica, and processing oil; or is a microporous battery separator.

49. (canceled)

50. The lead acid battery of claim 26, wherein said porous membrane is:
sealed on one of the following consisting of one side of said positive electrode, two sides of said positive electrode, and three sides of said positive electrode; or
said porous membrane is sealed on one of the following consisting of one side of said one or more electrode and fibrous mat assemblies, two sides of said one or more electrode and fibrous mat assemblies, and three sides of said one or more electrode and fibrous mat assemblies.

51. (canceled)

52. (canceled)

53. A flooded lead acid battery comprising:
an electrode array comprising one or more negative electrodes and one or more positive electrodes alternately arranged with respect to one another;
a porous membrane enveloping at least one of said one or more negative electrodes, wherein said porous membrane comprises ribs on one or more surfaces thereof, a fibrous mat is disposed within said envelope.

54. The flooded lead acid battery of claim 53, wherein said ribs are at least partially on a surface of the porous membrane adjacent to said fibrous mat, and optionally wherein said ribs have a height from 10 μm to about 2.0 mm, from about 5 μm to about 300 μm, or from 25 μm to 200 μm.

55. (canceled)

56. (canceled)

57. (canceled)

58. The flooded lead acid battery of claim 53, wherein said fibrous mat:
envelopes one of said one or more negative electrodes;
is at least partially integrated into said negative electrode;
comprises discrete pieces disposed between said ribs;
has a thickness from about 50% of the height of said ribs to about 150% of the height of said
ribs;
is disposed between said negative electrode and said porous membrane and optionally
laminated to the porous membrane;
comprises at least one material selected from the group consisting of glass fibers, pulp, a polymer, and combinations thereof;
is formed from a polymer in combination with at least one material selected from the group consisting of glass fibers, pulp, and combinations thereof;
is formed from a polymer in combination with at least one material selected from the group consisting of glass fibers, pulp, and combinations thereof, wherein said polymer comprises at least one selected from the group consisting of a polyolefin, a polyester, a polyamide, a polyimide, and combinations thereof;
comprises an inorganic material;
comprises an inorganic material, wherein said inorganic material comprises silica;
is a spun-bond melt-nonwoven composite material;
comprises a carbon fiber nonwoven material;
comprises carbon fiber nonwoven material, wherein said carbon fiber nonwoven material
comprises conductive carbon, graphite, artificial graphite, activated carbon, acetylene black, carbon black, high surface area carbon black, graphene, high surface area graphene, keitjen black, carbon fibers, carbon filaments, carbon nanotubes, open-cell carbon foam, a carbon mat, carbon felt, carbon Buckminsterfullerene (Bucky Balls), flake
graphite, oxidized carbon, and combinations thereof;
comprises conductive carbon, graphite, artificial graphite, activated carbon, carbon paper,
acetylene black, carbon black, high surface area carbon black, graphene, high surface area graphene, keitjen black, carbon fibers, carbon filaments, carbon nanotubes, open-cell
carbon foam, a carbon mat, carbon felt, carbon Buckminsterfullerene (Bucky Balls), an aqueous carbon suspension, flake graphite, oxidized carbon, and combinations thereof;
comprises a nucleation additive;
comprises a nucleation additive, wherein said nucleation additive is one of a form of carbon, Barium Sulfate (BaSO₄), and combinations thereof;
comprises a nucleation additive, wherein said nucleation additive is a form of carbon wherein said form of carbon comprises conductive carbon, graphite, artificial graphite, activated carbon, carbon paper, acetylene black, carbon black, high surface area carbon black, graphene, high surface area graphene, keitjen black, carbon fibers, carbon filaments, carbon nanotubes, open-cell carbon foam, a carbon mat, carbon felt, carbon Buckminsterfullerene (Bucky Balls), an aqueous carbon suspension, flake graphite, oxidized carbon, and combinations thereof;
comprises a conductive laver disposed adjacent to said negative electrode;
comprises a conductive laver disposed adjacent to said negative electrode, wherein said conductive laver comprises conductive carbon, graphite, artificial graphite, activated carbon, carbon paper, acetylene black, carbon black, high surface area carbon black, graphene, high surface area graphene, keitjen black, carbon fibers, carbon filaments, carbon nanotubes, open-cell carbon foam, a carbon mat, carbon felt, carbon Buckminsterfullerene (Bucky Balls), an aqueous carbon suspension, flake graphite, oxidized carbon, and combinations thereof; or
is sealed on one of the following consisting of one side of said negative electrode, two sides of said negative electrode, and three sides of said negative electrode.

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. The flooded lead acid battery of claim 53, wherein said porous membrane:
has ribs on two surfaces thereof;
comprises at least one material selected from the group consisting of natural materials, synthetic materials, polyolefins, phenolic resins, poly vinyl chloride (PVC), natural rubber, synthetic rubber, synthetic wood pulp, glass fibers, lignins, cellulosic fibers, and combinations thereof;
comprises polyethylene, silica, and processing oil;
comprises polyethylene, silica, and processing oil, wherein said processing oil is in an
amount of approximately 5% by weight of said porous membrane to approximately 15% by weight of said porous membrane;
is sealed on one of the following consisting of one side of said negative electrode, two sides of said negative electrode, and three sides of said negative electrode; or
is a microporous battery separator.

77. (canceled)

78. (canceled)

79. (canceled)

80. (canceled)

81. (canceled)

82. (canceled)

83. A system comprising: a vehicle, and said lead acid battery or flooded lead acid battery of claim 1, wherein said vehicle may be one chosen from the group consisting of an automobile, a truck, a motorcycle, an all-terrain vehicle, a motorcycle, a forklift, a golf cart, a hybrid vehicle, a hybrid-electric vehicle, an electric vehicle, an idling-start-stop (“ISS”) vehicle, an e-rickshaw battery, an e-trike an e-bike a wheel chair, and a marine vessel.

84. (canceled)

85. (canceled)

86. A method for preventing acid displacement in a lead acid battery, a flooded lead acid battery, an enhanced flooded lead acid battery, or a flooded lead acid battery operating or intended to be operated in a partial state of charge, which comprises manufacturing the battery so that it has a structure identical to the battery of claim 1.

87-89. (canceled)
